(19) United States
(12) Patent Application Publication
(10) Pub. No.: US 2026/0088566 A1
(43) Pub. Date: Mar. 26, 2026

(54) FLOATING CONNECTOR AND CONNECTION STRUCTURE OF CONNECTORS

(71) Applicant: HOSIDEN CORPORATION, Osaka (JP)

(72) Inventor: Yuta IWAMOTO, Yao-shi (JP)

(73) Assignee: HOSIDEN CORPORATION, Osaka (JP)

(21) Appl. No.: 19/324,474

(22) Filed: Sep. 10, 2025

(30) Foreign Application Priority Data
Sep. 26, 2024 (JP) 2024-167842

(51) Int. Cl. H01R 13/631; H01R 12/72; H01R 12/73

(52) U.S. Cl. CPC H01R 13/6315; H01R 12/722; H01R 12/732

(57) ABSTRACT

A floating connector including a first connector part, a second connector part in spaced relation to, and on one side in a first direction relative to, the first connector part, and relay terminals. The first connector part includes a first body and first retainable portions of the terminals retained in the first body at intervals in a second direction. The second connector part includes a second body and second retainable portions of the terminals retained in the second body at intervals in the second direction. The terminals include elastically deformable portions between the respective first and second retainable portions, arranged at intervals in the second direction. Elastic deformation of the elastically deformable portions causes the second connector part to be displaced relative to the first connector part, in the direction including the component of at least one direction of the first, second, or the third direction.

### CROSS-REFERENCE TO RELATED APPLICATION

The present application claims priority under 35 U.S.C. § 119 of Japanese Patent Application No. 2024-167842 filed on Sep. 26, 2024, the disclosure of which is expressly incorporated by reference herein in its entirety.

### BACKGROUND OF THE INVENTION

### Technical Field

The invention relates to floating connectors and connection structures of connectors.

### Background Art

JP 2023-139357 A describes a conventional floating connector. The floating connector is mounted on a circuit board and connectable to a mating connector. The floating connector includes a housing and a plurality of terminals.

Provided inside the housing is a plurality of housing spaces housing the respective terminals. An upper wall of the housing is provided with a plurality of upper openings communicating with the respective housing spaces.

Each of the terminals includes a fixed portion, a lower contacting portion, an upper contacting portion of an inverted Ω shape, and a spring portion of a generally L-shape. The fixed portion is fixed to a lower portion of the corresponding housing space of the housing to be is disposed on a lower wall of the housing. The lower contacting portion extends forward from the corresponding fixed portion and is bent downward such that a lower face of the lower contacting portion is at the same height as a bottom face of the lower wall of the housing. The bottom face of the lower wall of the housing is mountable on the circuit board, and the lower contacting portion is connectable to the circuit board. The upper contacting portion includes a main portion of a generally U shape, a first end portion on the front side, and a second end portion on the rear side. The spring portion includes a first spring element and a second spring element. The first spring element, which is a plate-like portion suspended from the second end portion of the upper contacting portion, extends in vertical and horizontal directions. The second spring element, which is a plate-like portions suspended from a lower end of the corresponding first spring element to the corresponding fixed portion, extends in the vertical and horizontal directions.

The mating connector may be connected to the floating connector at a position forwardly offset from a predetermined connecting position with respect to the floating connector. In this case, the terminals of the mating connector are inserted from above, through the respective upper openings of the housing of the floating connector, into the respective housing spaces of the housing, and into the respective main portions of the upper contacting portions of the terminals of the floating connector. At this time, the first spring elements of the plurality of terminals of the floating connector elastically deform so as to tilt forward, and the second spring elements of the terminals elastically deform so as to rise up, so that the main portions of the upper contacting portions of the terminals are displaced forward following the respective terminals of the mating connector.

The mating connector may also be connected to the floating connector at a position rearwardly offset from the predetermined connecting position with respect to the floating connector. In this case, the terminals of the mating connector are inserted from above, through the respective upper openings of the housing of the floating connector, into the respective housing spaces of the housing, and into the respective main portions of the upper contacting portions of the terminals of the floating connector. At this time, the first spring elements of the plurality of terminals of the floating connector elastically deform so as to tilt rearward, and the second spring elements of the terminals elastically deform so as to sink down, so that the main portions of the upper contacting portions of the terminals are displaced rearward following the respective terminals of the mating connector.

Thus the conventional floating connector is configured such that the elastic deformation of the spring portions of the plurality of terminals cause the main portions of the upper contacting portions of the plurality of terminals to float in accordance with the displacement of the mating connector in a front or rear direction.

### SUMMARY OF INVENTION

As described above, the conventional floating connector is simply configured such that the connector mounted on the circuit board is connectable to a single mating connector. In other words, no consideration has been given to connecting the conventional floating connector to two mating connectors.

The invention provides a floating connector connectable to two mating connectors and also provides connection structure of connectors.

A floating connector according to an aspect of the invention includes a first connector part, a second connector part disposed in spaced relation to, and on one side in a first direction relative to, the first connector part, and a plurality of relay terminals constituted by an electrically conductive material.

The first connector part includes a first body constituted by an insulating material, first retainable portions of the plurality of relay terminals, and first contacting portions of the plurality of relay terminals. The first retainable portions of the plurality of relay terminals are retained in the first body at intervals in a second direction, where the second direction is substantially orthogonal to the first direction. The first contacting portions of the plurality of relay terminals extend to one side in a third direction from the respective first retainable portions of the plurality of relay terminals, and protrude or are exposed at least partly from the first body such as to be visible from the one side in the third direction, where the third direction is substantially orthogonal to the first and second directions.

The second connector part includes a second body constituted by an insulating material and disposed in spaced relation to, and on the one side in the first direction relative to, the first body, second retainable portions of the plurality of relay terminals, and second contacting portions of the plurality of relay terminals. The second retainable portions of the plurality of relay terminals are retained in the second body at intervals in the second direction. The second contacting portions of the plurality of relay terminals extend to the one side in the third direction from the respective second retainable portions of the plurality of relay terminals, and protrude or are exposed at least partly from the second body such as to be visible from the one side in the third direction.

The plurality of relay terminals further include respective elastically deformable portions. The elastically deformable portions are provided between the respective first retainable portions and the respective second retainable portions and are arranged at intervals in the second direction. The second direction is a thickness direction of each of the elastically deformable portions of the plurality of relay terminals,

The elastically deformable portions of the plurality of relay terminals are elastically deformable in a direction including a component of at least one direction of the first, second, or the third direction, and the elastic deformation of the elastically deformable portions causes the second connector part to be displaced relative to the first connector part, in the direction including the component of the at least one direction.

A connection structure (combination) of connectors according to an aspect of the invention includes the floating connector described above, a first circuit board, a second circuit board disposed in spaced relation to, and on the one side in the first direction relative to, the first circuit board, a first mating connector mounted on the first circuit board and connectable to the first connector part of the floating connector from the one side in the third direction, and a second mating connector mounted on the second circuit board and connectable to the second connector part of the floating connector from the one side in the third direction.

The first mating connector includes a first body constituted by an insulating material, and a plurality of first terminals being constituted by an electrically conductive material and including respective first retainable portions, respective first contacting portions, and respective first lead portions. The first retainable portions of the first mating connector are retained in the first body of the first mating connector at intervals in the second direction. The first contacting portions of the first mating connector extend to the other side in the third direction, and protrude or are exposed at least partly from the first body of the first mating connector such as to be visible from the other side in the third direction. The first lead portions of the first mating connector are disposed on the one side in the third direction, the one side in the first direction, or the other side in the first direction, relative to the first body of the first mating connector, and are connected to the first circuit board.

In a state where the first connector part of the floating connector is connected to the first mating connector, the first contacting portions of the plurality of relay terminals of the floating connector are in contact with the respective first contacting portions of the plurality of first terminals of the first mating connector.

The second mating connector includes a second body constituted by an insulating material, and a plurality of second terminals being constituted by an electrically conductive material and including respective second retainable portions, respective second contacting portions, and respective second lead portions. The second retainable portions of the second mating connector are retained in the second body of the second mating connector at intervals in the second direction. The second contacting portions of the second mating connector extend to the other side in the third direction, and protrude or are exposed at least partly from the second body of the second mating connector such as to be visible from the other side in the third direction. The second lead portions of the second mating connector are disposed on the one side in the third direction, the one side in the first direction, or the other side in the first direction, relative to the second body of the second mating connector, and are connected to the second circuit board.

In a state where the second connector part of the floating connector is connected to the second mating connector, the second contacting portions of the plurality of relay terminals of the floating connector are in contact with the respective second contacting portions of the plurality of second terminals of the second mating connector.

As described above, since the first connector part is connectable to the first mating connector and the second connector part is connectable to the second mating connector, the invention provides a novel floating connector connectable to two mating connectors. Moreover, the elastically deformable portions of the plurality of relay terminals are elastically deformable in the direction including the component of the at least one direction of the first, second, or the third direction, and the elastic deformation of the elastically deformable portions causes the second connector part to be displaced relative to the first connector part, in the direction including the component of the at least one direction. As such, even if the second mating connector is at a position offset from a predetermined position with respect to the first mating connector, in the direction including the component of the at least one direction, the second connector part is displaced with respect to the first connector part in the direction including the component of the at least one direction, enabling the connection of the second connector part to the second mating connector. Since the connection structure of the aspect described above includes the novel floating connector, the connection structure also provides the same technical features and effects as those of the floating connector.

### BRIEF DESCRIPTION OF DRAWINGS

FIG. 1A is a front, top, right side perspective view of a floating connector according to a first embodiment of the invention.

FIG. 1B is a front, bottom, left side perspective view of the floating connector of the first embodiment.

FIG. 1C is a rear, top, right side perspective view of the floating connector of the first embodiment.

FIG. 1D is a rear, bottom, left side perspective view of the floating connector of the first embodiment.

FIG. 2A is a cross-sectional view of the floating connector of the first embodiment, taken along line 2A-2A in FIG. 1A.

FIG. 2B is a cross-sectional view of the floating connector of the first embodiment, taken along line 2B-2B in FIG. 1A.

FIG. 2C is a cross-sectional view of the floating connector of the first embodiment, taken along line 2C-2C in FIG. 1A.

FIG. 2D is a cross-sectional view of the floating connector of the first embodiment, taken along line 2D-2D in FIG. 1A.

FIG. 2E a cross-sectional view of the floating connector of the first embodiment, taken along line 2E-2E in FIG. 1A.

FIG. 2F is a cross-sectional view of the floating connector of the first embodiment, taken along line 2F-2F in FIG. 1A.

FIG. 2G is a cross-sectional view of the floating connector of the first embodiment, taken along line 2G-2G in FIG. 1A.

FIG. 3A is a front, top, right side perspective, exploded view of the floating connector of the first embodiment.

FIG. 3B is a rear, bottom, left side perspective, exploded view of the floating connector of the first embodiment.

FIG. 4A is a front, top, right side perspective, enlarged view of one of relay terminals of the floating connector of the first embodiment.

FIG. 4B is a front, top, left side perspective, enlarged view of one of the relay terminals of the floating connector of the first embodiment.

FIG. 5A is a rear, top, left side perspective view of a connection structure (combination) of connectors according to the first embodiment of the invention, illustrating a state where the floating connector has not been connected to a first mating connector mounted on a first circuit board and to a second mating connector mounted on a second circuit board.

FIG. 5B is a rear, top, left side perspective view of the connection structure (combination) according to the first embodiment of the invention, illustrating a state where the floating connector has been connected to the first mating connector mounted on the first circuit board and to the second mating connector mounted on the second circuit board.

FIG. 6A is a cross-sectional view of the connection structure of the first embodiment, taken along line 6A-6A in FIG. 5B.

FIG. 6B is a cross-sectional view of the connection structure of the first embodiment, taken along line 6B-6B in FIG. 5B.

FIG. 6C is a cross-sectional view of the connection structure of the first embodiment, taken along line 6C-6C in FIG. 5B.

FIG. 6D is a cross-sectional view of the connection structure of the first embodiment, taken along line 6D-6D in FIG. 5B.

FIG. 7A is an enlarged perspective view illustrating a state where one of relay terminals of the floating connector is connected to one of terminals of the first mating connector and one of terminals of the second mating connector of the connection structure of the first embodiment, as viewed from one side.

FIG. 7B is an enlarged perspective view illustrating a state where one of relay terminals of the floating connector is connected to one of terminals of the first mating connector and one of terminals of the second mating connector of the connection structure of the first embodiment, as viewed from the opposite side.

FIG. 8A is a rear, top, left side view of the first and the second mating connectors of the first embodiment.

FIG. 8B is a rear, bottom, right side view of the first and the second mating connectors of the first embodiment.

FIG. 8C is a front, top, left side view of the first and the second mating connectors of the first embodiment.

FIG. 8D is a front, bottom, right side view of the first and the second mating connectors of the first embodiment.

FIG. 9A is a cross-sectional view of the first and the second mating connectors of the first embodiment, taken along line 9A-9A in FIG. 8A.

FIG. 9B is a cross-sectional view of the first and the second mating connectors of the first embodiment, taken along line 9B-9B in FIG. 8A.

FIG. 9C is a cross-sectional view of the first and the second mating connectors of the first embodiment, taken along line 9C-9C in FIG. 8A.

FIG. 9D is a cross-sectional view of the first and the second mating connectors of the first embodiment, taken along line 9D-9D in FIG. 8A.

FIG. 10A is a rear, top, left side perspective, exploded view of the first and the second mating connectors of the first embodiment.

FIG. 10B is a front, bottom, right side perspective, exploded view of the first and the second mating connectors of the first embodiment.

FIG. 11A is a rear, top, left side perspective, enlarged view of one of the terminals of the first and the second mating connectors of the first embodiment.

FIG. 11B is a rear, top, right side perspective, enlarged view of one of the terminals of the first and the second mating connectors of the first embodiment.

In the brief description of the drawings above and the description of embodiments which follows, relative spatial terms such as “upper”, “lower”, “top”, “bottom”, “left”, “right”, “front”, “rear”, etc., are used for the convenience of the skilled reader and refer to the orientations of the floating connectors, connection structures of connectors, and their constituent parts as depicted in the drawings. No limitation is intended by use of these terms, either in use of the invention, during its manufacture, shipment, custody, or sale, or during assembly of its constituent parts or when incorporated into or combined with other apparatus.

### DESCRIPTION OF EMBODIMENTS

A plurality of embodiments of the invention, including the first embodiment and variants thereof, will now be described. It should be noted that the constituents of the embodiments and their variants to be described can be combined in any possible manner. It should also be noted that the materials, the shapes, the dimensions, the numbers, the arrangements, etc. of the constituents of the embodiments and their variants to be described are presented by way of example only and can be modified in any manner as long as the same functions can be fulfilled.

### First Embodiment

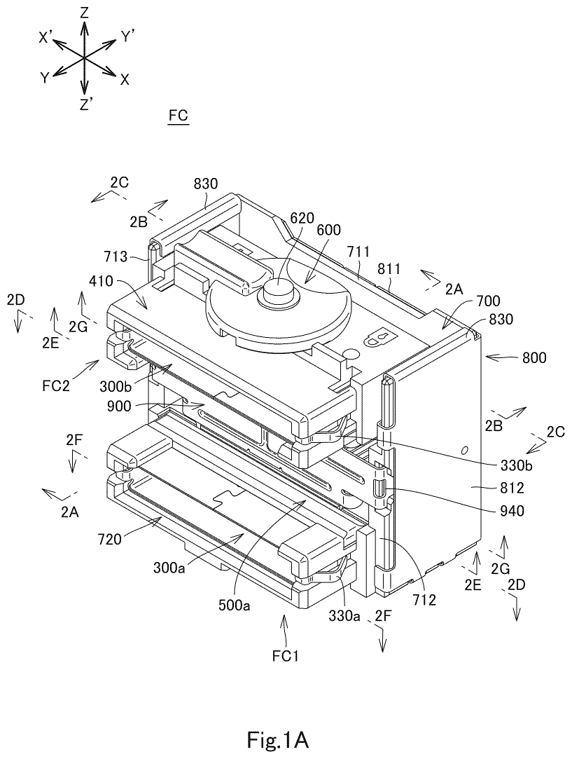

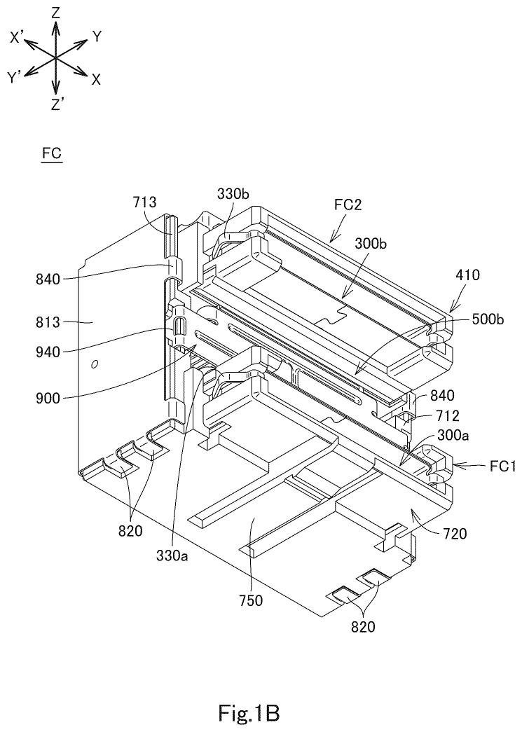

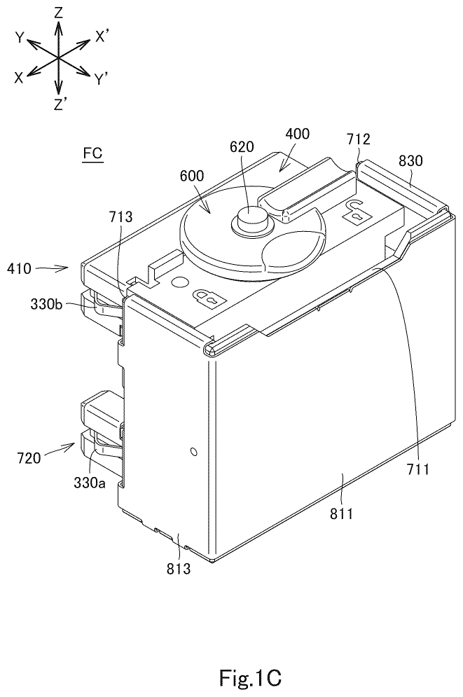

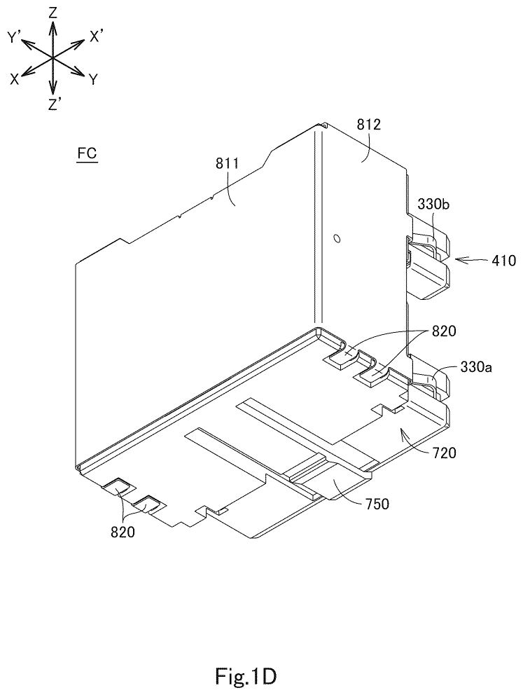

A floating connector FC (which may be referred to simply as “the connector FC”) according to a plurality of embodiments, including the first embodiment of the invention and variants thereof, will now be described with reference to FIGS. 1A to 4B. FIGS. 1A to 4B illustrate the connector FC of the first embodiment.

FIGS. 1A to 2C and 3A to 4B show a Z-Z′ direction (first direction). The Z-Z′ direction includes a Z direction (one side in the first direction) and a Z′ direction (the other side in the first direction). FIGS. 1A to 1D and 2B to 4B show an X-X′ direction (second direction). The X-X′ direction is substantially orthogonal to the Z-Z′ direction and includes an X direction (one side in the second direction) and an X′ direction (the other side in the second direction). FIGS. 1A to 2A and 2D to 4B show a Y-Y′ direction (third direction). The Y-Y′ direction is substantially orthogonal to the Z-Z′ and X-X′ directions and includes a Y direction (one side in the third direction) and a Y′ direction (the other side in the third direction).

The connector FC includes a plurality of relay terminals 200 (which may be referred to simply as “terminals 200”). Each of the terminals 200 is constituted by an electrically conductive material. Each terminal 200 includes a first contacting portion 210a, a first retainable portion 220a, a second contacting portion 210b, a second retainable portion 220b, and an elastically deformable portion 230. Each terminal 200 may further include a first linking portion 240a and a second linking portion 240b.

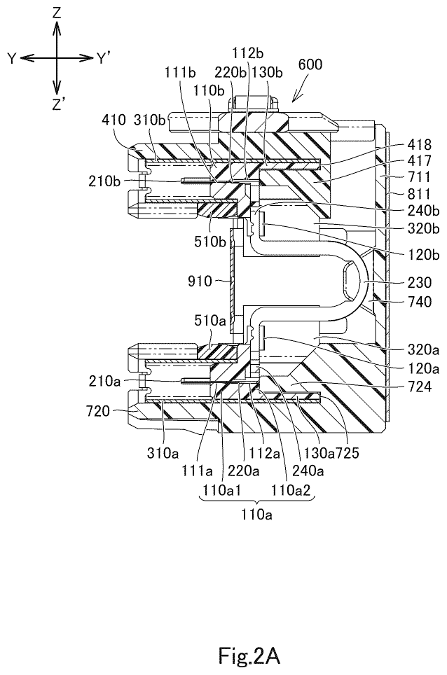

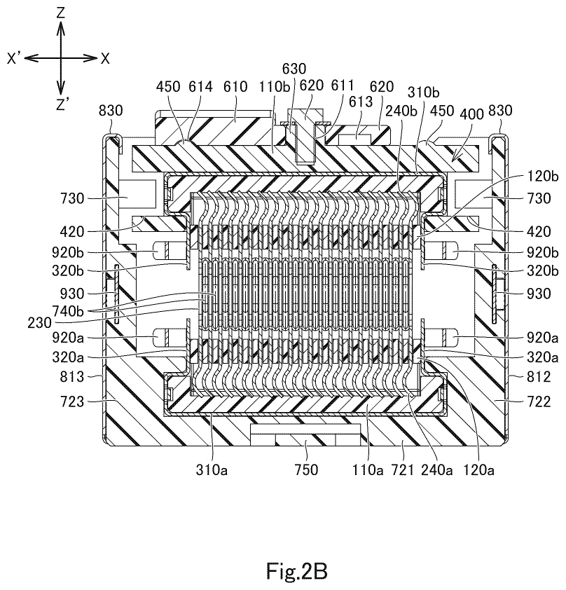

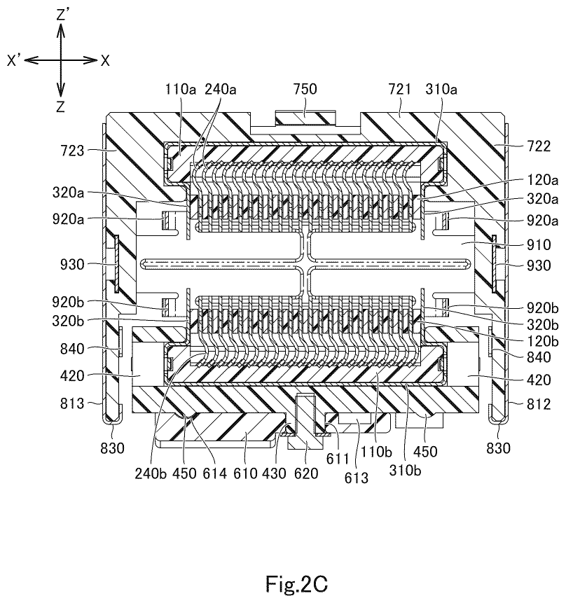

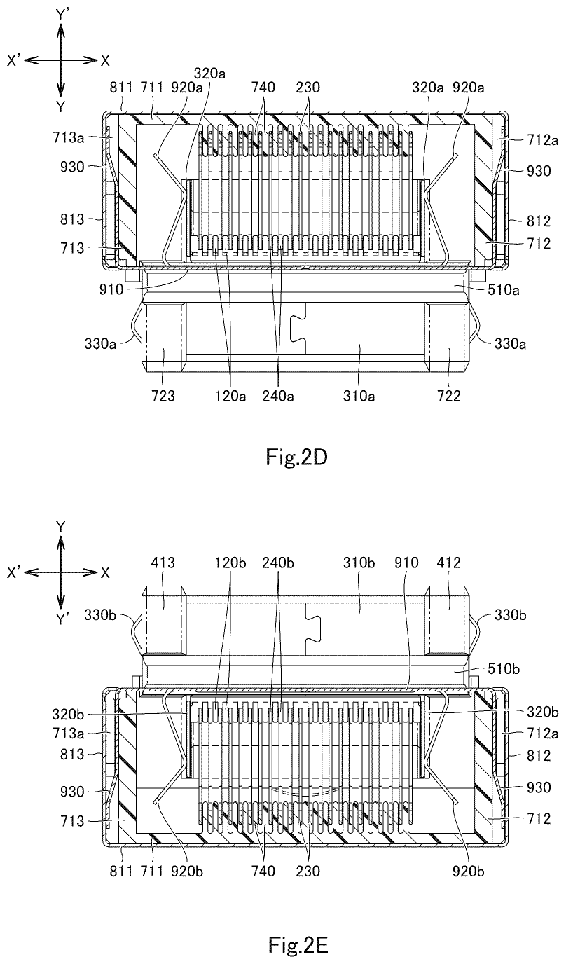

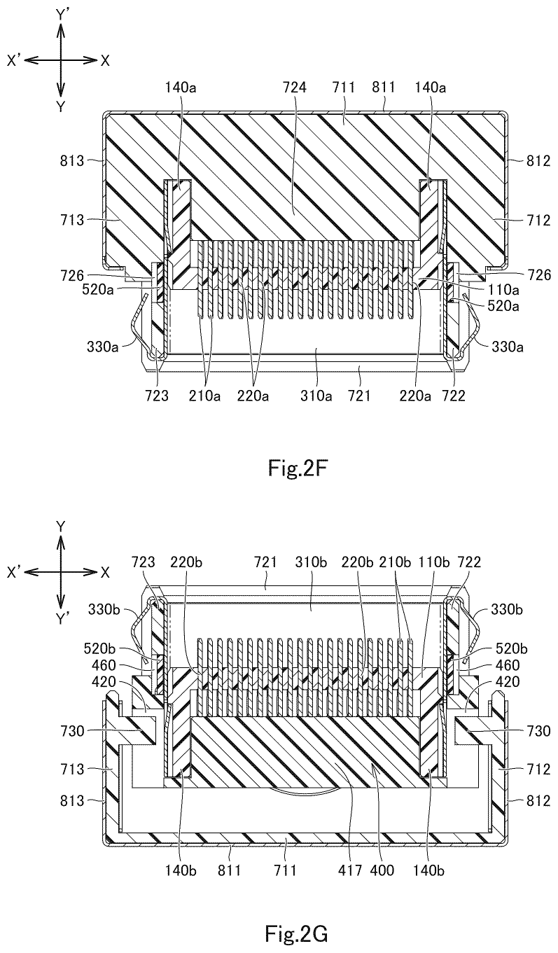

The first retainable portion 220a may be constituted by a plate (see FIGS. 2A and 3A to 4B), a rod (not illustrated), or a tube (not illustrated) extending in the Y-Y′ direction. The first retainable portion 220a may be generally U shaped in sectional view along the Z-Z′ and X-X′ directions and extend in the Y-Y′ direction.

The second retainable portion 220b is disposed on the Z-direction side relative to the first retainable portion 220a. The second retainable portion 220b may be constituted by a plate (see FIGS. 2A and 3A to 4B), a rod (not illustrated), or a tube (not illustrated) extending in the Y-Y′ direction. The second retainable portion 220b may be generally U shaped in sectional view along the Z-Z′ and X-X′ directions and extend in the Y-Y′ direction.

The first contacting portion 210a is only required to extend in the Y direction from the first retainable portion 220a. For example, the first contacting portion 210a may be constituted by a plate (see FIGS. 2A and 3A to 4B), a rod (not illustrated), or a tube (not illustrated) extending in the Y direction from the first retainable portion 220a. The first contacting portion 210a may have a bifurcated shape extending in the Y direction from the first retainable portion 220a and include first and second contacting arms (not illustrated).

The second contacting portion 210b is disposed on the Z-direction side relative to the first contacting portion 210a. The second contacting portion 210b is only required to extend in the Y direction from the second retainable portion 220b. For example, the second contacting portion 210b may be constituted by a plate (see FIGS. 2A and 3A to 4B), a rod (not illustrated), or a tube (not illustrated) extending in the Y direction from the second retainable portion 220b. The second contacting portion 210b may have a bifurcated shape extending in the Y direction from the second retainable portion 220b and include first and second contacting arms (not illustrated).

The elastically deformable portion 230 is provided between the first retainable portion 220a and the second retainable portion 220b and is elastically deformable in a direction including a component of at least one direction of the Z-Z′, X-X′, or Y-Y′ direction (this direction may be referred to simply as “the direction including the component of the at least one direction”). The direction including the component of the at least one direction may include a direction including components of a plurality of directions among the Z-Z′, X-X′, and Y-Y′ direction. For example, the elastically deformable portion 230 may be generally laterally oriented U shaped, generally laterally oriented arc shaped, or generally laterally oriented V shaped, in sectional view along the Z-Z′ and Y-Y′ directions, and may be elastically deformable in a direction including a component of one direction of the Z-Z′, X-X′, or Y-Y′ direction, in a direction including two components of the Z-Z′, X-X′, and Y-Y′ direction, or in a direction including three components of the Z-Z′, X-X′, and Y-Y′ direction. The elastically deformable portion 230 includes a first end portion 231 on the Z′-direction side, a second end portion 232 on the Z-direction side, and a top portion 233. When the second end portion 232 is displaced from (moves away from) the first end portion 231 in a direction including a Z-direction component, the elastically deformable portion 230 thereby elastically deforms in the direction including the Z-direction component. When the second end portion 232 is displaced toward (moves toward) the first end portion 231 in a direction including a Z′-direction component, the elastically deformable portion 230 thereby elastically deforms in the direction including the Z′-direction component. When the second end portion 232 is displaced from the first end portion 231 in a direction including a Y-direction component, the elastically deformable portion 230 thereby elastically deforms in the direction including the Y-direction component. When the second end portion 232 is displaced from the first end portion 231 in a direction including a Y′-direction component, the elastically deformable portion 230 thereby elastically deforms in the direction including the Y′-direction component. When the second end portion 232 is displaced from the first end portion 231 in a direction including an X-direction component, the elastically deformable portion 230 thereby elastically deforms in the direction including the X-direction component. When the second end portion 232 is displaced from the first end portion 231 in a direction including an X′-direction component, the elastically deformable portion 230 thereby elastically deforms in the direction including the X′-direction component.

The first linking portion 240a links the elastically deformable portion 230 and the first retainable portion 220a, and the second linking portion 240b links the elastically deformable portion 230 and the second retainable portion 220b. The first linking portion 240a may be constituted by, for example, a plate (see FIGS. 2A and 3A to 4B) or a rod (not illustrated) extending from the first end portion 231 of the elastically deformable portion 230 to the rear end on the Y′-direction side of the first retainable portion 220a. The second linking portion 240b may be constituted by, for example, a plate (see FIGS. 2A and 3A to 4B) or a rod (not illustrated) extending from the second end portion 232 of the elastically deformable portion 230 to the rear end on the Y′-direction side of the second retainable portion 220b.

Each terminal 200 described above may be manufactured by a rolling method, for example. The rolling method includes repeatedly performing a rolling step of passing a metal material through between rolling rolls to obtain a thin metal sheet, and thereafter punching and cutting the metal sheet into a predetermined shape for the terminal or performing the like step. In this case, each terminal 200 further includes the following configuration (1) or (2). Note that the X-X′ direction is a thickness direction of the elastically deformable portion 230 of each terminal 200. In other words, the X-X′ direction is a thickness direction of the metal material constituting the elastically deformable portion 230 of each terminal 200.
(1) Each terminal 200 has a first face on the X-direction side and a second face on the X′-direction side, and the first and second faces are generally flat and extend in the Z-Z′ and X-X′ directions (not illustrated). The first and second faces of each terminal 200 are rolled faces. Specifically, the elastically deformable portion 230, the first linking portion 240a, the second linking portion 240b, the first retainable portion 220a, and the second retainable portion 220b of each terminal 200 are constituted by the plate described above and each have a first face on the X-direction side and a second face on the X′-direction side, which faces are generally flat, rolled faces. The first contacting portion 210a of each terminal 200 is constituted by the plate or the pair of contacting arms described above, and has a first face 211a on the X-direction side and a second face 212a on the X′-direction side, which are generally flat, rolled faces. The second contacting portion 210b of each terminal 200 is constituted by the plate or the pair of contacting arms described above, and has a first face 211b on the X-direction side and a second face 212b on the X′-direction side, which faces are generally flat, rolled faces.
(2) The first linking portion 240a of each terminal 200 of the above configuration (1) is at least partly (i.e., partly or entirely) bent or curved such that the first face 211a and the second face 212a of the first contacting portion 210a are inclined in a first oblique direction including components of the Z-Z′ and X-X′ directions, and/or the second linking portion 240b is at least partly (i.e., partly or entirely) bent or curved such that the first face 211b and the second face 212b of the second contacting portion 210b are inclined in a second oblique direction including components of the Z-Z′ and X-X′ directions (see FIGS. 2A and 3A to 4B). The first and second faces of the first retainable portion 220a are also inclined in the first oblique direction, similarly to the first face 211a and the second face 212a of the first contacting portion 210a. The first and second faces of the second retainable portion 220b are also inclined in the second oblique direction, similarly to the first face 211b and the second face 212b of the second contacting portion 210b. The first linking portion 240a may be curved in a generally arc shape or a generally U shape protruding in the X or X′ direction, or may be bent in a generally V shape protruding in the X or X′ direction. The second linking portion 240b may be curved in a generally arc shape or a generally U shape protruding in the X or X′ direction, or may be bent in a generally V shape protruding in the X or X′ direction. The first and second faces of the elastically deformable portion 230 of each terminal 200 remain generally flat faces extending in the Z-Z′ and Y-Y′ directions.

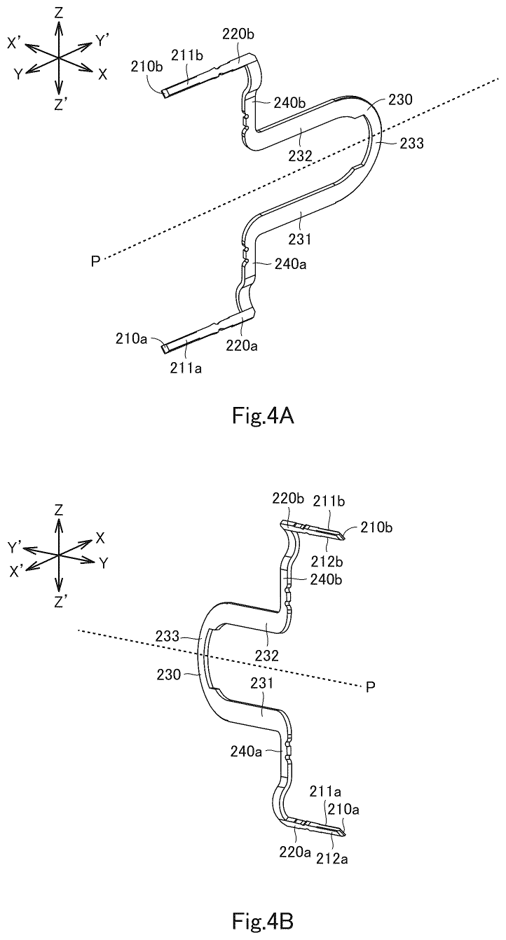

The first oblique direction and the second oblique direction may be the same direction, and the first face 211a and the second face 212a of the first contacting portion 210a may be the same in inclination as the first face 211b and the second face 212b of the second contacting portion 210b (see FIGS. 2A and 3A to 4B). Alternatively, the first oblique direction and the second oblique direction may be different directions, and the first face 211a and the second face 212a of the first contacting portion 210a may be different in inclination from the first face 211b and the second face 212b of the second contacting portion 210b (not illustrated). In the former case, each terminal 200 may, but is not required to, be shaped to have such two-fold rotational symmetry (see FIGS. 4A and 4B) that a shape of each terminal 200 before being rotated by 180 degrees about a rotation axis overlaps a shape of each terminal 200 after being rotated by 180 degrees about the rotation axis, when viewed from the Y-direction side along an imaginary line P. The rotation axis is the imaginary line P extending in the Y-Y′ directions substantially through the center of each terminal 200 (see FIGS. 4A and 4B).

Each terminal 200 described above may be manufactured not by the rolling method but by other known method for manufacturing terminals, such as a photolithography method or an inkjet method. In this case, each terminal 200 may have configuration (1) or (2) described above. Alternatively, the first and second faces of the elastically deformable portion 230 of each terminal 200 may be generally flat faces extending in the Z-Z′ and Y-Y′ directions, the first linking portion 240a and the second linking portion 240b of each terminal 200 may be constituted by a plate or a rod having a configuration other than configurations (1) and (2) described above, the first retainable portion 220a and the second retainable portion 220b of each terminal 200 may be constituted by a plate, a rod, a tube, or a generally U shaped member having a configuration other than configuration (1) and (2) described above, and the first contacting portion 210a and the second contacting portion 210b of each terminal 200 may be constituted by a plate, a rod, a tube, or a pair of contacting arms having a configuration other than configurations (1) or (2) described above. Still alternatively, the elastically deformable portion 230, the first linking portion 240a, the second linking portion 240b, the first retainable portion 220a, the second retainable portion 220b, the first contacting portion 210a, and the second contacting portion 210b of each terminal 200 may have any of the configurations described above other than configurations (1) and (2) described above.

When each terminal 200 has configuration (1) or (2) described above, the top portion 233 of the elastically deformable portion 230 of each terminal 200 may have a dimension in the Y-Y′ direction that is smaller than the dimension in the Z-Z′ direction of each of the first end portion 231 and the second end portion 232 of the elastically deformable portion 230 of each terminal 200. In this case, an end portion on the Y-direction side and/or an end portion on the Y′-direction side of the top portion 233 of the elastically deformable portion 230 of each terminal 200 may be cut away (see FIGS. 4A and 4B). Alternatively, the dimension in the Y-Y′ direction of the top portion 233 of the elastically deformable portion 230 of each terminal 200 may be substantially the same as, or larger than, the dimension in the Z-Z′ direction of each of the first end portion 231 and the second end portion 232 of the elastically deformable portion 230 of each terminal 200.

The first linking portion 240a and the second linking portion 240b can be omitted. In this case, the first end portion 231 of the elastically deformable portion 230 may be linked to the first retainable portion 220a, and the second end portion 232 of the elastically deformable portion 230 may be linked to the second retainable portion 220b.

The connector FC further includes a first connector part FC1. The first connector part FC1 includes a first body 100a, the first retainable portions 220a of the plurality of terminals 200, and the first contacting portions 210a of the plurality of terminals 200. The first connector part FC1 may further include the first linking portions 240a (if provided) of the plurality of terminals 200.

The first body 100a is only required to be constituted by an insulating material (e.g., an insulating resin or the like) and configured to retain the first retainable portions 220a of the plurality of terminals 200 at intervals in the X-X′ direction.

The first body 100a includes a first body main portion 110a. The first body main portion 110a retains the first retainable portions 220a of the plurality of terminals 200 at intervals in the X-X′ direction. The first contacting portions 210a of the plurality of terminals 200 at least partly protrude, or are exposed, from the first body main portion 110a such as to be visible from the Y-direction side. The first body main portion 110a and the plurality of terminals 200 may further have one of the following configurations (3-1) to (3-4).
(3-1) The first body main portion 110a includes a block 110al and a table 110a2. The block 110al of the first body main portion 110a extends in the Y-Y′ direction and is constituted by a polygonal prism (e.g., a quadrangular prism (see FIG. 2A), a hexagonal prism (not illustrated), or the like.) or a cylinder (not illustrated). The table 110a2 (see FIG. 2A) of the first body main portion 110a extends in the Y′ direction from the block 110al of the first body main portion 110a.

The block 110al of the first body main portion 110a is provided with a plurality of retaining holes 111a extending through the block 110al in the Y-Y′ direction and arranged at intervals in the X-X′ direction. The table 110a2 of the first body main portion 110a is provided with a plurality of retaining grooves 112a arranged at intervals in the X-X′ direction and on the Y′-direction side relative to the plurality of retaining holes 111a. The plurality of retaining grooves 112a open out in the Y, Y′, and Z directions. The first retainable portions 220a of the plurality of terminals 200 are securely received from the Y′-direction side in the plurality of retaining holes 111a and the plurality of retaining grooves 112a. Thus the first retainable portions 220a of the plurality of terminals 200 are retained in the first body 100a at intervals in the X-X′ direction. The first contacting portions 210a of the plurality of terminals 200 at least partly protrude in the Y direction from the plurality of retaining holes 111a of the first body 100a. For example, the first contacting portions 210a of the plurality of terminals 200 may entirely protrude in the Y direction from the plurality of retaining holes 111a. Alternatively, portions on the Y′-direction side of the first contacting portions 210a of the plurality of terminals 200 may be housed in the plurality of retaining holes 111a, and portions on the Y-direction side of the first contacting portions 210a of the plurality of terminals 200 may protrude in the Y direction from the plurality of retaining holes 111a.
(3-2) The block 110al of the first body main portion 110a may be further provided with a plurality of connection holes (not illustrated) on the Y-direction side relative to the plurality of retaining holes 111a. The plurality of connection holes are arranged in the X-X′ direction at the same intervals as the plurality of retaining holes 111a, extend through the plurality of retaining holes 111a, and open out in the Y direction. In this case, the first contacting portions 210a of the plurality of terminals 200 are at least partly disposed in the plurality of connection holes of the first body 100a, and are exposed, or protrude, at least partly from the plurality of connection holes in the Y direction. For example, the first contacting portions 210a of the plurality of terminals 200 may be entirely housed in the plurality of connection holes, and the entireties, or portions on the Y′-direction side, of the first contacting portions 210a of the plurality of terminals 200 may be exposed from the plurality of connection holes in the Y direction. Alternatively, portions on the Y′-direction side of the first contacting portions 210a of the plurality of terminals 200 may be housed in the plurality of connection holes, and portions on the Y-direction side of the first contacting portions 210a of the plurality of terminals 200 may protrude in the Y direction from the plurality of connection holes.
(3-3) The first body main portion 110a may include the plurality of retaining holes 111a or the plurality of retaining grooves 112a (not illustrated). In this case, the first retainable portions 220a of the plurality of terminals 200 are securely received from the Y′-direction side in the plurality of retaining holes 111a or the plurality of retaining grooves 112a. This configuration also allows the first retainable portions 220a of the plurality of terminals 200 to be retained in the first body 100a at intervals in the X-X′ direction. The first contacting portions 210a of the plurality of terminals 200 at least partly protrude in the Y direction from the plurality of retaining holes 111a or the plurality of retaining grooves 112a of the first body 100a. For example, the first contacting portions 210a of the plurality of terminals 200 may entirely protrude in the Y direction from the plurality of retaining holes 111a or the plurality of retaining grooves 112a. Alternatively, portions on the Y′-direction side of the first contacting portions 210a of the plurality of terminals 200 may be housed in the plurality of retaining holes 111a or the plurality of retaining grooves 112a, and portions on the Y-direction side of the first contacting portions 210a of the plurality of terminals 200 may protrude in the Y direction from the plurality of retaining holes 111a or the plurality of retaining grooves 112a. Note that where the plurality of retaining grooves 112a are not provided, the table 110a2 can be omitted. Where the plurality of retaining holes 111a are not provided, the block 110al can be omitted.
(3-4) The first body main portion 110a may include the plurality of retaining holes 111a or the plurality of retaining grooves 112a, and the plurality of connection holes (not illustrated). The plurality of connection holes are provided in the block 110al of the first body main portion 110a, and arranged in the X-X′ direction at the same intervals as the plurality of retaining holes 111a or the plurality of retaining grooves 112a, and communicate with the plurality of retaining holes 111a or the plurality of retaining grooves 112a, and open out in the Y direction. In this case, the first retainable portions 220a of the plurality of terminals 200 are securely received from the Y′-direction side in the plurality of retaining holes 111a or the plurality of retaining grooves 112a. This configuration also allows the first retainable portions 220a of the plurality of terminals 200 to be retained in the first body 100a at intervals in the X-X′ direction. The first contacting portions 210a of the plurality of terminals 200 are at least partly disposed in the plurality of connection holes of the first body 100a, and are exposed, or protrude, at least partly from the plurality of connection holes in the Y direction. For example, the first contacting portions 210a of the plurality of terminals 200 may be entirely housed in the plurality of connection holes, and the entireties, or portions on the Y-direction side, of the first contacting portions 210a of the plurality of terminals 200 may be exposed from the plurality of connection holes in the Y direction. Alternatively, portions on the Y′-direction side of the first contacting portions 210a of the plurality of terminals 200 may be housed in the plurality of connection holes, and portions on the Y-direction side of the first contacting portions 210a of the plurality of terminals 200 may protrude in the Y direction from the plurality of connection holes. Note that where the plurality of retaining grooves 112a are not provided, the table 110a2 can be omitted. Where the plurality of retaining holes 111a are not provided, the block 110al can be omitted.

The first retainable portions 220a of the plurality of terminals 200 are retained in the first body 100a, so that the first contacting portions 210a, the second contacting portions 210b, the elastically deformable portions 230, the first linking portions 240a (if provided), and the second linking portions 240b (if provided) of the plurality of terminals 200 are correspondingly arranged at intervals in the X-X′ direction.

The first body 100a may further include a plurality of first partitions 120a. The plurality of first partitions 120a extend in the Z direction from the first body main portion 110a and are arranged at intervals in the X-X′ direction. The plurality of first partitions 120a include a plurality of sets of two adjacent first partitions 120a adjacent in the X-X′ direction. Where the first linking portions 240a of the plurality of terminals 200 are provided, each of the first linking portions 240a of the plurality of terminals 200 is disposed and guided between the two adjacent partitions 120a of each set such as to be movable in the direction including the component of the at least one direction. Where the first linking portions 240a of the plurality of terminals 200 are not provided, the plurality of first partitions 120a may be omitted, or alternatively each of the first end portions 231 of the elastically deformable portions 230 of the plurality of terminals 200 may be disposed and guided between the two adjacent partitions 120a of each set such as to be movable in the direction including the component of the at least one direction.

The first body 100a may further include a plate 130a and/or a pair of side walls 140a. The plate 130a extends in the Y′ direction from the first body main portion 110a. The pair of side walls 140a includes a side wall 140a on the X-direction side and a side wall 140a on the X′-direction side. The side wall 140a on the X-direction side is provided on the X-direction side relative to the first body main portion 110a and the plate 130a. The side wall 140a on the X′-direction side is provided on the X′-direction side relative to the first body main portion 110a and the plate 130a.

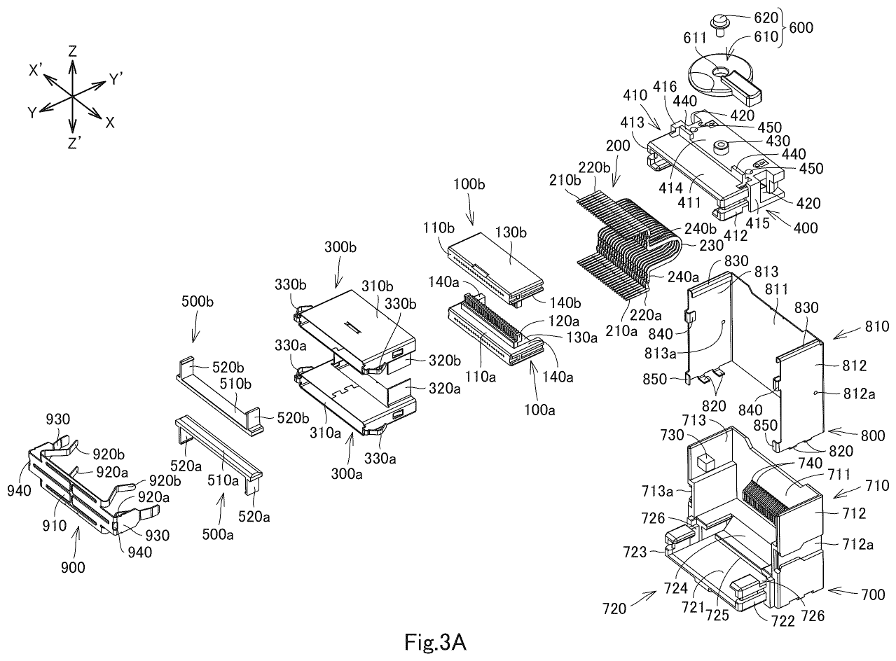

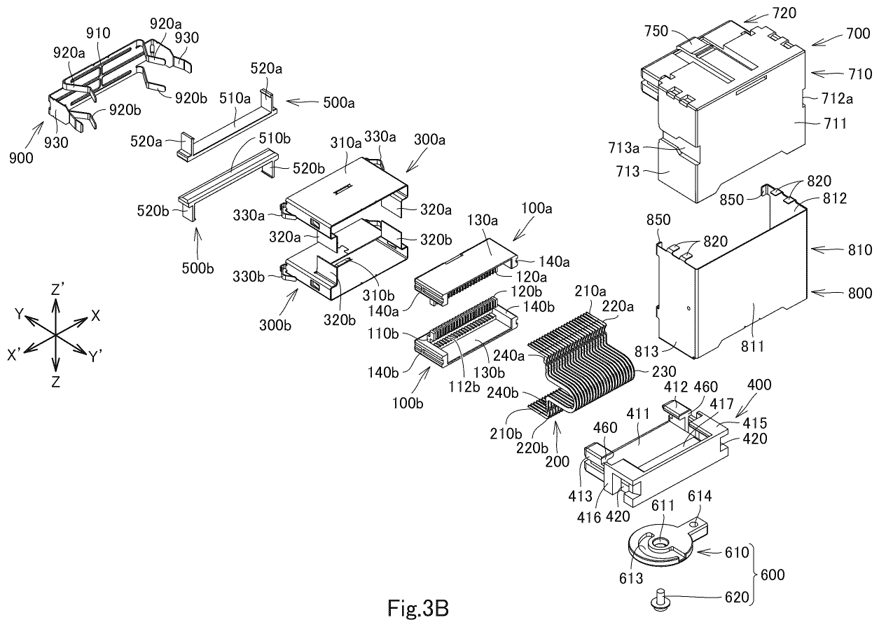

The connector FC may further include a first shell 300a having electrical conductivity. The first shell 300a may be constituted by an electrically conductive material (e.g., a metal plate or the like), or may include an insulating material (e.g., an insulating resin or the like) and metal vapor-deposited on an inner or outer surface of the insulating material. The first shell 300a includes a first shell body 310a. The first shell body 310a has a generally ring shape (a polygonal ring shape, such as a generally quadrangular ring shape (see FIGS. 2A to 3B), or a generally circular ring shape (not illustrated)) or a generally U shape (not illustrated), in sectional view along the Z-Z′ and X-X′ directions. The first shell body 310a extends in the Y-Y′ direction. The first shell body 310a has an inner shape and an inner size in cross section along the Z-Z′ and X-X′ directions that correspond to an outer shape and an outer size of the first body 100a in cross section along the Z-Z′ and X-X′ directions. The first shell body 310a houses the first body 100a at least partly from the Y′-direction side. Accordingly, the first contacting portions 210a and the first retainable portions 220a of the plurality of terminals 200 are at least partly disposed inside the first shell body 310a. The first shell body 310a has a dimension in the Y-Y′ direction that is larger than the dimension in the Y-Y′ direction of the first body 100a. A portion of the first shell body 310a that is located on the Y-direction side relative to the first body 100a defines a first connection space. Note that where the first contacting portions 210a of the plurality of terminals 200 at least partly protrude from the first body 100a, the first contacting portions 210a are at least partly disposed in the first connection space of the first shell body 310a.

The first shell 300a may further include at least one first wall 320a. The at least one first wall 320a extends from the first shell body 310a in the Z direction. For example, the at least one first wall 320a may include a pair of first walls 320a. The pair of first walls 320a include a first wall 320a on the X-direction side (one of first walls 320a) and a first wall 320a on the X′-direction side (the other first wall 320a). The first wall 320a on the X-direction side and the first wall 320a on the X′-direction side may be formed by cutting out parts (e.g., a wall on the Z-direction side) of the first shell body 310a and bending the parts to the Z-direction side, or alternatively may extend in the Z direction from the wall on the X-direction side and the wall on the X′-direction side, respectively, of the first shell body 310a. The first wall 320a on the X-direction side is disposed in spaced relation to, and on the X-direction side relative to, the first linking portions 240a of the plurality of terminals 200. The first wall 320a on the X′-direction side is disposed in spaced relation to, and on the X′-direction side relative to, the first linking portions 240a of the plurality of terminals 200. Note that the at least one first wall 320a may be a single wall and can be omitted.

The first shell 300a may further include at least one first connecting portion 330a. The at least one first connecting portion 330a may be formed by cutting out a part of the first shell body 310a and bending the part to the outside (e.g., the X-, X′-, or Z′-direction sides) of the first shell body 310a. Alternatively, the at least one first connecting portion 330a may extend from the end on the Y-direction side of the first shell body 310a and be folded over in the Y′ direction. Note that the at least one first connecting portion 330a shown in FIGS. 1A to 3B includes a first connecting portion 330a on the X-direction side and a first connecting portion 330a on the X′-direction side. The first connecting portion 330a on the X-direction side extends from the end on the Y-direction side of the wall on the X-direction side of the first shell body 310a and is folded over to the X- and Y′-direction sides. The first connecting portion 330a on the X′-direction side extends from the end on the Y-direction side of the wall on the X′-direction side of the first shell body 310a and is folded over to the X′- and Y′-direction sides. The first connecting portion 330a on the X-direction side and the first connecting portion 330a on the X′-direction side are elastically deformable in directions approaching each other in the X-X′ direction. Note that the at least one first connecting portion 330a can be omitted.

The first shell 300a itself may be omitted.

The connector FC further includes a second connector part FC2. The second connector part FC2 is disposed in spaced relation to, and on the Z-direction side relative to, the first connector part FC1. When the elastically deformable portions 230 of the plurality of terminals 200 elastically deform in the direction including the component of the at least one direction, the elastic deformation causes the second connector part FC2 to be displaced relative to the first connector part FC1 in the direction including the component of the at least one direction, from a predetermined normal position of the second connector part FC2 with respect to the first connector part FC1.

The second connector part FC2 includes a second body 100b, the second retainable portions 220b of the plurality of terminals 200, and the second contacting portions 210b of the plurality of terminals 200. The second connector part FC2 may further include the second linking portions 240b (if provided) of the plurality of terminals 200.

The second body 100b is constituted by an insulating material (e.g., an insulating resin or the like) and disposed in spaced relation to, and on the Z-direction side relative to, the first body 100a. The second body 100b has a similar configuration to the first body 100a. The second body 100b may be identical in shape to the first body 100a and may be oriented such as to be rotated by approximately 180 degrees relative to the first body 100a (see FIGS. 2A to 3B). Alternatively, the second body 100b has a similar configuration to the first body 100a, but may have a different shape from the first body 100a (not illustrated). The second body 100b differs from the first body 100a in the following respects.

The second body main portion 110b of the second body 100b retains the second retainable portions 220b of the plurality of terminals 200 at intervals in the X-X′ direction. The second contacting portions 210b of the plurality of terminals 200 at least partly protrude, or are exposed, from the second body main portion 110b such as to be visible from the Y-direction side. The second body main portion 110b and the plurality of terminals 200 may further have one of the following configurations (4-1) to (4-4).
(4-1) Where the second body main portion 110b includes a plurality of retaining holes 111b and a plurality of retaining grooves 112b, the second retainable portions 220b of the plurality of terminals 200 are securely received from the Y′-direction side in the plurality of retaining holes 111b and the plurality of retaining grooves 112b. The second contacting portions 210b of the plurality of terminals 200 at least partly protrude in the Y direction from the plurality of retaining holes 111b of the second body 100b. For example, the second contacting portions 210b of the plurality of terminals 200 may at least partly protrude in the Y direction from the plurality of retaining holes 111b of the second body 100b in a similar manner to the above-described configuration (3-1). The plurality of retaining grooves 112b open out in the Y, Y′, and Z′ directions.
(4-2) Where the second body main portion 110b includes the plurality of retaining holes 111b, the plurality of retaining grooves 112b, and a plurality of connection holes, the second retainable portions 220b of the plurality of terminals 200 are securely received from the Y′-direction side in the plurality of retaining holes 111b and the plurality of retaining grooves 112b. The second contacting portions 210b of the plurality of terminals 200 are at least partly disposed in the plurality of connection holes of second body 100b, and are exposed, or protrude, at least partly from the plurality of connection holes in the Y direction. For example, the second contacting portions 210b of the plurality of terminals 200 may be at least partly disposed in the plurality of connection holes of the second body 100b, and may be exposed, or protrude, at least partly from the plurality of connection holes in the Y direction, in a similar manner to the above-described configuration (3-2).
(4-3) Where the second body main portion 110b includes the plurality of retaining holes 111b or the plurality of retaining grooves 112b, the second retainable portions 220b of the plurality of terminals 200 are securely received from the Y′-direction side in the plurality of retaining holes 111b or the plurality of retaining grooves 112b. The second contacting portions 210b of the plurality of terminals 200 at least partly protrude in the Y direction from the plurality of retaining holes 111b or the plurality of retaining grooves 112b of the second body 100b. For example, the second contacting portions 210b of the plurality of terminals 200 may at least partly protrude in the Y direction from the plurality of retaining holes 111b or the plurality of retaining grooves 112b of the second body 100b, in a similar manner to the above-described configuration (3-3).
(4-4) Where the second body main portion 110b includes the plurality of retaining holes 111b or the plurality of retaining grooves 112b, and the plurality of connection holes, the second retainable portions 220b of the plurality of terminals 200 are securely received from the Y′-direction side in the plurality of retaining holes 111b or the plurality of retaining grooves 112b. The second contacting portions 210b of the plurality of terminals 200 are at least partly disposed in the plurality of connection holes of second body 100b, and are exposed, or protrude, at least partly from the plurality of connection holes in the Y direction. For example, the second contacting portions 210b of the plurality of terminals 200 may be at least partly disposed in the plurality of connection holes of the second body 100b, and may be exposed, or protrude, at least partly from the plurality of connection holes in the Y direction, in a similar manner to the above-described configuration (3-4).

The second retainable portions 220b of the plurality of terminals 200 are retained in the second body 100b, so that the first contacting portions 210a, the second contacting portions 210b, the elastically deformable portions 230, the first linking portions 240a (if provided), and the second linking portions 240b (if provided) of the plurality of terminals 200 are correspondingly arranged at intervals in the X-X′ direction.

Where the second body 100b further includes a plurality of second partitions 120b, the plurality of second partitions 120b extend in the Z′ direction from the second body main portion 110b and are arranged at intervals in the X-X′ direction. The plurality of second partitions 120b include a plurality of sets of two adjacent second partitions 120b adjacent in the X-X′ direction. Where the second linking portions 240b of the plurality of terminals 200 are provided, each of the second linking portions 240b of the plurality of terminals 200 is disposed and guided between the two adjacent partitions 120b of each set such as to be movable in the direction including the component of the at least one direction. Where the second linking portions 240b of the plurality of terminals 200 are not provided, the plurality of second partitions 120b may be omitted, or alternatively each of the second end portions 232 of the elastically deformable portions 230 of the plurality of terminals 200 may be disposed and guided between the two adjacent partitions 120b of each set such as to be movable in the direction including the component of the at least one direction.

The second body 100b may or may not include a plate 130b and/or a pair of side walls 140b.

The second connector part FC2 may further include a second shell 300b having electrical conductivity. The second shell 300b has a similar configuration to the first shell 300a. The second shell 300b may be identical in shape to the first shell 300a and may be oriented such as to be rotated by approximately 180 degrees relative to the first shell 300a (see FIGS. 1A to 3B). Alternatively, the second shell 300b has a similar configuration to the first shell 300a, but may have a different shape (not illustrated) from the first shell 300a. The second shell 300b differs from the first shell 300a in the following respects.

The second shell body 310b of the second shell 300b has a generally ring shape (a polygonal ring shape, such as a generally quadrangular ring shape (see FIGS. 2A to 3B), or a generally circular ring shape (not illustrated)) or a generally U shape (not illustrated), in sectional view along the Z-Z′ and X-X′ directions. The second shell body 310b extends in the Y-Y′ direction. The second shell body 310b has an inner shape and an inner size in cross section along the Z-Z′ and X-X′ directions that correspond to an outer shape and an outer size of the second body 100b in cross section along the Z-Z′ and X-X′ directions. The second shell body 310b houses the second body 100b at least partly from the Y′-direction side. Accordingly, the second contacting portions 210b and the second retainable portions 220b of the plurality of terminals 200 are at least partly disposed in the second shell body 310b. The second shell body 310b has a dimension in the Y-Y′ direction that is larger than the dimension in the Y-Y′ direction of the second body 100b. A portion of the second shell body 310b that is located on the Y-direction side relative to the second body 100b defines a second connection space. Note that where the second contacting portions 210b of the plurality of terminals 200 at least partly protrude from the second body 100b, the second contacting portions 210b are at least partly disposed in the second connection space of the second shell body 310b.

The second shell 300b may further include at least one second wall 320b. The at least one second wall 320b extends from the second shell body 310b in the Z′ direction. For example, the at least one second wall 320b may include a pair of second walls 320b. The pair of second walls 320b include a second wall 320b on the X-direction side (one of second walls 320b) and a second wall 320b on the X′-direction side (the other second wall 320b). The second wall 320b on the X-direction side and the second wall 320b on the X′-direction side may be formed by cutting out parts (e.g., a wall on the Z′-direction side) of the second shell body 310b and bending the parts to the Z′-direction side, or alternatively may extend in the Z′ direction from the wall on the X-direction side and the wall on the X′-direction side, respectively, of the second shell body 310b. The second wall 320b on the X-direction side is disposed in spaced relation to, and on the X-direction side relative to, the second linking portions 240b of the plurality of terminals 200. The second wall 320b on the X′-direction side is disposed in spaced relation to, and on the X′-direction side relative to, the second linking portions 240b of the plurality of terminals 200. Note that at least one second wall 320b may be a single wall and can be omitted.

The second shell 300b may further include at least one second connecting portion 330b. The at least one second connecting portion 330b may be formed by cutting out a part of the second shell body 310b and bending the part to the outside (e.g., the X-, X′-, or Z′-direction sides) of the second shell body 310b. Alternatively, the at least one second connecting portion 330b may extend from the end on the Y-direction side of the second shell body 310b and be folded over in the Y′ direction. Note that the at least one second connecting portion 330b shown in FIGS. 1A to 3B includes a second connecting portion 330b on the X-direction side and a second connecting portion 330b on the X′-direction side. The second connecting portion 330b on the X-direction side extends from the end on the Y-direction side of the wall on the X-direction side of the second shell body 310b and is folded over to the to the X- and Y′-direction sides. The second connecting portion 330b on the X′-direction side extends from the end on the Y-direction side of the wall on the X′-direction side of the second shell body 310b and is folded over to the to the X′- and Y′-direction sides. The second connecting portion 330b on the X-direction side and the second connecting portion 330b on the X′-direction side are elastically deformable in directions approaching each other in the X-X′ direction. Note that at least one second connecting portion 330b can be omitted. Note that the second shell 300b itself may be omitted.

The second connector part FC2 may further include a second housing 400. The second housing 400 is constituted by an insulating material (e.g., an insulating resin or the like) and retains the second shell 300b.

The second housing 400 includes a second housing body 410. The second housing body 410 has a generally U shape (see FIGS. 1A to 3B) or a generally ring shape (a polygonal ring shape, such as a generally quadrangular ring shape, or a generally circular ring shape (not illustrated)) in sectional view along the Z-Z′ and X-X′ directions. The second housing body 410 extends in the Y-Y′ direction. The second housing body 410 has an inner shape and an inner size in cross section along the Z-Z′ and X-X′ directions that correspond to an outer shape and an outer size of the second shell body 310b of the second shell 300b in cross section along the Z-Z′ and X-X′ directions. The second housing body 410 securely houses the second shell body 310b from the Y′-direction side. The second housing body 410 may include a distal portion on the Y-direction side and a rear portion on the Y′-direction side. The distal portion of the second housing body 410 includes a ceiling plate 411 on the Z-direction side, a side wall 412 on the X-direction side, and a side wall 413 on the X′-direction side. The rear portion of the second housing body 410 includes a ceiling plate 414 on the Z-direction side, a side wall 415 on the X-direction side, and a side wall 416 on the X′-direction side. The ceiling plate 414 extends from the ceiling plate 411 in the Y′ direction. The side wall 415 extends from the side wall 412 in the Y′ direction. The side wall 416 extends from the side wall 413 in the Y′ direction. The rear portion of the second housing body 410 may or may not further include a rear wall on the Y-direction side. Where the second housing body 410 has a generally U shape in the above-described cross-sectional view, the at least one second wall 320b (if provided) of the second shell 300b extends through between the side wall 415 and the side wall 416 of the second housing body 410 to be located on the Z′-direction side relative to the second housing body 410. Where the second housing body 410 has a generally ring shape in the above-described cross-sectional view, the second housing body 410 includes a bottom portion on the Z′-direction side provided with at least one slit extending through the bottom portion in the Z-Z′ direction and opening out in the Y direction, and the at least one second wall 320b (if provided) of the second shell 300b extends through the at least one slit to be located on the Z′-direction side relative to the second housing body 410.

The rear wall of the second housing body 410 may be provided with a retaining base 417 extending in the Y direction from the rear wall. The retaining base 417 may or may not abut the second linking portions 240b (if provided) of the plurality of terminals 200 from the Y′-direction side. The retaining base 417 faces the ceiling plate 414 with a first gap 418 therebetween (see FIG. 2A). The first gap 418 extends in the Y-Y′ direction and opens out in the Y, X, and X′ directions inside the second housing body 410. The first gap 418 has a dimension in the Z-Z′ direction that is substantially the same as the sum of a dimension in the Z-Z′ direction of the plate 130b of the second body 100b and a dimension in the Z-Z′ direction of a portion on the Y′-direction side of the wall on the Z-direction side of the second shell body 310b that is located on the plate 130b. The first gap 418 fittingly and securely receives the plate 130b and the portion on the Y′-direction side of the wall on the Z-direction side of the second shell body 310b. The retaining base 417 faces the side wall 415 with a second gap therebetween and faces the side wall 416 with a third gap therebetween (see FIG. 2G). The second gap receives a portion on the Y′-direction side of the side wall 140b on the X-direction side of the second body 100b and a portion on the Y′-direction side of the wall on the X-direction side of the second shell body 310b thereon. The third gap receives a portion on the Y′-direction side of the side wall 140b on the X′-direction side of the second body 100b and a portion on the Y′-direction side of the wall on the X′-direction side of the second shell body 310b thereon. Note that the retaining base 417 can be omitted.

A first locking hole 460 may be provided in a portion on the X-direction side of the ceiling plate 411 and the side wall 412, and a second locking hole 460 may be provided in a portion on the X′-direction side of the ceiling plate 411 and the side wall 413. The first locking hole 460 and the second locking hole 460 extend in the Z-Z′ direction and open out in the Z′ direction. Note that the first locking hole 460 and the second locking hole 460 can be omitted.

The side walls 415 and 416 may be provided with a first guidable portion 420 and a second guidable portion 420, respectively. The first and second guidable portions 420 are recesses or holes respectively provided in the side walls 415 and 416, and respectively open out in the X and X′ directions. The first and second guidable portions 420 may open out also in the Y′ direction. Note that the first guidable portion 420 and the second guidable portion 420 can be omitted.

The ceiling plate 414 may be provided with a shaft 430. The shaft 430 may be a cylinder extending from the ceiling plate 414 in the Z direction and provided with a shaft hole in a central portion thereof. The shaft 430 may alternatively be a shaft hole in the ceiling 414. The ceiling plate 414 is provided with a dome-shaped, locking protrusion 450 on the X-direction side in a portion on the X-direction side relative to the shaft 430, and provided with a dome-shaped, locking protrusion 450 on the X′-direction side in a portion on the X′-direction side relative to the shaft 430.

In a boundary between the ceiling plate 411 and the ceiling 414A, there may be provided with a pair of abutments 440 protruding to the Z-direction side. The pair of abutments 440 include a first abutment 440 on the X-direction side and a second abutment 440 on the X′-direction side. Note that the abutments 440 can be omitted.

A side face on the X-direction side of the side wall 412 may be provided with a guide groove on the X-direction side extending in the Y-Y′ direction, and a side face on the X′-direction side of the side wall 413 may be provided with a guide groove on the X′-direction side extending in the Y-Y′ direction (see FIGS. 1A to 3B). In this case, the second connecting portion 330b on the X-direction side of the second shell 300b is disposed on the X-direction side relative to the side wall 412 of the second housing body 410, and a distal portion of the second connecting portion 330b on the X-direction side is guidable such as to move in the Y-Y′ direction in the guide groove on the X-direction side. The second connecting portion 330b on the X′-direction side of the second shell 300b is disposed on the X′-direction side relative to the side wall 413 of the second housing body 410, and a distal portion of the second connecting portion 330b on the X′-direction side is guidable such as to move in the Y-Y′ direction in the guide groove on the X-direction side.

The rear portion of the second housing body 410 may be integrated with the second body 100b. The second housing 400 itself may be omitted.

The second connector part FC2 may further include a rotating lever 600. The rotating lever 600 has a lever body 610, and a screw or pin 620. The lever body 610 includes a disk and a handle extending from the disk. A central portion of the disk is provided with a shaft hole 611. Where the shaft 430 of the second housing 400 is constituted by the above-described cylinder, the shaft 430 is received in the shaft hole 611. In this case, the lever body 610 is rotatable about the shaft 430 on the rear portion of the second housing 400. The screw or pin 620 is fixedly received in the shaft hole of the shaft 430. Where the shaft hole in the ceiling plate 414 of the second housing 400 is provided in place of the shaft 430 of the second housing 400, the shaft hole of the second housing 400 communicate with the shaft hole 611 of the lever body 610, and the screw or pin 620 is fixedly received in the shaft 430 and the shaft hole of the second housing 400. In this case, the lever body 610 is rotatable about the screw or pin 620 on the rear portion of the second housing 400.

Provided on a face on the Z′-direction side of the disk of the lever body 610 is a lock groove 613 having a generally arc shape and surrounding the shaft hole 611. Provided on a face on the Z′-direction side of a distal portion of the handle of the lever body 610 is a locking recess 614. In a state where the lever body 610 is located at a lock position (in a locked state), the locking protrusion 450 on the X-direction side of the second housing 400 fits in the locking recess 614 so as to temporarily lock the lever body 610. In a state where the lever body 610 is located at an unlocked position (in an unlocked state), the locking protrusion 450 on the X′-direction side of the second housing 400 fits in the locking recess 614 so as to temporarily lock the lever body 610. In the locked state, the first abutment 440 is located on the Y-direction side relative to the handle of the lever body 610 and abuts the handle from the Y-direction side. In the unlocked state, the second abutment 440 is located on the Y-direction side relative to the handle of the lever body 610 and abuts the handle from the Y-direction side. Thus the pair of abutments 440 defines the rotation range of the rotating lever 600.

The lever body 610 may be constituted by the disk or the handle. In the former case, the lock groove 613 and the locking recess 614 may be provided on the face on the Z′-direction side of the disk. In the latter case, the lock groove 613 and the locking recess 614 may be provided on the face on the Z′-direction side of the handle.

The second housing 400 and the rotating lever 600 can be both omitted. Even where the second housing 400 is provided, the rotating lever 600 can be omitted. In this case also, the shaft 430 and the locking protrusion 450 of the second housing 400 are omitted.

The connector FC may further include a second retainer 500b. The second retainer 500b is constituted by an insulating resin or the like. The second retainer 500b includes a retainer body 510b, a first locking piece 520b, and a second locking piece 520b. The retainer body 510b extends in the X-X′ direction. The first locking piece 520b and the second locking piece 520b extend in the Z direction from the retainer body 510b and are spaced from each other in the X-X′ direction. The first locking piece 520b and the second locking piece 520b are received respectively in the first locking hole 460 and the second locking hole 460 of the second housing 400 from the Z′-direction side, and distal portions of the first and second locking pieces 520b are provided with respective lugs respectively locked in the first and second locking holes 460. In this locked state, a face on the Y-direction side of the retainer body 510b abuts a face on the Y-direction side of the first locking hole 460 and a face on the Y-direction side of the second locking hole 460 of the second housing 400, a face on the Y′-direction side of the retainer body 510b abuts a face on the Y-direction side of a portion of the second body 100b that links the second body main portion 110b and the second partitions 120b. Also in the locked state, the retainer body 510b abuts, from the Z′-direction side, the second shell body 310b of the second shell 300b housed in the second housing body 410 of the second housing 400, or alternatively, the retainer body 510b faces, from the Z′-direction side, the second shell body 310b of the second shell 300b housed in the second housing body 410 of the second housing 400 such that the retainer body 510b is located in the vicinity of the second shell body 310b with a gap therebetween. The second retainer 500b may thus serve to fix the second shell body 310b to the second housing body 410. Note that the second retainer 500b and the second housing 400 can both be omitted. Even where the second housing 400 is provided, the second retainer 500b can be omitted.

The connector FC may further include a first housing 700. The first housing 700 is constituted by an insulating material (e.g., an insulating resin or the like). The first housing 700 includes a first housing body 710 having a generally U shape in sectional view along the X-X′ and Y-Y′ directions. The first housing body 710 may include a first portion 711, a second portion 712, and a third portion 713. The first portion 711 is a wall on the Y′-direction side of the first housing body 710. The second portion 712 is a wall on the X-direction side of the first housing body 710 and extends in the Y direction from an end on the X-direction side of the first portion 711. A side face on the X-direction side of the second portion 712 may be provided with a housing groove 712a (third housing groove) extending in the Y-Y′ direction. The housing groove 712a opens out in the Y and X directions. The third portion 713 is a wall on the X′-direction side of the first housing body 710 extending in the Y direction from an end on the X′-direction side of the first portion 711. A side face on the X′-direction side of the third portion 713 may be provided with a housing groove 713a (third housing groove) extending in the Y-Y′ direction. The housing groove 713a opens out in the Y and X′ directions. The housing groove 712a and the housing groove 713a can be omitted.

The first housing 700 further includes a retaining portion 720. The retaining portion 720 is provided on a portion on the Z′-direction side of the first housing body 710 and retains the first connector part FC1.

The retaining portion 720 has, for example, a generally U shape (see FIGS. 1A to 3B) or a generally ring shape (a polygonal ring shape, such as a generally quadrangular ring shape, or a generally circular ring shape (not illustrated)) in sectional view along the Z-Z′ and X-X′ directions, and extends in the Y-Y′ direction. The retaining portion 720 has an inner shape and an inner size in cross section along the Z-Z′ and X-X′ directions that correspond to an outer shape and an outer size of the first shell body 310a of the first shell 300a in cross section along the Z-Z′ and X-X′ directions. The retaining portion 720 securely houses the first shell body 310a at least partly from the Y-direction side. Note that where the first shell 300a is omitted, the retaining portion 720 securely houses the first body 100a at least partly from the Y-direction side.

The retaining portion 720 includes a bottom portion 721 on the Z′-direction side, a side wall 722 on the X-direction side, and a side wall 723 on the X′-direction side. The retaining portion 720 includes a distal portion and a rear portion. The distal portion of the retaining portion 720 is constituted by respective portions on the Y-direction side of the bottom portion 721, the side wall 722, and the side wall 723, and is located on the Y-direction side relative to the first housing body 710. The rear portion of the retaining portion 720 is configured by respective portions on the Y′-direction side of the bottom portion 721, the side wall 722, and the side wall 723, and is located inside the first housing body 710. Where the retaining portion 720 has a generally U shape in the above-described cross-sectional view, the at least one first wall 320a (if provided) of the first shell 300a extends through between the side wall 722 and the side wall 723 of the retaining portion 720 to be located on the Z-direction side relative to the retaining portion 720. Where the retaining portion 720 has a generally ring shape in the above-described cross-sectional view, the retaining portion 720 includes a ceiling portion on the Z-direction side provided with at least one slit extending through the ceiling portion in the Z-Z′ direction and opening out in the Y direction, and the at least one first wall 320a (if provided) of the first shell 300a extends through the at least one slit to be located on the on the Z-direction side relative to the retaining portion 720.

The retaining portion 720 may further include a retaining base 724 extending in the Y direction from the first portion 711 of the first housing 700. The retaining base 724 may or may not abut the first linking portions 240a (if provided) of the plurality of terminals 200 from the Y′-direction side. The retaining base 724 faces the bottom portion 721 with a first gap 725 therebetween (see FIG. 2A). The first gap 725 extends in the Y-Y′ direction and opens out in the Y, X, and X′ directions inside the retaining portion 720. The first gap 725 has a dimension in the Z-Z′ direction that is substantially the same as the sum of a dimension in the Z-Z′ direction of the plate 130a of the first body 100a and a dimension in the Z-Z′ direction of a portion on the Y′-direction side of the wall on the Z′-direction side of the first shell body 310a that is located on the plate 130a. The first gap 725 fittingly and securely receives the plate 130a and the portion on the Y′-direction side of the wall on the Z′-direction side of the first shell body 310a. The retaining base 724 faces the side wall 722 with a second gap therebetween and faces the side wall 723 with a third gap therebetween (see FIG. 2F). The second gap receives a portion on the Y′-direction side of the side wall 140a on the X-direction side of the first body 100a and a portion on the Y′-direction side of the wall on the X-direction side of the first shell body 310a thereon. The third gap receives a portion on the Y′-direction side of the side wall 140a on the X′-direction side of the first body 100a and a portion on the Y′-direction side of the wall on the X′-direction side of the first shell body 310a thereon. Note that the retaining base 724 can be omitted.

A first locking hole 726 may be provided in a portion on the X-direction side of the bottom portion 721 and the side wall 722, and a second locking hole 726 may be provided in a portion on the X′-direction side of the bottom portion 721 and the side wall 723. The first locking hole 726 and the second locking hole 726 extend in the Z-Z′ direction and open out in the Z direction. Note that the first locking hole 726 and the second locking hole 726 can be omitted.

A side face on the X-direction side of the side wall 722 may be provided with a guide groove on the X-direction side extending in the Y-Y′ direction, and a side face on the X′-direction side of the side wall 723 may be provided with a guide groove on the X′-direction side extending in the Y-Y′ direction (see FIGS. 1A to 3B). In this case, the first connecting portion 330a on the X-direction side of the first shell 300a is disposed on the X-direction side relative to the side wall 722 of the retaining portion 720, and a distal portion of the first connecting portion 330a on the X-direction side is guidable such as to move in the Y-Y′ direction in the guide groove on the X-direction side. The first connecting portion 330a on the X′-direction side of the first shell 300a is disposed on the X′-direction side relative to the side wall 723 of the retaining portion 720, and a distal portion of the first connecting portion 330a on the X′-direction side is guidable such as to move in the Y-Y′ direction in the guide groove on the X′-direction side.

The first housing 700 may further include at least one guide 730. The at least one guide 730 guides the second connector part FC2 movably in the direction including the component of the at least one direction. The at least one guide 730 may include a first guide 730 on the X-direction side and a second guide 730 on the X′-direction side.

Where the first guidable portion 420 and the second guidable portion 420 of the second housing 400 are provided, the first guide 730 is a protrusion protruding from the second portion 712 of the first housing body 710 to the X′-direction side, and is received in the first guidable portion 420 from the X-direction side so as to be movable in the direction including the component of the at least one direction, and the second guide 730 is a protrusion protruding from the third portion 713 of the first housing body 710 to the X-direction side, and is received in the second guidable portion 420 from the X′-direction side so as to be movable in the direction including the component of the at least one direction (see FIGS. 2B and 2G). Thus the first guide 730 and the second guide 730 guide the second housing 400 (i.e., the second connector part FC2) movably in the direction including the component of the at least one direction. Where the first guide 730 and the second guide 730 are movable respectively in the first guidable portion 420 and the second guidable portion 420 in a direction including a component of the Z-Z′ direction, the first guide 730 has a dimension in the Z-Z′ direction that is smaller than a dimension in the Z-Z′ direction of the first guidable portion 420, and the second guide 730 has a dimension in the Z-Z′ direction that is smaller than a dimension in the Z-Z′ direction of the second guidable portion 420. A linear distance in the Z-Z′ direction between the face on the Z-direction side of the first guide 730 and the face on the Z′-direction side of the first guidable portion 420 and a linear distance in the Z-Z′ direction between the face on the Z-direction side of the second guide 730 and the face on the Z′-direction side of the second guidable portion 420 may each be set such as to define, or may each be larger than, a movement range in which the second connector part FC2 is movable in a direction including a component of the Z direction relative to the first connector part FC1. A linear distance in the Z-Z′ direction between the face on the Z′-direction side of the first guide 730 and the face on the Z-direction side of the first guidable portion 420 and a linear distance in the Z-Z′ direction between the face on the Z′-direction side of the second guide 730 and the face on the Z-direction side of the second guidable portion 420 may each be set such as to define, or may each be larger than, a movement range in which the second connector part FC2 is movable in a direction including a component of the Z′ direction relative to the first connector part FC1.

Where the first guide 730 and the second guide 730 are movable respectively in the first guidable portion 420 and the second guidable portion 420 in a direction including a component of the X-X′ direction, the first guide 730 has a dimension in the X-X′ direction that is smaller than a dimension in the X-X′ direction of the first guidable portion 420, and the second guide 730 has a dimension in the X-X′ direction that is smaller than a dimension in the X-X′ direction of the second guidable portion 420. A linear distance in the X-X′ direction between the face on the X′-direction side of the first guide 730 and the face on the X-direction side of the first guidable portion 420 and a linear distance in the X-X′ direction between the face on the X-direction side of the second guide 730 and the face on the X′-direction side of the second guidable portion 420 may each be set such as to define, or may each be larger than, a movement range in which the second connector part FC2 is movable in a direction including a component of the X-X′ direction relative to the first connector part FC1.

Where the first guide 730 and the second guide 730 are movable respectively in the first guidable portion 420 and the second guidable portion 420 in a direction including a component of the Y-Y′ direction, the first guide 730 has a dimension in the Y-Y′ direction that is smaller than a dimension in the Y-Y′ direction of the first guidable portion 420, and the second guide 730 has a dimension in the Y-Y′ direction that is smaller than a dimension in the Y-Y′ direction of the second guidable portion 420. A linear distance in the Y-Y′ direction between the face on the Y-direction side of the first guide 730 and the face on the Y′-direction side of the first guidable portion 420 and a linear distance in the Y-Y′ direction between the face on the Y-direction side of the second guide 730 and the face on the Y′-direction side of the second guidable portion 420 may each be set such as to define, or may each be larger than, a movement range in which the second connector part FC2 is movable in a direction including a component of the Y direction relative to the first connector part FC1.

Note that the second housing 400 may be provided with the first guide 730 and the second guide 730, and the second portion 712 and the third portion 713 of the first housing body 710 may be provided respectively with the first guidable portion 420 and the second guidable portion 420.

Where the first housing 700 is provided with the first guide 730 and the second guide 730 but neither the first guidable portion 420 nor the second guidable portion 420 are provided, the first guide 730 and the second guide 730 are guide recesses or guide holes respectively provided in the second portion 712 and the third portion 713 of the first housing body 710, and respectively house the side wall 415 and the side wall 416 of the second housing 400 movably in the direction including the component of the at least one direction. In other words, the side wall 415 and the side wall 416 of the second housing 400 are received respectively in the first guide 730 and the second guide 730 movably in the direction including the component of the at least one direction. Where the side wall 415 and the side wall 416 are movable in the first guide 730 and the second guide 730 in a direction including a component of the Z-Z′ direction, the dimension in the Z-Z′ direction of the first guide 730 is larger than a dimension in the Z-Z′ direction of the side wall 415, and the dimension in the Z-Z′ direction of the second guide 730 is larger than a dimension in the Z-Z′ direction of the second guidable portion 420. Where the side wall 415 and the side wall 416 are movable in the first guide 730 and the second guide 730 in a direction including a component of the X-X′ direction, the dimension in the X-X′ direction of the first guide 730 is larger than a dimension in the X-X′ direction of the side wall 415, and the dimension in the X-X′ direction of the second guide 730 is larger than a dimension in the X-X′ direction of the second guidable portion 420. Where the side wall 415 and the side wall 416 are movable in the first guide 730 and the second guide 730 in a direction including a component of the Y-Y′ direction, the dimension in the Y-Y′ direction of the first guide 730 is larger than a dimension in the Y-Y′ direction of the side wall 415, and the dimension in the Y-Y′ direction of the second guide 730 is larger than a dimension in the Y-Y′ direction of the second guidable portion 420.

Where the second housing 400 is omitted, the first guide 730 and the second guide 730 are guide recesses or guide holes respectively provided in the second portion 712 and the third portion 713 of the first housing body 710, and respectively house the end portions on the X- and X′-direction sides of the second connector part FC2 (the end portions on the X- and X′-direction sides of the second shell body 310b of the second shell 300b of the second connector part FC2 (if the second shell 300b is provided), or alternatively the end portions on the X- and X′-direction sides of the second body main portion 110b of the second body 100b of the second connector part FC2) movably in the direction including the component of the at least one direction. In other words, the end portions on the X- and X′-direction sides of the second connector part FC2 are received respectively in the first guide 730 and the second guide 730 movably in the direction including the component of the at least one direction. Where the end portions on the X- and X′-direction sides of the second connector part FC2 are movable respectively in the first guide 730 and the second guide 730 in a direction including a component of the Z-Z′ direction, the dimension in the Z-Z′ direction of the first guide 730 is larger than a dimension in the Z-Z′ direction of the end portion on the X-direction side of the second connector part FC2, and the dimension in the Z-Z′ direction of the second guide 730 is larger than a dimension in the Z-Z′ direction of the end portion on the X′-direction side of the second connector part FC2. Where the end portions on the X- and X′-direction sides of the second connector part FC2 are movable respectively in the first guide 730 and the second guide 730 in a direction including a component of the X-X′ direction, the dimension in the X-X′ direction of the first guide 730 is larger than a dimension in the X-X′ direction of the end portion on the X-direction side of the second connector part FC2, and the dimension in the X-X′ direction of the second guide 730 is larger than a dimension in the X-X′ direction of the end portion on the X′-direction side of the second connector part FC2. Where the end portions on the X- and X′-direction sides of the second connector part FC2 are movable respectively in the first guide 730 and the second guide 730 in a direction including a component of the Y-Y′ direction, the dimension in the Y-Y′ direction of the first guide 730 is larger than a dimension in the Y-Y′ direction of the end portion on the X-direction side of the second connector part FC2, and the dimension in the Y-Y′ direction of the second guide 730 is larger than a dimension in the Y-Y′ direction of the end portion on the X′-direction side of the second connector part FC2.

The first guidable portion 420 and the second guidable portion 420 may be provided respectively in an end portion on the X-direction side and an end portion on the X′-direction side of the second shell body 310b of the second shell 300b of the second connector part FC2 (if the second shell 300b is provided), and/or respectively in an end portion on the X-direction side and an end portion on the X′-direction side of the second body main portion 110b of the second body 100b of the second connector part FC2.

Note that the at least one guide 730 described above may be a single guide 730. The at least one guide 730 described above can be omitted.

The first housing 700 may further include a plurality of partitions 740. The plurality of partitions 740 extend in the Y direction from the first portion 711 of the first housing 700 and are arranged at intervals in the X-X′ direction. The plurality of partitions 740 include a plurality of sets of two adjacent partitions 740 adjacent in the X-X′ direction. Each of the top portions 233 of the elastically deformable portions 230 of the plurality of terminals 200 is disposed between the two adjacent partitions 740 of each set. Each of the top portions 233 of the elastically deformable portions 230 of the plurality of terminals 200 may, but is not required to, be guided between the two adjacent partitions 740 of each set such as to be movable in the direction including the component of the at least one direction. The plurality of partitions 740 can be omitted.

The first housing 700 may further include a locking arm 750. The locking arm 750 is provided in the bottom portion 721 of the retaining portion 720 of the first housing 700 and extends in the Y direction. The locking arm 750 can be omitted.

Where the second connector part FC2 is configured to be incapable of being displaced in the Z-Z′ direction, the first housing 700 may include a first restriction wall (not illustrated) abutting the second connector part FC2 or the second end portions 232 of the elastically deformable portions 230 of the plurality of terminals 200 from the Z- and Z′-direction sides to restrict the displacement of the second end portions 232 in the Z-Z′ direction. The first restriction wall may be disposed such as not to prevent displacement in the X-X′ and Y-Y′ directions of the second connector part FC2 or the second end portions 232 of the elastically deformable portions 230 of the plurality of terminals 200. Where the second connector part FC2 is configured to be incapable of being displaced in the X-X′ direction, the first housing 700 may include a second restriction wall (not illustrated) abutting the second connector part FC2 or the second end portions 232 of the elastically deformable portions 230 of the plurality of terminals 200 from the X- and X′-direction sides to restrict the displacement of the second end portions 232 in the X-X′ direction. The second restriction wall may be disposed such as not to prevent displacement in the Z-Z′ and Y-Y′ directions of the second connector part FC2 or the second end portions 232 of the elastically deformable portions 230 of the plurality of terminals 200. Where the second connector part FC2 is configured to be incapable of being displaced in the Y-Y′ direction, the first housing 700 may include a third restriction wall (not illustrated) abutting the elastically deformable portions 230 of the plurality of terminals 200 from the Y- and Y′-direction sides to restrict the displacement of the second end portions 232 in the Y-Y′ direction. The third restriction wall may be disposed such as not to prevent displacement in the Z-Z′ and X-X′ directions of the second connector part FC2 or the second end portions 232 of the elastically deformable portions 230 of the plurality of terminals 200.

The first housing 700 itself may be omitted.

The connector FC may further include a first retainer 500a. The first retainer 500a is constituted by an insulating resin or the like. The first retainer 500a includes a retainer body 510a, a first locking piece 520a, and a second locking piece 520a. The retainer body 510a extends in the X-X′ direction. The first locking piece 520a and the second locking piece 520a extend in the Z′ direction from the retainer body 510b and are spaced from each other in the X-X′ direction. The first locking piece 520a and the second locking piece 520a are received respectively in the first locking hole 726 and the second locking hole 726 of the retaining portion 720 of the first housing 700 from the Z-direction side, and distal portions of the first and second locking pieces 520a are provided with respective lugs respectively locked in the first and second locking holes 726. In this locked state, a face on the Y-direction side of the retainer body 510a abuts a face on the Y-direction side of the first locking hole 726 and a face on the Y-direction side of the second locking hole 726 of the retaining portion 720, a face on the Y′-direction side of the retainer body 510a abuts a face on the Y′-direction side of a portion of the first body 100a that links the first body main portion 110a and the first partitions 120a. Also in the locked state, the retainer body 510a abuts, from the Z-direction side, the first shell body 310a of the first shell 300a retained in the retaining portion 720, or alternatively, the retainer body 510a faces, from the Z-direction side, the first shell body 310a of the first shell 300a retained in the retaining portion 720 f such that the retainer body 510a is located in the vicinity of the first shell body 310a with a gap therebetween. The first retainer 500a may thus serve to fix the first shell body 310a to the retaining portion 720 of the first housing 700. Note that the first retainer 500a and the first housing 700 can both be omitted. Even where the first housing 700 is provided, the first retainer 500a can be omitted.

The connector FC may further include a first shield 800 having electrical conductivity. The first shield 800 may be constituted by an electrically conductive material (e.g., a metal plate or the like), or may include an insulating material (e.g., an insulating resin or the like) and metal vapor-deposited on an inner or outer surface of the insulating material. The first shield 800 includes a first shield body 810 having a generally U shape in sectional view along the X-X′ and Y-Y′ directions. The first shield body 810 may include a first shield portion 811, a second shield portion 812, and a third shield portion 813.

The first shield portion 811 is a plate on the Y′-direction side of the first shield body 810. Where the first housing 700 is provided, the first shield portion 811 abuts the first portion 711 of the first housing 700 from the Y′-direction side, and covers the first portion 711, the first connector part FC1, the second connector part FC2, and the elastically deformable portions 230 of the plurality of terminals 200 from the Y′-direction side. Where the first housing 700 is not provided, the first shield portion 811 is disposed such as to cover the first connector part FC1, the second connector part FC2, and the elastically deformable portions 230 of the plurality of terminals 200 from the Y′-direction side.

The second shield portion 812 is a plate on the X-direction side of the first shield body 810 and extends in the Y direction from the end on the X-direction side of the first shield portion 811. Where the first housing 700 is provided, the second shield portion 812 abuts the second portion 712 of the first housing 700 from the X-direction side, and covers the second portion 712, the first connector part FC1, the second connector part FC2, and the elastically deformable portions 230 of the plurality of terminals 200 from the X-direction side. Where the first housing 700 is not provided, the second shield portion 812 is disposed such as to cover the first connector part FC1, the second connector part FC2, and the elastically deformable portions 230 of the plurality of terminals 200 from the X-direction side.

The third shield portion 813 is a plate on the X′-direction side of the first shield body 810 and extends in the Y direction from the end on the X′-direction side of the first shield portion 811. Where the first housing 700 is provided, the third shield portion 813 abuts the third portion 713 of the first housing 700 from the X′-direction side, and covers the third portion 713, the first connector part FC1, the second connector part FC2, and the elastically deformable portions 230 of the plurality of terminals 200 from the X′-direction side. Where the first housing 700 is not provided, the third shield portion 813 is disposed such as to cover the first connector part FC1, the second connector part FC2, and the elastically deformable portions 230 of the plurality of terminals 200 from the X′-direction side.

Where the first housing 700 is provided, the first shield 800 may include a plurality of locking pieces. The plurality of locking pieces include at least one group of locking pieces selected from a plurality of first locking pieces 820, a plurality of second locking pieces 830, a plurality of third locking pieces 840, and a plurality of fourth locking pieces 850.

Each of the first locking pieces 820 is a bent piece provided at the end on the Z′-direction side of the first shield body 810, and abuts the first housing body 710 of the first housing 700 from the Z′-direction side. The first locking pieces 820 shown in FIGS. 1A to 3B are plate-like pieces, two of which are provided at the end on the Z′-direction side of the second shield portion 812 of the first shield body 810, and the other two of which are provided at the end on the Z′-direction side of the third shield portion 813 of the first shield body 810. The two first locking pieces 820 at the second shield portion 812 abut the second portion 712 of the first housing body 710 from the Z′-direction side, and the two first locking pieces 820 at the third shield portion 813 abut the third portion 713 of the first housing body 710 from the Z′-direction side.

Each of the second locking pieces 830 is a bent piece provided at the end on the Z-direction side of the first shield body 810, and abuts the first housing body 710 of the first housing 700 from the Z-direction side. The second locking pieces 830 shown in FIGS. 1A to 3B are hook-shaped pieces, one of which is provided at the end on the Z-direction side of the second shield portion 812 of the first shield body 810, and the other one of which is provided at the end on the Z-direction side of the third shield portion 813 of the first shield body 810. The second locking piece 830 at the second shield portion 812 is hooked on the second portion 712 of the first housing body 710 from the Z-direction side, and the second locking piece 830 at the third shield portion 813 is hooked on the third portion 713 of the first housing body 710 from the Z-direction side.

Each of the third locking pieces 840 is a bent piece of generally L shape, provided at the end on the Y-direction side of the first shield body 810, and abuts the first housing body 710 of the first housing 700 from the Y-direction side. The third locking pieces 840 shown in FIGS. 1A to 3B are hook-shaped pieces, one of which is provided at the end on the Y-direction side of the second shield portion 812 of the first shield body 810, and the other one of which is provided at the end on the Y-direction side of the third shield portion 813 of the first shield body 810. The third locking piece 840 at the second shield portion 812 is hooked on the second portion 712 of the first housing body 710 from the Y-direction side, and the third locking piece 840 at the third shield portion 813 is hooked on the third portion 713 of the first housing body 710 from the Y-direction side.

Each of the fourth locking pieces 850 is a bent piece provided at the end on the Y-direction side of the first shield body 810, and abuts the first housing body 710 of the first housing 700 from the Y-direction side. The fourth locking pieces 850 shown in FIGS. 1A to 3B are plate-like pieces, one of which is provided at the end on the Y-direction side of the second shield portion 812 of the first shield body 810, and the other one of which is provided at the end on the Y-direction side of the third shield portion 813 of the first shield body 810. The fourth locking piece 850 at the second shield portion 812 abuts the second portion 712 of the first housing body 710 from the Y-direction side, and the fourth locking piece 850 at the third shield portion 813 abuts the third portion 713 of the first housing body 710 from the Y-direction side.

Note that the plurality of locking pieces can be omitted. The first shield 800 itself can be omitted.

The connector FC may further include a second shield 900. The second shield 900 may be constituted by an electrically conductive material (e.g., a metal plate or the like), or may include an insulating material (e.g., an insulating resin or the like) and metal vapor-deposited on an inner or outer surface of the insulating material. The second shield 900 may be electrically connected to the first shield 800 (if provided).

The second shield 900 includes a second shield body 910 having a plate-like shape extending in the Z-Z′ and X-X′ directions. The second shield body 910 is disposed between the first connector part FC1 and the second connector part FC2 and covers the elastically deformable portions 230 of the plurality of terminals 200 from the Y-direction side. The second shield body 910 is located on the Y-direction side relative to the first shield portion 811 of the first shield body 810.

Where the at least one second wall 320b of the second shell 300b is provided, in a state where the second connector part FC2 is located at the normal position, the second shield body 910 may be disposed on the Y-direction side relative to, and at a predetermined distance (a predetermined linear distance in the Y-Y′ direction) from, the at least one second wall 320b. When the second connector part FC2 is displaced by the predetermined distance in the Y direction, the at least one second wall 320b thereby abuts the second shield body 910. Thus the displacement of the second connector part FC2 to the Y-direction side is restricted to the predetermined distance. Note that the second shield body 910 may be disposed at a distance larger than the predetermined distance from the at least one second wall 320b.

Where the first shell 300a is provided, at least one shield of the first shield 800 or the second shield 900 may include at least one first connecting portion 920a. The at least one first connecting portion 920a is only required to be electrically connected to the first shell 300a.

The at least one first connecting portion 920a may be, for example, at least one spring piece extending from the at least one shield to the other shield, and may be in contact with the first shell 300a.

Where the at least one first connecting portion 920a is provided at the second shield 900 (see FIGS. 1A to 3B), the at least one first connecting portion 920a may be at least one spring piece extending in the Y′ direction from the second shield body 910, and may be in elastic contact with the at least one first wall 320a (if provided) or the first shell body 310a of the first shell 300a from the X- or X′-direction side. The at least one first connecting portion 920a may be bent such as to entirely or partly have a generally V shape protruding toward the at least one first wall 320a (if provided) or the first shell body 310a of the first shell 300a. Or alternatively, the at least one first connecting portion 920a may be curved such as to entirely or partly have a generally arc shape protruding toward the at least one first wall 320a (if provided) or the first shell body 310a of the first shell 300a.

The at least one first connecting portion 920a may include a pair of first connecting portions 920a, and the pair of first connecting portions 920a may include a first connecting portion 920a on the X-direction side (primary first connecting portion 920a) and a first connecting portion 920a on the X′-direction side (secondary first connecting portion 920a). In this case, the first connecting portion 920a on the X-direction side may extend in the Y′ direction from the end on the X-direction side of the second shield body 910 and may be in elastic contact with the first wall 320a on the X-direction side (if provided) or the first shell body 310a from the X-direction side; and the first connecting portion 920a on the X′-direction side may extend in the Y′ direction from the end on the X′-direction side of the second shield body 910 and may be in elastic contact with the first wall 320a on the X′-direction side (if provided) or the first shell body 310a from the X′-direction side.

Where the at least one first connecting portion 920a is provided at the first shield 800 (not illustrated), the at least one first connecting portion 920a may be at least one spring piece extending from the first shield body 810 to the first shell 300a, and may be in elastic contact with the at least one first wall 320a (if provided) or the first shell body 310a of the first shell 300a from the X- or X′-direction side. The at least one first connecting portion 920a may extend through at least one first through hole, at least one first recess, or the like provided in the first housing body 710 of the first housing 700 to elastically contact the at least one first wall 320a (if provided) or the first shell body 310a of the first shell 300a from the X- or X′-direction side. The at least one first connecting portion 920a may be bent such as to entirely or partly have a generally V shape protruding toward the at least one first wall 320a (if provided) or the first shell body 310a of the first shell 300a. Or alternatively, the at least one first connecting portion 920a may be curved such as to entirely or partly have a generally arc shape protruding toward the at least one first wall 320a (if provided) or the first shell body 310a of the first shell 300a.

Where the at least one first connecting portion 920a includes the first connecting portion 920a on the X-direction side and the first connecting portion 920a on the X′-direction side, the first connecting portion 920a on the X-direction side extends from the end on the Y-direction side of the second shield portion 812 of the first shield body 810, is folded over to the X′- and Y′-direction sides, and is in elastic contact with the first wall 320a on the X-direction side (if provided) or the first shell body 310a from the X-direction side, and the first connecting portion 920a on the X′-direction side extends from the end on the Y-direction side of the third shield portion 813 of the first shield body 810, is folded over to the X- and Y′-direction sides, and is in elastic contact with the first wall 320a on the X′-direction side (if provided) or the first shell body 310a from the X′-direction side.

Regardless of whether the at least one first connecting portion 920a is provided at the first shield 800 or the second shield 900, where the at least one first connecting portion 920a is in elastic contact with the first shell body 310a retained by the retaining portion 720, the retaining portion 720 may be provided with at least one first housing groove to receive the at least one first connecting portion 920a. The at least one first housing groove opens out in the Y direction and toward the first shell body 310a. Where the at least one first connecting portion 920a includes the pair of first connecting portions 920a, a first housing groove on the X-direction side is provided in the side wall on the X-direction side of the retaining portion 720, and a first housing groove on the X′-direction side is provided to the side wall on the X′-direction side of the retaining portion 720.

Where the second shell 300b is provided, at least one shield of the first shield 800 or the second shield 900 may include at least one second connecting portion 920b. The at least one second connecting portion 920b is only required to be electrically connected to the second shell 300b. The at least one second connecting portion 920b may be, for example, at least one spring piece extending from the at least one shield to the other shield, and may be in contact with the second shell 300b.

Where the at least one second connecting portion 920b is provided in the second shield 900 (see FIGS. 1A to 3B), the at least one second connecting portion 920b may be at least one spring piece extending in the Y′ direction from the second shield body 910, and may be in elastic contact with the at least one second wall 320b (if provided) or the second shell body 310b of the second shell 300b from the X- or X′-direction side. The at least one second connecting portion 920b may be bent such as to entirely or partly have a generally V shape protruding toward the at least one second wall 320b (if provided) or the second shell body 310b of the second shell 300b. Or alternatively, the at least one second connecting portion 920b may be curved such as to entirely or partly have a generally arc shape protruding toward the at least one second wall 320b (if provided) or the second shell body 310b of the second shell 300b.

The at least one second connecting portion 920b may include a pair of second connecting portions 920b, and the pair of second connecting portions 920b may include a second connecting portion 920b on the X-direction side (primary second connecting portion 920b) and a second connecting portion 920b on the X′-direction side (secondary second connecting portion 920b). In this case, the second connecting portion 920b on the X-direction side may extend in the Y′ direction from the end on the X-direction side of the second shield body 910 and may be in elastic contact with the second wall 320b on the X-direction side (if provided) or the second shell body 310b from the X-direction side; and the second connecting portion 920b on the X′-direction side may extend in the Y′ direction from the end on the X′-direction side of the second shield body 910 and may be in elastic contact with the second wall 320b on the X′-direction side (if provided) or the second shell body 310b from the X′-direction side.

Where the at least one second connecting portion 920b is provided at the first shield 800 (not illustrated), the at least one second connecting portion 920b may be at least one spring piece extending from the first shield body 810 to the second shell 300b, and may be in elastic contact with the at least one second wall 320b (if provided) or the second shell body 310b of the second shell 300b from the X- or X′-direction side. The at least one second connecting portion 920b may be bent such as to entirely or partly have a generally V shape protruding toward the at least one second wall 320b (if provided) or the second shell body 310b of the second shell 300b. Or alternatively, the at least one second connecting portion 920b may be curved such as to entirely or partly have a generally arc shape protruding toward the at least one second wall 320b (if provided) or the second shell body 310b of the second shell 300b. The at least one second connecting portion 920b may extend through at least one second through hole, at least one second recess, or the like provided in the first housing body 710 of the first housing 700 to elastically contact the at least one second wall 320b (if provided) or the second shell body 310b of the second shell 300b from the X- or X′-direction side.

Where the at least one second connecting portion 920b includes the second connecting portion 920b on the X-direction side and the second connecting portion 920b on the X′-direction side, the second connecting portion 920b on the X-direction side may extend from the end on the Y-direction side of the second shield portion 812 of the first shield body 810, may be folded over to the X′- and Y′-direction sides, and may be in elastic contact with the second wall 320b on the X-direction side (if provided) or the second shell body 310b from the X-direction side, and the second connecting portion 920b on the X′-direction side may extend from the end on the Y-direction side of the third shield portion 813 of the first shield body 810, may be folded over to the X- and Y′-direction sides, and may be in elastic contact with the second wall 320b on the X′-direction side (if provided) or the second shell body 310b from the X′-direction side.

Regardless of whether the at least one second connecting portion 920b is provided at the first shield 800 or the second shield 900, where the at least one second connecting portion 920b is in elastic contact with the second shell body 310b fitted in the second housing body 410, the second housing body 410 may be provided with at least one second housing groove to receive the at least one second connecting portion 920b. The at least one second housing groove opens out in the Y direction and toward the second shell body 310b. Where the at least one second connecting portion 920b includes the pair of second connecting portions 920b, a second housing groove on the X-direction side is provided in the side wall on the X-direction side of the second shell body 310b, and a second housing groove on the X′-direction side is provided in the side wall on the X′-direction side of the second shell body 310b. Note that the at least one second connecting portion 920b can be omitted.

Where the first shield 800 and the second shield 900 are electrically connected to each other, at least one shield of the first shield 800 or the second shield 900 may include at least one third connecting portion 930. The at least one third connecting portion 930 is only required to be electrically connected to the other shield.

The at least one third connecting portion 930 is, for example, at least one spring piece extending from the at least one shield, and is in contact with the other shield.

Where the at least one third connecting portion 930 is provided at the second shield 900 (see FIGS. 1A to 3B), the at least one third connecting portion 930 may be at least one spring piece extending in the Y′ direction from the second shield body 910, and may be in elastic contact with the first shield body 810 of the first shield 800 from the X- or X′-direction side. The at least one third connecting portion 930 may be bent such as to entirely or partly (e.g., a distal portion on the Y′-direction side) have has a generally V shape protruding toward the first shield body 810 of the first shield 800, or may be curved such as to entirely or partly (e.g., a distal portion on the Y′-direction side) have a generally arc shape protruding toward the first shield body 810 of the first shield 800.

The at least one third connecting portion 930 may include a pair of third connecting portions 930, and the pair of third connecting portions 930 may include a third connecting portion 930 on the X-direction side (primary third connecting portion 930) and a third connecting portion 930 on the X′-direction side (secondary third connecting portion 930). In this case, the third connecting portion 930 on the X-direction side may extend in the Y′ direction from the end on the X-direction side of the second shield body 910, be housed in the housing groove 712a of the second portion 712 from the Y-direction side, and be in elastic contact with the second shield portion 812 of the first shield body 810 from the X′-direction side; and the third connecting portion 930 on the X′-direction side may extend in the Y′ direction from the end on the X′-direction side of the second shield body 910, be housed in the housing groove 713a of the third portion 713 from the Y-direction side, and be in elastic contact with the third shield portion 813 of the first shield body 810 from the X-direction side. The third connecting portion 930 on the X-direction side may, but is not required to, include a pair of locking protrusions protruding respectively in the Z direction and the Z′ direction. In a state where the third connecting portion 930 on the X-direction side is housed in the housing groove 712a, the pair of locking protrusions of the third connecting portion 930 may be locked respectively to the wall on the Z-direction side and the wall on the Z′-direction side of the housing groove 712a. The third connecting portion 930 on the X′-direction side may, but is not required to, include a pair of locking protrusions respectively protruding in the Z direction and the Z′ direction. In a state where the third connecting portion 930 on the X′-direction side is housed in the housing groove 713a, the pair of locking protrusions of the third connecting portion 930 may be locked respectively to the wall on the Z-direction side and the wall on the Z′-direction side of the housing groove 713a.

The second shield portion 812 of the first shield body 810 may be provided with a protrusion 812a protruding to the X′-direction side (see FIG. 3A). The protrusion 812a is located in the housing groove 712a. The distal portion of the third connecting portion 930 on the X-direction side may be configured to be not in contact with the second shield portion 812 with a gap therebetween, from the start of its insertion into the housing groove 712a until it is completely housed in the housing groove 712a (before reaching the protrusion 812a of the second shield portion 812), but may be in elastic contact with the protrusion 812a of the second shield portion 812 from the X′-direction side when completely housed in the housing groove 712a (in a state of having reached the protrusion 812a of the second shield portion 812). Alternatively, the distal portion of the third connecting portion 930 on the X-direction side may be configured to be in elastic contact with the second shield portion 812, from the start of its insertion into the housing groove 712a until it is completely housed in the housing groove 712a, and may be in elastic contact with the protrusion 812a of the second shield portion 812 from the X′-direction side when completely housed in the housing groove 712a (in a state of having reached the protrusion 812a of the second shield portion 812). In either case, the third connecting portion 930 on the X-direction side provides increased contact pressure against the second shield portion 812. In a state where the third connecting portion 930 on the X-direction side has reached the protrusion 812a of the second shield portion 812, the third connecting portion 930 on the X-direction side may be locked in the housing groove 712a in a manner as described above. The third shield portion 813 of the first shield body 810 may be provided with a protrusion 813a protruding to the X-direction side (see FIG. 3A). The protrusion 813a is located in the housing groove 713a. The distal portion of the third connecting portion 930 on the X′-direction side may be configured to be not in contact with the third shield portion 813 of the first shield body 810 with a gap therebetween, from the start of its insertion into the housing groove 713a until it is completely housed in the housing groove 713a (before reaching the protrusion 813a of the third shield portion 813), but may be in elastic contact with the protrusion 813a of the third shield portion 813 from the X-direction side when completely housed in the housing groove 713a (in a state of having reached the protrusion 813a of the third shield portion 813). Alternatively, the distal portion of the third connecting portion 930 on the X′-direction side may be configured to be in elastic contact with the third shield portion 813 of the first shield body 810, from the start of its insertion into the housing groove 713a until it is completely housed in the housing groove 713a, and may be in elastic contact with the protrusion 813a of the third shield portion 813 from the X-direction side when completely housed in the housing groove 713a (in a state of having reached the protrusion 813a of the third shield portion 813). In either case, the third connecting portion 930 on the X′-direction side provides increased contact pressure against the third shield portion 813. In a state where the third connecting portion 930 on the X′-direction side has reached the protrusion 813a of the third shield portion 813, the third connecting portion 930 on the X′-direction side may be locked in the housing groove 713a in a manner as described above. Note that the protrusion 812a and the protrusion 813a can be omitted.

The third connecting portion 930 on the X-direction side includes a bent portion bent by approximately 90 degrees relative to the second shield body 910. The bent portion may be provided with a window 940 formed through the bent portion. The third connecting portion 930 on the X′-direction side includes a bent portion bent by approximately 90 degrees relative to the second shield body 910. The bent portion may be provided with a window 940 formed through the bent portion. Respective end faces on the Y′-direction side of the windows 940 function as pressing faces to be pressed by a jig from the Y-direction side when the third connecting portion 930 on the X-direction side is inserted into the housing groove 712a and the third connecting portion 930 on the X′-direction side is inserted into the housing groove 713a. The windows 940 can be omitted.

Alternatively, the third connecting portion 930 on the X-direction side may extend in the Y′ direction from the end on the X-direction side of the second shield body 910 and be in elastic contact with the second shield portion 812 of the first shield body 810 from the X′-direction side, and the third connecting portion 930 on the X′-direction side may extend in the Y′ direction from the end on the X′-direction side of the second shield body 910 and be in elastic contact with the third shield portion 813 of the first shield body 810 from the X-direction side.

Where the at least one third connecting portion 930 is provided at the first shield 800 (not illustrated), the at least one third connecting portion 930 may be at least one spring piece extending from the first shield body 810 to the second shield body 910 and be in elastic contact with the second shield body 910. For example, the at least one third connecting portion 930 may extend through at least one third through hole, at least one third recess, or the like provided in the first housing body 710 of the first housing 700 to elastically contact the second shield body 910. The at least one third connecting portion 930 may extend from the end on the Y-direction side of the second shield portion 812 of the first shield body 810, and be bent in the X′ direction, and be in elastic contact with the second shield body 910 from the Y-direction side. Alternatively, the at least one third connecting portion 930 may extend from the end on the Y-direction side of the third shield portion 813 of the first shield body 810, be bent in the X direction, and be in elastic contact with the second shield body 910 from the Y-direction side. The at least one third connecting portion 930 may be bent such as to entirely or partly have a generally V shape protruding toward the second shield body 910, or alternatively be curved such as to entirely or partly have a generally arc shape protruding toward the second shield body 910.

Note that the at least one third connecting portion 930 can be omitted. In this case, the first shield 800 and the second shield 900 may be electrically connected to each other via the first shell 300a and/or the second shell 300b, by being electrically connected to the first shell 300a and/or the second shell 300b in a manner described above. Alternatively, the first shield 800 and the second shield 900 may be electrically connected to each other via a cable, a different terminal, or the like. Still alternatively, the first shield 800 and the second shield 900 may be electrically connected to each other by bringing the first shield body 810 of the first shield 800 into contact with the second shield body 910 of the second shield 900.

The following describes non-limiting methods for manufacturing the connector FC described above. First, the first body 100a and the plurality of terminals 200 are prepared.

The first contacting portions 210a of the plurality of terminals 200 are inserted into the respective retaining holes 111a and/or the respective retaining grooves 112a of the first body 100a from the Y′-direction side, and the first retainable portions 220a of the plurality of terminals 200 are inserted into and retained by the respective retaining holes 111a and/or the respective retaining grooves 112a of the first body 100a. The first retainable portions 220a of the plurality of terminals 200 are thus retained in the first body 100a at intervals in the X-X′ direction. At this time, the first contacting portions 210a of the plurality of terminals 200 at least partly protrude in the Y direction from the respective retaining holes 111a or the respective retaining grooves 112a of the first body 100a, or alternatively are disposed in the respective connection holes (if provided) of the first body 100a and are exposed, or protrude, at least partly in the Y direction from the respective connection holes.

Where the plurality of terminals 200 include the respective first linking portions 240a and the first body 100a includes the plurality of first partitions 120a, when the first retainable portions 220a of the plurality of terminals 200 are retained in the first body 100a, the first linking portions 240a of the plurality of terminals 200 are inserted between the respective two of the plurality of first partitions 120a of the first body 100a.

After thus assembling the plurality of terminals 200 to the first body 100a, the first shell 300a is prepared.

The first body 100a is inserted into, and retained by, the first shell body 310a of the first shell 300a from the Y′-direction side. Consequently, the first contacting portions 210a and the first retainable portions 220a of the plurality of terminals 200 are at least partly disposed in the first shell body 310a together with the first body 100a. At the same time, the portion of the first shell body 310a that is located on the Y-direction side relative to the first body 100a defines the first connection space. Where the first contacting portions 210a of the plurality of terminals 200 at least partly protrude from the first body 100a, the first contacting portions 210a are at least partly disposed in the first connection space of the first shell body 310a.

Where the first shell 300a includes the pair of first walls 320a, when the first body 100a is inserted into the first shell body 310a of the first shell 300a, the first linking portions 240a of the plurality of terminals 200 are disposed between the pair of first walls 320a. The first body 100a may be retained in the first shell body 310a of the first shell 300a before assembling the plurality of terminals 200 to the first body 100a as described above.

Thus the first connector part FC1 is assembled.

The second body 100b is prepared. The second contacting portions 210b of the plurality of terminals 200 are inserted into the respective retaining holes 111b and/or the respective retaining grooves 112b of the second body 100b from the Y′-direction side, and the second retainable portions 220b of the plurality of terminals 200 are inserted into and retained by the respective retaining holes 111b and/or the respective retaining grooves 112b of the second body 100b. The second retainable portions 220b of the plurality of terminals 200 are thus retained in the second body 100b at intervals in the X-X′ direction. At this time, the second contacting portions 210b of the plurality of terminals 200 at least partly protrude in the Y direction from the respective retaining holes 111b and/or the alternatively retaining grooves 112b of the second body 100b, or alternatively are disposed in the respective connection holes (if provided) of the second body 100b and are exposed, or protrude, at least partly in the Y direction from the respective connection holes. Where the plurality of terminals 200 include the second linking portions 240b and the second body 100b include the plurality of second partitions 120b, when the second retainable portions 220b of the plurality of terminals 200 are retained in the second body 100b, the second linking portions 240b of the plurality of terminals 200 are inserted between the respective two of the plurality of second partitions 120b of the second body 100b.

After the plurality of terminals 200 are assembled to the second body 100b as described above, the second shell 300b is prepared.

The second body 100b is inserted into and retained by the second shell body 310b of the second shell 300b from the Y′-direction side. Consequently, the second contacting portions 210b and the second retainable portions 220b of the plurality of terminals 200 are at least partly disposed in the second shell body 310b together with the second body 100b. At the same time, the portion of the second shell body 310b that is located on the Y-direction side relative to the second body 100b defines the second connection space. Where the second contacting portions 210b of the plurality of terminals 200 at least partly protruded from the second body 100b, the second contacting portions 210b at least partly disposed in the second connection space of the second shell body 310b.

Where the second shell 300b includes the pair of second walls 320b, when the second body 100b is inserted into the second shell body 310b of the second shell 300b, the second linking portions 240b of the plurality of terminals 200 are disposed between the pair of second walls 320b. Note that the second body 100b may be retained in the second shell body 310b of the second shell 300b before assembling the plurality of terminals 200 to the second body 100b as described above.

After the second body 100b is retained in the second shell body 310b of the second shell 300b, the second housing 400 is prepared. The second shell body 310b of the second shell 300b is inserted into, and retained by, the second housing body 410 of the second housing 400 from the Y-direction side.

Where the second housing body 410 is provided with the retaining base 417, when the second shell body 310b of the second shell 300b is inserted into the second housing body 410 of the second housing 400, the retaining base 417 is brought into abutment from the Y′-direction side with the second linking portions 240b (if provided) of the plurality of terminals 200, or is disposed in spaced relation to the second linking portions 240b (if provided) of the plurality of terminals 200, the plate 130b of the second body 100b and the portion on the Y′-direction side of the wall on the Z-direction side of the second shell body 310b are fitted into the first gap 418 between the ceiling plate 414 and the retaining base 417 of the second housing body 410, the portion on the Y′-direction side of the side wall 140b on the X-direction side of the second body 100b and the portion on the Y′-direction side of the wall on the X-direction side of the second shell body 310b thereon are inserted into the second gap between the side wall 415 and the retaining base 417 of the second housing body 410, and the portion on the Y′-direction side of the side wall 140b on the X′-direction side of the second body 100b and the portion on the Y′-direction side of the wall on the X′-direction side of the second shell body 310b thereon are inserted into the third gap between the side wall 416 and the retaining base 417 of the second housing body 410.

Where the at least one second wall 320b of the second shell 300b is provided, when the second shell body 310b of the second shell 300b is inserted into the second housing body 410 of the second housing 400, the at least one second wall 320b of the second shell 300b passes between the side wall 412 and the side wall 413 and between the side wall 415 and the side wall 416 of the second housing body 410 having the above-described generally U shape and is disposed on the Z′-direction side relative to the second housing body 410, or passes through the at least one slit of the bottom portion of the second housing body 410 having the above-described generally ring shape and is disposed on the Z′-direction side relative to the second housing body 410. Where the at least one second wall 320b is not provided, the above step is omitted.

Where the second retainer 500b is provided, the second retainer 500b is prepared. The first locking piece 520b and the second locking piece 520b of the second retainer 500b are inserted respectively into the first locking hole 460 and the second locking hole 460 of the second housing 400 from the Z′-direction side, and lugs at the distal portions of and the first and second locking pieces 520b are locked respectively to the first locking hole 460 and the second locking hole 460. At this time, the second retainer 500b fixes the second shell body 310b of the second shell 300b to the second housing body 410 of the second housing 400.

Thus the second connector part FC2 is assembled. Where the second housing 400 is omitted, the steps relating to the second housing 400 are omitted from the steps for assembling the second connector part FC2. Also, where the second retainer 500b is omitted, the steps relating to the second retainer 500b are omitted from the steps for assembling the second connector part FC2.

Where the rotating lever 600 is provided, the shaft 430 of the second housing 400 is inserted into the shaft hole 611 of the lever body 610 of the rotating lever 600. Thereafter, the screw or pin 620 of the rotating lever 600 is inserted into, and fixed to, the shaft hole of the shaft 430. Alternatively, the shaft hole 611 of the lever body 610 of the rotating lever 600 is disposed such as to communicate with the shaft hole of the second housing 400. Thereafter, the screw or pin 620 of the rotating lever 600 is inserted into, and fixed to, the shaft hole of the shaft 430 and the shaft hole of the second housing 400. Thus the rotating lever 600 is rotatably attached onto the second housing 400.

Where the first housing 700 is provided, the first housing 700 is prepared. Where the first shield 800 is provided, the first shield 800 is prepared. Where the first shield 800 is provided with the plurality of first locking pieces 820, the plurality of first locking pieces 820 extend in the Z′ direction. The first housing body 710 of the first housing 700 is inserted into the first shield body 810 of the first shield 800 from the Z′-direction side. Consequently, the first shield portion 811 of the first shield body 810 of the first shield 800 is brought into abutment with the first portion 711 of the first housing 700, the second shield portion 812 of the first shield body 810 of the first shield 800 is brought into abutment with the second portion 712 of the first housing 700, and the third shield portion 813 of the first shield body 810 of the first shield 800 is brought into abutment with the third portion 713 of the first housing 700. Where the first shield 800 is provided with the plurality of second locking pieces 830 and/or the plurality of third locking pieces 840, when the first housing body 710 of the first housing 700 is inserted into the first shield body 810 of the first shield 800, the second portion 712 and the third portion 713 of the first housing body 710 are inserted into the plurality of second locking pieces 830 and/or the plurality of third locking pieces 840 from the Z′-direction side. Where the first shield 800 is provided with the plurality of fourth locking pieces 850, when the first housing body 710 of the first housing 700 is inserted into the first shield body 810 of the first shield 800, the second portion 712 and the third portion 713 of the first housing body 710 are brought into abutment with the plurality of fourth locking pieces 850 from the Y′-direction side. After inserting the first housing body 710 of the first housing 700 into the first shield body 810 of the first shield 800, the plurality of first locking pieces 820 are bent to abut the second portion 712 and the third portion 713 of the first housing body 710. Thus the first shield 800 is attached to the first housing 700.

After the first body 100a is retained in the first shell body 310a of the first shell 300a, the second body 100b is retained in the second shell body 310b of the second shell 300b, and the second shell body 310b of the second shell 300b is retained in the second housing body 410 of the second housing 400, the first shell body 310a of the first shell 300a is inserted into, and retained by, the retaining portion 720 of the first housing 700 from the Y-direction side.

Where the retaining portion 720 is provided with the retaining base 724, when the first shell body 310a of the first shell 300a is inserted into the retaining portion 720 of the first housing 700, the retaining base 724 is brought into abutment from the Y′-direction side with the first linking portions 240a (if provided) of the plurality of terminals 200, or disposed in spaced relation to the first linking portions 240a (if provided) of the plurality of terminals 200, the plate 130a of the first body 100a and the portion on the Y′-direction side of the wall on the Z′-direction side of the first shell body 310a are fitted into the first gap 725 between the bottom portion 721 and the retaining base 724 of the retaining portion 720, the portion on the Y′-direction side of the side wall 140a on the X-direction side of the first body 100a and the portion on the Y′-direction side of the wall on the X-direction side of the first shell body 310a thereon are inserted into the second gap between the side wall 722 and the retaining base 724 of the retaining portion 720, and the portion on the Y′-direction side of the side wall 140a on the X′-direction side of the first body 100a and the portion on the Y′-direction side of the wall on the X′-direction side of the first shell body 310a thereon are inserted into the third gap between the side wall 723 and the retaining base 724 of the retaining portion 720. Note that where the retaining base 724 is omitted, the steps relating to the retaining base 724 are omitted.

Where the at least one first wall 320a of the first shell 300a is provided, when the first shell body 310a of the first shell 300a is inserted into the retaining portion 720 of the first housing 700, the at least one first wall 320a passes between the side wall 722 and the side wall 723 of the retaining portion 720 having the above-described generally U shape to be located on the Z-direction side relative to the retaining portion 720, or alternatively passes through the at least one slit on the top plate of the retaining portion 720 having the above-described generally ring shape to be located on the Z-direction side relative to the retaining portion 720. Where the at least one first wall 320a is not provided, this step is omitted.

Where the first housing 700 is provided with the at least one guide 730, when the first shell body 310a of the first shell 300a is inserted into the retaining portion 720 of the first housing 700, the second connector part FC2 is inserted into the first housing body 710 of the first housing 700 from the Y-direction side, and the second connector part FC2 is guided by the at least one guide 730 of the first housing 700 in a manner described above. Where the at least one guide 730 is omitted, the steps relating to the at least one guide 730 are omitted.

Where the first housing 700 is provided with the plurality of partitions 740, when the first shell body 310a of the first shell 300a is inserted into the retaining portion 720 of the first housing 700, the elastically deformable portions 230 of the plurality of terminals 200 are inserted respectively between the plurality of partitions 740 of the first housing 700 from the Y-direction side. Where the plurality of partitions 740 are omitted, the steps relating to the plurality of partitions 740 are omitted.

In a state where the first shell body 310a of the first shell 300a is inserted in the retaining portion 720 of the first housing 700, the first shield portion 811 of the first shield 800 covers the first connector part FC1, the second connector part FC2, and the elastically deformable portions 230 of the plurality of terminals 200 from the Y′-direction side, the second shield portion 812 of the first shield 800 covers the first connector part FC1, the second connector part FC2, and the elastically deformable portions 230 of the plurality of terminals 200 from the X-direction side, and the third shield portion 813 of the first shield 800 covers the first connector part FC1, the second connector part FC2, and the elastically deformable portions 230 of the plurality of terminals 200 from the X′-direction side.

The first shield 800 may be attached to the first housing 700 after the first shell body 310a of the first shell 300a or the first body 100a is retained in the retaining portion 720 of the first housing 700. Where the first housing 700 is omitted, the steps relating to the first housing 700 are omitted.

Where the first retainer 500a is provided, the first retainer 500a is prepared. The first locking piece 520a and the second locking piece 520a of the first retainer 500a are inserted respectively into the first locking hole 726 and the second locking hole 726 of the retaining portion 720 of the first housing 700 from the Z-direction side, and lugs at the distal portions of the first and second locking piece 520a are locked respectively to the first locking hole 726 and the second locking hole 726. At this time, the first retainer 500a fixes the first shell body 310a of the first shell 300a to the retaining portion 720. Where the first retainer 500a is omitted, the steps relating to the first retainer 500a are omitted.

Where the second shield 900 is provided, the second shield 900 is prepared. In the Y-Y′ direction, the second shield 900 is brought relatively close to the first housing 700. The second shield body 910 of the second shield 900 is disposed between the first connector part FC1 and the second connector part FC2 and covers the elastically deformable portions 230 of the plurality of terminals 200 from the Y-direction side.

Where the second shield 900 is provided with the pair of first connecting portions 920a, when bringing the second shield 900 relatively closer to the first housing 700 in the Y-Y′ direction, the first connecting portion 920a on the X-direction side is brought into elastic contact with the first wall 320a on the X-direction side (if provided) of the first shell 300a from the X-direction side, or alternatively is housed in the first housing groove on the X-direction side of the retaining portion 720 to elastically contact the first shell body 310a of the first shell 300a from the X-direction side; and the first connecting portion 920a on the X′-direction side is brought into elastic contact with the first wall 320a on the X′-direction side (if provided) of the first shell 300a from the X′-direction side, or alternatively is housed in the first housing groove on the X′-direction side of the retaining portion 720 to elastically contact the first shell body 310a of the first shell 300a from the X′-direction side. Thus the second shield 900 and the first shell 300a are electrically connected to each other. Where the pair of first connecting portions 920a is a single first connecting portion 920a, the above steps for either one of the pair of first connecting portions 920a should apply to the single first connecting portion 920a. Where the first connecting portion(s) 920a is omitted, the steps relating to the first connecting portion(s) 920a are omitted.

Where the second shield 900 is provided with the pair of second connecting portions 920b, when bringing the second shield 900 relatively closer to the first housing 700 in the Y-Y′ direction, the second connecting portion 920b on the X-direction side is brought into elastic contact with the second wall 320b on the X-direction side (if provided) of the second shell 300b from the X-direction side, or alternatively is housed in the second housing groove on the X-direction side of the second shell body 310b to elastically contact the second shell body 310b of the second shell 300b from the X-direction side; and the second connecting portion 920b on the X′-direction side is brought into elastic contact with the second wall 320b on the X′-direction side (if provided) of the second shell 300b from the X′-direction side, or alternatively is housed in the second housing groove on the X′-direction side of the second shell body 310b to elastically contact the second shell body 310b of the second shell 300b from the X′-direction side. Thus the second shield 900 and the second shell 300b are electrically connected to each other. Where the pair of second connecting portions 920b is a single second connecting portion 920b, the above steps for either one of the pair of second connecting portions 920b should apply to the single second connecting portion 920b. Where the second connecting portion(s) 920b is omitted, the steps relating to the second connecting portion(s) 920b are omitted.

Where the second shield 900 is provided with the pair of third connecting portions 930, when bringing the second shield 900 relatively closer to the first housing 700 in the Y-Y′ direction, the third connecting portion 930 on the X-direction side is housed in the housing groove 712a of the second portion 712 of the first housing 700 from the Y-direction side to elastically contact the second shield portion 812 of the first shield 800 from the X′-direction side, and the third connecting portion 930 on the X′-direction side is housed in the housing groove 713a of the third portion 713 of the first housing 700 from the Y-direction side to elastically contact the third shield portion 813 of the first shield 800 from the X-direction side. The third connecting portion 930 on the X-direction side may be locked in the housing groove 712a when housed in the housing groove 712a (when completely housed). The third connecting portion 930 on the X′-direction side may be locked in the housing groove 713a when housed in the housing groove 713a (when completely housed).

Where the second shield portion 812 of the first shield body 810 is provided with the protrusion 812a and the third shield portion 813 of the first shield body 810 is provided with the protrusion 813a, from the start of the insertion into the housing groove 712a of the third connecting portion 930 on the X-direction side until the third connecting portion 930 on the X-direction side is completely housed in the housing groove 712a, the distal portion of the third connecting portion 930 on the X-direction side moves in the Y′ direction without contacting the second shield portion 812 of the first shield body 810 or slides on the second shield portion 812 in the Y′ direction. When the third connecting portion 930 on the X direction is completely housed in the housing groove 712a, the distal portion of the third connecting portion 930 on the X-direction side is in elastic contact with the protrusion 812a of the second shield portion 812 from the X′-direction side and may be locked in the housing groove 712a. From the start of the insertion into the housing groove 713a of the third connecting portion 930 on the X′-direction side until the third connecting portion 930 on the X′-direction side is completely housed in the housing groove 713a, the distal portion of the third connecting portion 930 on the X′-direction side moves in the Y′ direction without contacting the third shield portion 813 of the first shield body 810 or slides on the third shield portion 813 in the Y′ direction. When the third connecting portion 930 on the X′-direction side is completely housed in the housing groove 713a, the distal portion of the third connecting portion 930 on the X′-direction side is in elastic contact with the protrusion 813a of the third shield portion 813 from the X-direction side and may be locked in the housing groove 713a.

Thus the second shield 900 is electrically connected to the first shield 800 in a manner described above. Note that where the bent portion of the third connecting portion 930 on the X-direction side is provided with the window 940 and the bent portion of the third connecting portion 930 on the X′-direction side is provided with the window 940, the end faces of the windows 940 on the Y′-direction side may be pressed by the jigs from the Y-direction side, and thereby the third connecting portion 930 on the X-direction side may be inserted into the housing groove 712a from the Y-direction side and the third connecting portion 930 on the X′-direction side may be inserted into the housing groove 713a from the Y-direction side.

Note that where the pair of third connecting portions 930 is a single third connecting portion 930, the above steps for either one of the pair of third connecting portions 930 should apply to the single third connecting portion 930. Where the third connecting portion(s) 930 is omitted, the steps relating to the third connecting portion(s) 930 are omitted.

Where the second shield 900 is omitted, the steps relating to the second shield 900 are omitted.

The non-limiting connector FC is manufactured as described above.

The floating connector FC described above provides the following technical features and effects (1) to (8).

Technical features and effects (1): The novel connector FC described above is obtained. Since the connector FC includes the first connector part FC1 and the second connector part FC2, each of the connector parts is connectable to a mating connector. In other words, the connector FC is connectable to two mating connectors.

Technical features and effects (2): When the elastically deformable portions 230 of the plurality of terminals 200 of the connector FC elastically deform in the direction including the component of the at least one direction, the elastic deformation of the elastically deformable portions 230 causes the second connector part FC2 to be displaced relative to the first connector part FC1 in the direction including the component of the at least one direction. As such, even if a second mating connector to be connected to the second connector part FC2 is at a position offset, in the direction including the component of the at least one direction, from the predetermined position with respect to a first mating connector to be connected to the first connector part FC1, the second connector part is displaced relative to the first connector part in the direction including the component of the at least one direction, allowing the second connector part FC2 to be connected to the second mating connector.

Technical features and effects (3): Where each terminal 200 has configuration (1) or (2) described above, since the first and second faces of each terminal are rolled faces, each terminal 200 has a relatively smaller dimension in the X-X′ direction (thickness dimension). This results in a reduced pitch distance in the X-X′ direction between the plurality of terminals 20, so that the connector FC has a reduced dimension in the X-X′ direction.

Also, the connector FC is suitable for a high-speed differential connector with a plurality of lanes. In a high-speed differential connector in general, each lane includes four terminals arranged in the order of GSSG (wherein the terminals G are ground terminals, and the terminals S are signal terminals forming a differential pair). With increasing number of the lanes, even if a terminal G is shared by each two adjacent ones of the plurality of lanes, every increase of the lanes means an increase of the terminals by three. However, since the connector FC includes the plurality of terminals 200 of a relatively small pitch distance in the X-X′ direction, the connector FC can be used as a high-speed differential connector with a plurality of lanes and a reduced dimension in the X-X′ direction. On the other hand, if a plurality of high-speed differential connectors each having one lane are arranged side by side along the X-X′ direction, the plurality of connectors occupy a large space in the X-X′ direction. In particular, where the plurality of high-speed differential connectors are configured to float in a direction including a component of the X-X′ direction, each two adjacent ones of the connectors require a space therebetween for the two connectors to float, resulting in further increase of the spaces in the X-X′ direction occupied by the plurality of high-speed differential connectors. In contrast, the connector FC can be configured such that the plurality of terminals 200 are arranged at intervals in the X-X′ direction such as to correspond to a plurality of lanes of the same number as the total number of the lanes of the plurality of high-speed differential connectors, so that the space in the X-X′ direction occupied by the connector FC (the dimension in the X-X′ direction of the connector FC) is smaller than the space in the X-X′ direction occupied by the plurality of high-speed differential connectors.

Technical features and effects (4): Where the elastically deformable portions 230 of the plurality of terminals 200 are generally laterally oriented U shaped, generally laterally oriented arc shaped, or generally laterally oriented V shaped as described above, the elastically deformable portions 230 are elastically deformable easily in a direction including the component of the above-described three directions. Moreover, where the elastically deformable portions 230 of the plurality of terminals 200 elastically deform in the direction including the components of the above-described three directions, it is easy to set the amount of the elastic deformation (the limit value of displacement amount) in the direction including the components of the above-described three directions of the elastically deformable portions 230 of the plurality of terminals 200, by adjusting the dimension in the Z-Z′ direction and/or the dimension in the Y-Y′ direction of the elastically deformable portions 230 of the plurality of terminals 200.

Technical features and effects (5): Where the dimension in the Y-Y′ direction of the top portion 233 of the elastically deformable portion 230 of each terminal 200 is smaller than the dimension in the Z-Z′ direction of each of the first end portion 231 and the second end portion 232 of the elastically deformable portion 230 of each terminal 200, the top portion 233 of the elastically deformable portion 230 is easily deformable in the Z-Z′ direction. In some cases, the top portion 233 of the elastically deformable portion 230 has an impedance that is larger than the impedance of each of the first end portion 231 and the second end portion 232 of the elastically deformable portion 230 in each terminal 200. However, where the plurality of partitions 740 of the first housing 700 are provided, the plurality of partitions 740 are constituted by an insulating resin or the like, which has a dielectric constant higher than that of air, and the top portion 233 of the elastically deformable portion 230 of each terminal 200 is disposed between the two adjacent partitions 740 of each set of the partitions 740. Therefore, by adjusting the distance in the X-X′ direction from the top portion 233 of the elastically deformable portion 230 of each terminal 200 to each of the two adjacent partitions 740 of the corresponding set, the impedance of the top portion 233 of the elastically deformable portion 230 of each terminal 200 can be reduced, closer to the impedance of each of the first end portion 231 and the second end portion 232 of the elastically deformable portion 230 of each terminal 200.

Technical features and effects (6): Where the plurality of partitions 740 of the first housing 700 are provided, the top portion 233 of the elastically deformable portion 230 of each terminal 200 is disposed between the two adjacent partitions 740 of each set of the partitions 740. This arrangement prevents contact between the elastically deformable portions 230 when elastically deforming in the direction including the components of the above-described three directions.

Technical features and effects (7): Where the first housing 700 is provided, the retaining portion 720 of the first housing 700 retains the first connector part FC1, and the at least one guide 730 of the first housing 700 guides the second connector part FC2 displaceably in the direction including the component of the at least one direction. This configuration stabilizes the displacement (floating) of the second connector part FC2.

Technical features and effects (8): Where the first body 100a and the second body 100b are identical in shape, they can be manufactured in a common mold. On the other hand, where the first body 100a and the second body 100b are different in shape and/or where the first retainable portions 220a of the plurality of terminals 200 are different in shape from the second retainable portions 220b of the plurality of terminals 200, there is a risk of misassembling the first retainable portions 220a of the plurality of terminals 200 into the second body 100b and misassembling the second retainable portions 220b of the plurality of terminals 200 into the first body 100a. However, this risk of misassembly is avoided where the first body 100a and the second body 100b are identical in shape. This is because a body manufactured in a common mold may be used as either the first body 100a or the second body 100b. Moreover, a common step can be taken as the step of assembling the first retainable portions 220a of the plurality of terminals 200 into the first body 100a and as the step of assembling the second retainable portions 220b of the plurality of terminals 200 into the second body 100b, using a common jig or other tools.

Furthermore, where the first shell 300a and the second shell 300b are identical in shape, they can be manufactured in a common mold. On the other hand, where the first body 100a and the second body 100b are different in shape and/or where the first shell 300a and the second shell 300b are different in shape, there is a risk of misassembling the second body 100b into the first shell body 310a of the first shell 300a and misassembling the first body 100a into the second shell body 310b of the second shell 300b. However, this risk of misassembly is avoided where the first body 100a and the second body 100b are identical in shape and the first shell 300a and the second shell 300b are identical in shape. This is because a body manufactured in a common mold may be used as either the first body 100a or the second body 100b and a shell manufactured in a common mold may be used as either the first shell 300a or the second shell 300b. Moreover, a common step can be taken as the step of assembling the first body 100a into the first shell body 310a of the first shell 300a and as the step of assembling the second body 100b into the second shell body 310b of the second shell, using a common jig or other tools.

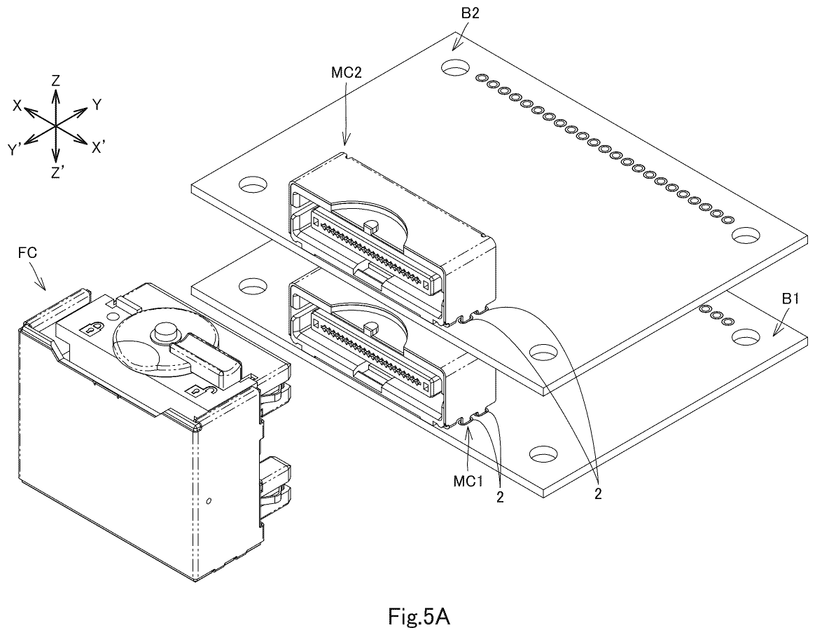

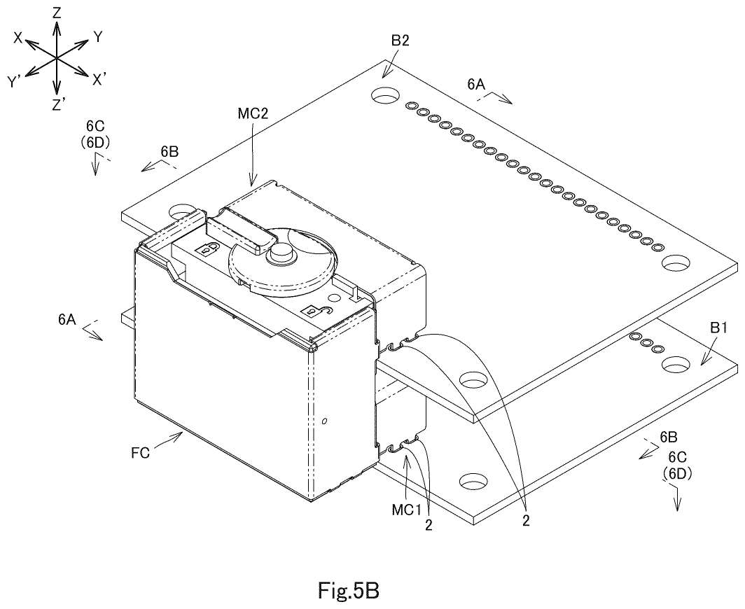

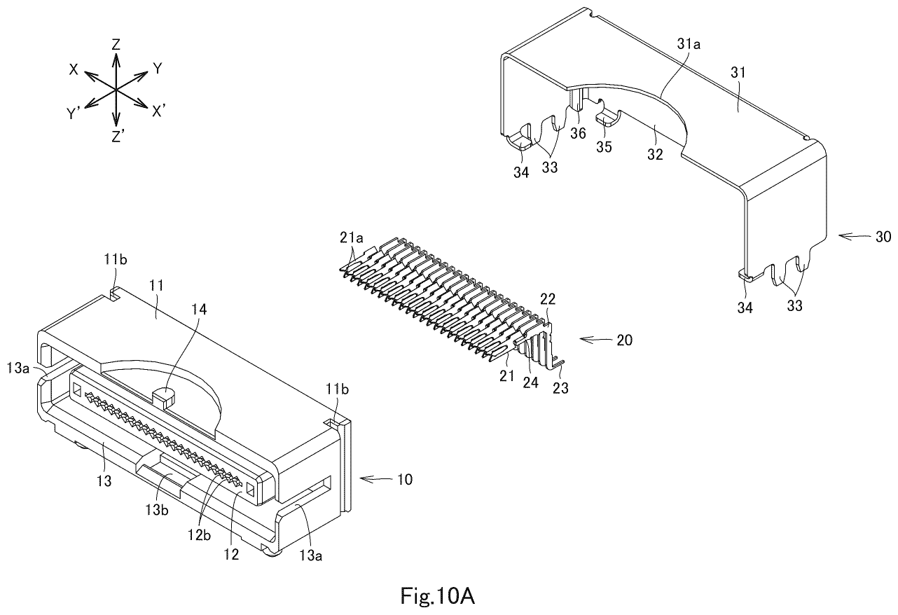

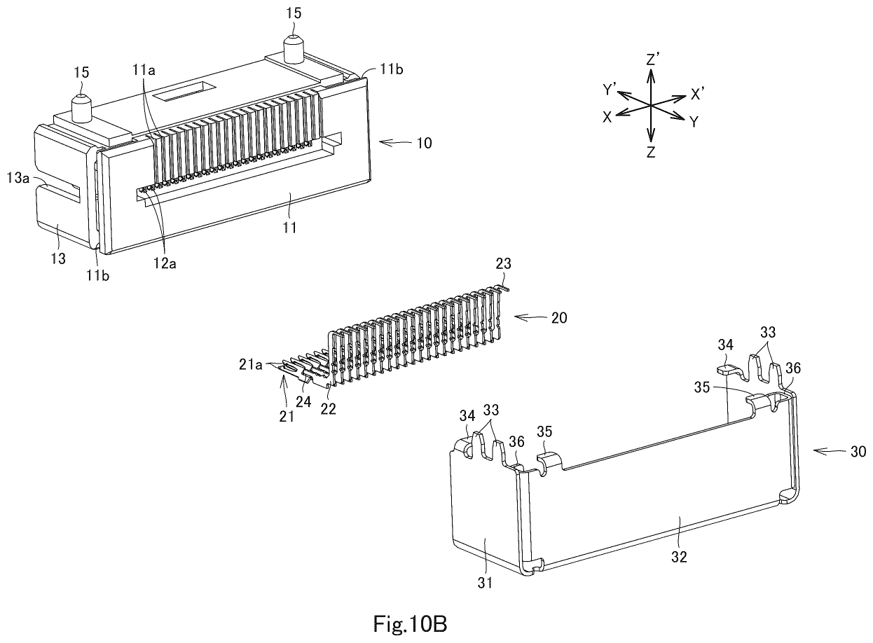

A connection structure (combination) of connectors according to a plurality of embodiments, including a first embodiment of the invention and variants thereof, will be now described with reference to FIGS. 1A to 11B. FIGS. 5A to 7B illustrate the connector connection structure of the first embodiment.

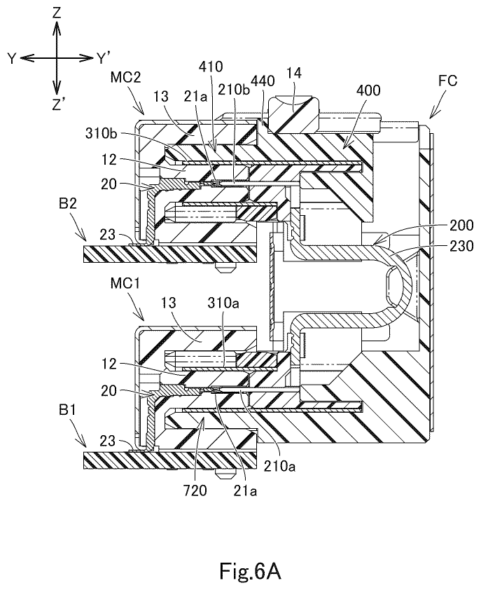

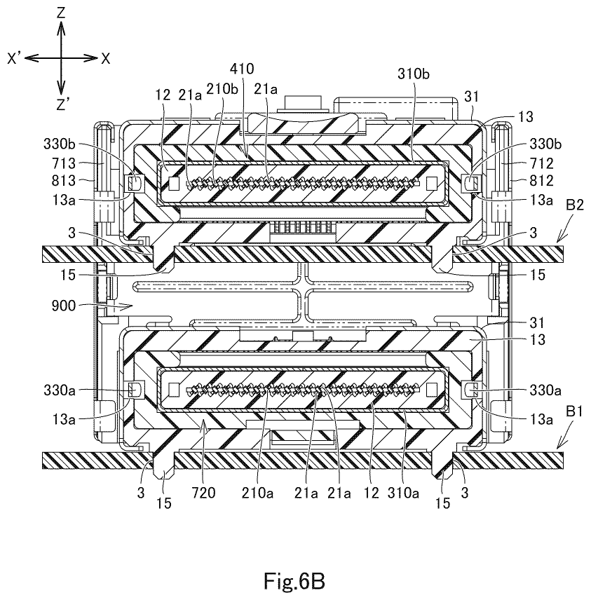

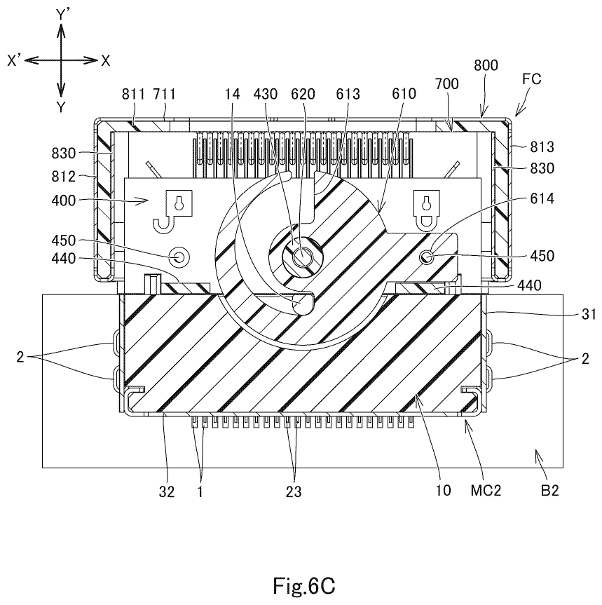

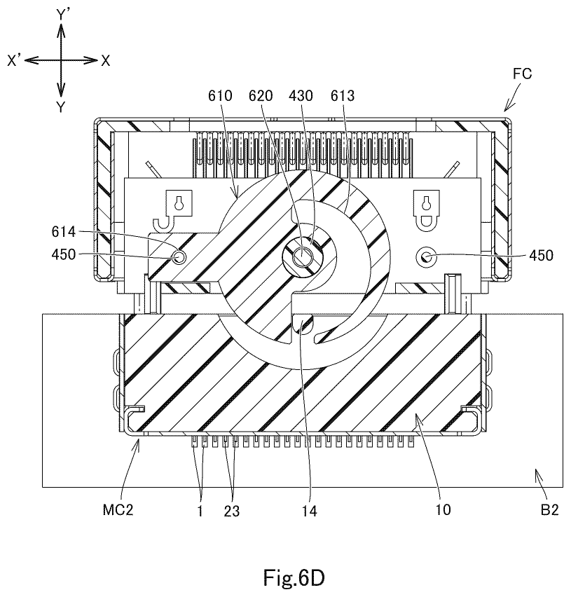

The connection structure includes the connector FC described above, a first circuit board B1, a second circuit board B2, a first mating connector MC1, and a second mating connector MC2. FIGS. 5A to 11B illustrate the first mating connector MC1 and the second mating connector MC2 of the connection structure of the first embodiment. FIGS. 5A to 6D illustrate the first circuit board B1 and the second circuit board B2 of the connection structure of the first embodiment.

FIGS. 5A to 6B, 7A to 9A, and 9D to 11B show the Z-Z′ direction. FIGS. 5A to 5B, 6B to 6D, 7A to 8D, and 9B to 11B show the X-X′ direction. FIGS. 5A to 6A, 6C, 6D, 7A to 8D, 9A to 9C, and 10A to 11B show the Y-Y′ direction.

The first circuit board B1 includes a plurality of first electrodes 1. The plurality of first electrodes 1 are surface electrodes provided at intervals in the X-X′ direction on a surface on the Z-direction side of the first circuit board B1, or alternatively through-hole electrodes provided at intervals in the X-X′ direction in the first circuit board B1. The first circuit board B1 may further include a plurality of first ground electrodes 2 and/or a plurality of first engaging holes 3. The plurality of first ground electrodes 2 are surface electrodes provided on the surface on the Z-direction side of the first circuit board B1 and connectable to ground, or alternatively through-hole electrodes provided in the first circuit board B1 and connectable to ground. The plurality of first engaging holes 3 extend through the first circuit board B1 in the Z-Z′ direction. The plurality of first ground electrodes 2 and/or the plurality of first engaging holes 3 can be omitted.

The first mating connector MC1 is mounted on the first circuit board B1 from the Z-direction side and connectable to the first connector part FC1 of the floating connector FC from the Y-direction side. When used herein, the term “first connection state” means a state where the first mating connector MC1 is connected to the first connector part FC1 of the connector FC described above in the Y-Y′ direction.

The first mating connector MC1 includes a first body 10. The first body 10 is constituted by an insulating material (e.g., an insulating resin or the like). The first body 10 is only required to have a shape that is connectable to the first connector part FC1 of the connector FC described above in the Y-Y′ direction.

The first body 10 may include a base 11 and a protrusion 12. The base 11 is generally a wall extending in the Z-Z′ and X-X′ directions, for example. A plurality of retaining grooves 11a are provided in a wall surface on the Y-direction side of the base 11 and at intervals in the X-X′ direction. In addition, locking grooves 11b may be provided respectively at an end portion on the X-direction side and an end portion on the X′-direction side of the base 11.

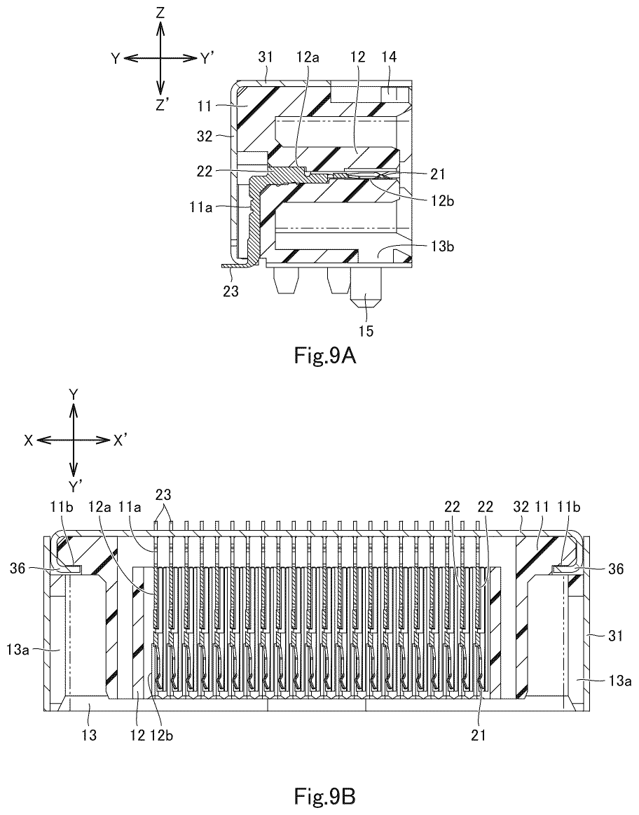

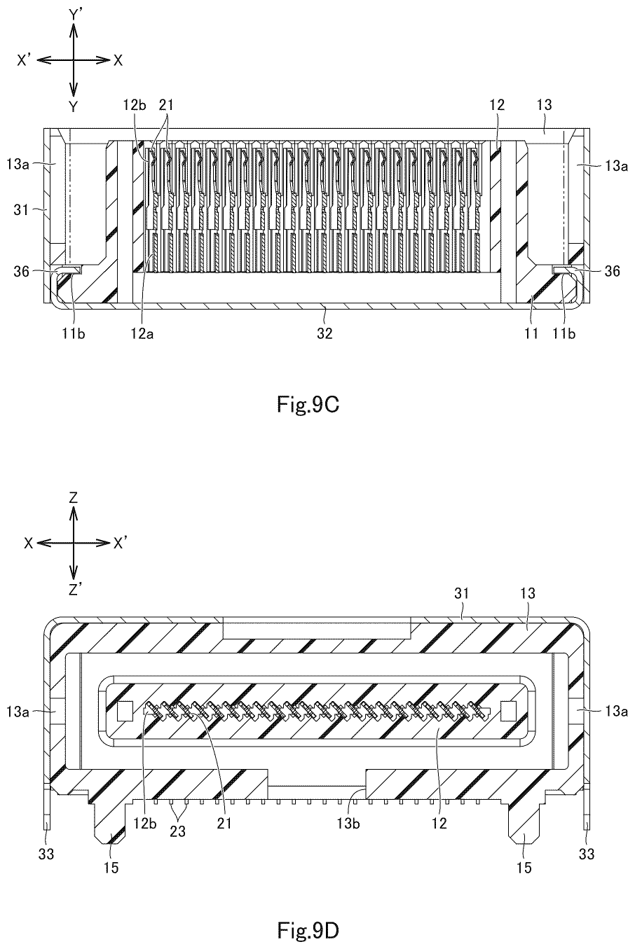

The protrusion 12 is constituted by a polygonal prism (e.g., a quadrangular prism (see FIGS. 9A to 9D), a hexagonal prism (not illustrated), or the like) or a cylinder (not illustrated). The protrusion 12 extends in the Y′ direction from a central portion of the base 11. In the first connection state, the protrusion 12 is fitted in the first connection space of the first shell body 310a of the first connector part FC1 of the connector FC and butted against the first body main portion 110a of the first body 100a of the first connector part FC1. The protrusion 12 has an outer shape and an outer size in cross section along the Z-Z′ and X-X′ directions that correspond to an inner shape and an inner size along the Z-Z′ and X-X′ directions of the first shell body 310a.

The protrusion 12 is provided with a plurality of retaining holes 12a and a plurality of connection holes 12b. The plurality of retaining holes 12a are arranged in the X-X′ direction at the same intervals as the plurality of retaining grooves 11a. The plurality of retaining holes 12a open out in the Y direction. The plurality of connection holes 12b are arranged in the X-X′ direction at the same intervals as the plurality of retaining holes 12a, are located on the Y′-direction side relative to, and communicated with, the plurality of retaining holes 12a. The plurality of connection holes 12b open out in the Y′ direction.

The plurality of connection holes 12b can be omitted. In this case, the plurality of retaining holes 12a extend through the protrusion 12 in the Y-Y′ directions and open out only in the Y direction but also in the Y′ direction.

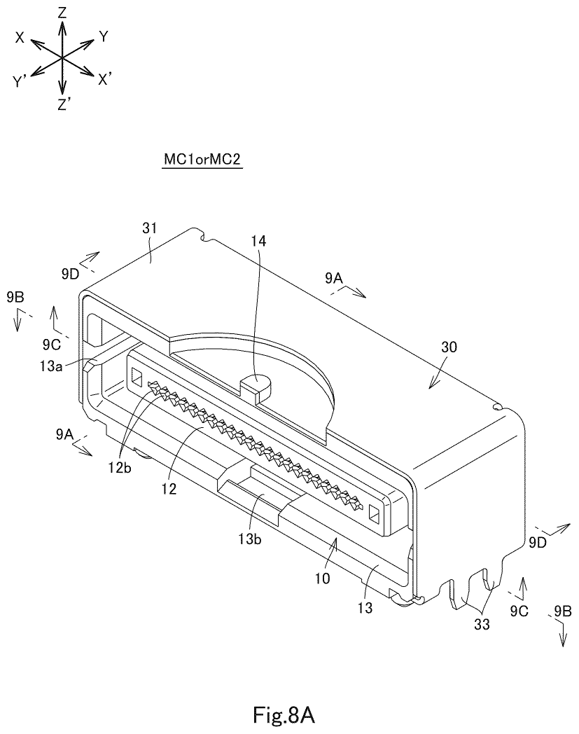

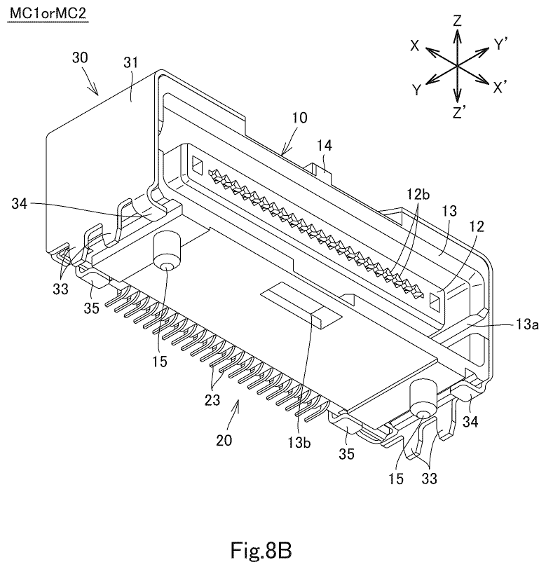

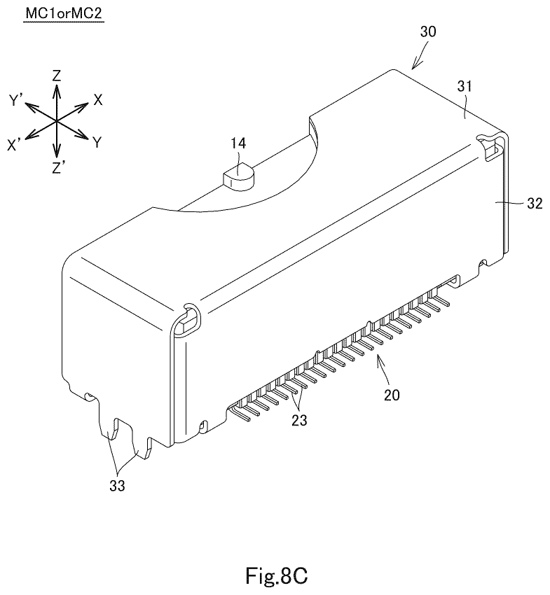

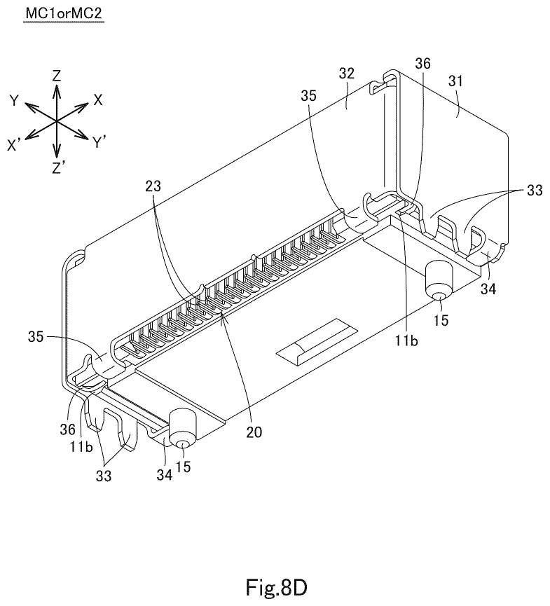

The first body 10 may further have a tubular portion 13. The tubular portion 13 has a generally ring shape (e.g., a polygonal ring shape, such as a generally quadrangular ring shape (see FIG. 8A to FIG. 10B) or a generally circular ring shape (not illustrated)) in sectional view along the along the Z-Z′ and X-X′ directions. The tubular portion 13 extends from the base 11 in the Y direction and surrounds the protrusion 12. The tubular portion 13 and the protrusion 12 define a first insertion space having a generally ring shape (e.g., a polygonal ring shape, such as a generally quadrangular ring shape (see FIG. 8A to FIG. 10B) or a generally circular ring shape (not illustrated)). Where the connector FC is provided with the first housing 700, in the first connection state, the distal portion of the retaining portion 720 of the first housing 700 of the connector FC is fitted in the first insertion space in the Y-Y′ direction. Where the connector FC is not provided with the first housing 700, in the first connection state, the distal portion of the first shell body 310a of the first shell 300a of the connector FC is fitted in the first insertion space in the Y-Y′ direction. The tubular portion 13 includes a first side wall on the X-direction side, a second side wall on the X′-direction side of the tubular portion 13, a top plate on the Z-direction side, and a bottom plate on the Z′-direction side.

The first side wall and the second side wall of the tubular portion 13 may be provided with a first slit 13a and a second slit 13a, respectively. The first slit 13a extends through the first side wall of the tubular portion 13 in the X-X′ direction and extends in the Y-Y′ direction. The second slit 13a extends through the second side wall of the tubular portion 13 in the X-X′ direction and extends in the Y-Y′ direction. In the first connection state, the first connecting portion 330a on the X-direction side and the first connecting portion 330a on the X′-direction side of the first shell 300a of the first connector part FC1 of the connector FC are received in the first slit 13a and the second slit 13a, respectively. Note that where the first connecting portion 330a on the X-direction side and the first connecting portion 330a on the X′-direction side are omitted, the first slit 13a and the second slit 13a can also be omitted.

The top plate of the tubular portion 13 may be provided with an abutment 14 protruding in the Z direction. The abutment 14 can be omitted.

The bottom plate of the tubular portion 13 may be provided with a plurality of engaging protrusions 15 protruding in the Z′ direction. The plurality of engaging protrusions 15 are fitted in the respective first engaging holes 3 of the first circuit board B1. The bottom plate of the tubular portion 13 may be further provided with a locking recess 13b. In the first connection state, the locking arm 750 of the first housing 700 is locked in the locking recess 13b. The engaging protrusion 15 and/or the locking recess 13b can be omitted.

The first mating connector MC1 further includes a plurality of first terminals 20. Each of the first terminals 20 may be manufactured by the above-described rolling method, for example. In this case, a first face on the X-direction side and a second face on the X′-direction side of each terminal 200 are flat rolled faces. Each terminal 200 may be manufactured not by the rolling method but by other known method for manufacturing terminals, such as a photolithography method or an inkjet method.

The plurality of first terminals 20 includes respective first contacting portions 21, respective first retainable portions 22, and respective first lead portions 23. The plurality of first terminals 20 may further include respective first linking portions 24.

The first retainable portions 22 of the plurality of first terminals 20 are generally L-shaped plates and securely received in the respective retaining grooves 11a of the base 11 of the first body 10 and the respective retaining holes 12a of the protrusion 12 from the Y-direction side. Thus the first retainable portions 22 of the plurality of first terminals 20 are retained in the first body 10 at intervals in the X-X′ direction.

The first contacting portions 21 of the plurality of first terminals 20 may extend in the Y′ direction from the corresponding first linking portions 24. The first contacting portions 21 may each be constituted by a plate (not illustrated), a rod (not illustrated), or a tube (not illustrated), or may have a bifurcated shape including first and second contacting arms 21a (see FIGS. 6A and 6B, 7A and 7B, and 9A to 11B). The first contacting portions 21 of the plurality of first terminals 20 protrude, or are exposed, at least partly from the first body 10 such as to be visible from the Y′-direction side.

Where the first body 10 includes the plurality of connection holes 12b, the first contacting portions 21 of the plurality of first terminals 20 are disposed in the respective connection holes 12b from the Y-direction side and are exposed at least partly in the Y′ direction from the respective connection holes 12b. In the first connection state, the first contacting portions 210a of the plurality of terminals 200 of the first connector part FC1 of the connector FC, which protrude at least partly from the first body 100a, are received in the respective connection holes 12b of the first body 10 from the Y′-direction side and are in contact with the respective first contacting portions 21 of the plurality of first terminals 20.

Where the first body 10 does not include the plurality of connection holes 12b, the first contacting portions 21 of the plurality of first terminals 20 protrude at least partly in the Y′ direction from the respective retaining holes 12a. In the first connection state, the first contacting portions 210a of the plurality of terminals 200 of the first connector part FC1 of the connector FC, which protrude at least partly from the first body 100a, are in contact with the respective first contacting portions 21 of the plurality of first terminals 20. Alternatively, in the first connection state, the first contacting portions 21 of the plurality of first terminals 20 are received in the respective connection holes of the second body 100b of the first connector part FC1 of the connector FC and are in contact with the respective first contacting portions 210a of the plurality of terminals 200 of the first connector part FC1.

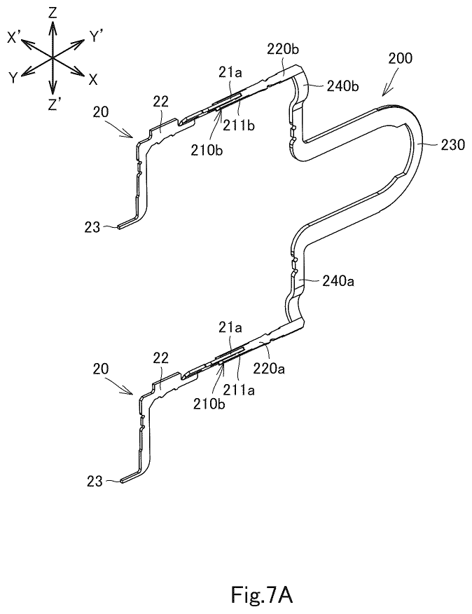

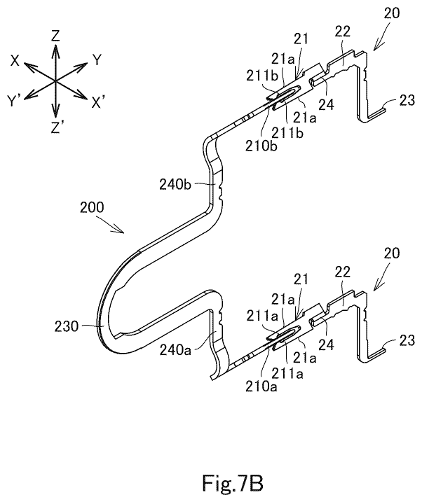

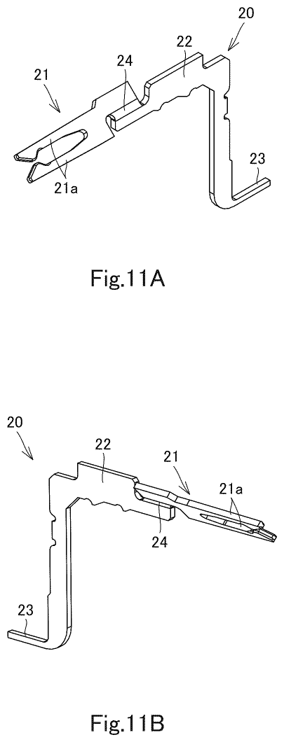

The first linking portions 24 of the plurality of first terminals 20 are only required to link the first retainable portions 22 and the first contacting portions 21.

Where the first contacting portion 210a of each terminal 200 of the first connector part FC1 of the connector FC is constituted by a plate or rod inclined in the first oblique direction (see FIGS. 7A, 7B, 11A and 11B), the first linking portion 24 of each first terminal 20 may be bent or curved such that the first contacting arm 21a and the second contacting arm 21a of the first contacting portion 21 of each first terminal 20 are elastically contactable respectively with the first face 211a and the second face 212a of the corresponding first contacting portion 210a respectively from one side and the other side of a third oblique direction (at substantially right angle respectively to the first face 211a and the second face 212a), where the third oblique direction is substantially orthogonal to the first oblique direction. Alternatively, the first linking portion 24 of each first terminal 20 may be bent or curved such that the first contacting portion 21 of a plate or rod shape of each first terminal 20 is contactable with the first face 211a or the second face 212a of the corresponding first contacting portion 210a from the one side or the other side of the third oblique direction.

Where the first contacting portion 210a of each terminal 200 of the first connector part FC1 of the connector FC includes the first and second contacting arms inclined in the first oblique direction (not illustrated), the first linking portion 24 of each first terminal 20 may be bent or curved such that the first and second faces of the first contacting portion 21 of each first terminal 20 is inclined in the third oblique direction, and the first and the second contacting arms of the corresponding first contacting portion 210a are elastically contactable respectively with the first and second faces of the first contacting portion 21 respectively from one side and the other side of the first oblique direction (at substantially right angle respectively to the first and second faces of the first contacting portion 21).

The first linking portions 24 of the plurality of first terminals 20 may not be bent or curved but extend straight from the corresponding first retainable portions 22 to the corresponding first contacting portions 21 (not illustrated).

The first linking portions 24 of the plurality of first terminals 20 can be omitted. In this case, the first contacting portions 21 of the plurality of first terminals 20 may extend from the corresponding first retainable portions 22 in the Y′ direction.

The first lead portions 23 of the plurality of first terminals 20 may extend in the Y direction from the corresponding first retainable portions 22, be disposed on the Y-direction side relative to the first body 10, and be connected to the respective first electrodes 1 being surface electrodes of the first circuit board B1. Alternatively, the first lead portions 23 of the plurality of first terminals 20 may extend in the Z′ direction from the corresponding first retainable portions 22, be disposed on the Z-direction side relative to the first body 10, and be connected to the respective first electrodes 1 being through-hole electrodes of the first circuit board B1.

The first mating connector MC1 may further include a first shell 30 having electrical conductivity. The first shell 30 may be constituted by an electrically conductive material (e.g., a metal plate or the like), or may include an insulating material (e.g., an insulating resin or the like) and metal vapor-deposited on an inner or outer surface of the insulating material. The first shell 30 includes a first shell body 31. The first shell body 31 has a generally U shape (not illustrated) or a generally ring shape (a polygonal ring shape, such as a generally quadrangular ring shape, or a generally circular ring shape (not illustrated)) in sectional view along the Z-Z′ and X-X′ directions. The first shell body 31 extends in the Y-Y′ direction. The first shell body 31 has an inner shape and an inner size in cross section along the Z-Z′ and X-X′ directions that correspond to an outer shape and an outer size of the first body 10 in cross section along the Z-Z′ and X-X′ directions. The first body 10 is at least partly housed in the first shell body 31 from the Y-direction side. The first shell body 31 includes a top plate on the Z-direction side, a first side plate on the X-direction side, and a second side plate on the X′-direction side.

Where the tubular portion 13 is provided with the first slit 13a and the second slit 13a, the first side plate and the second side plate of the first shell body 31 are exposed respectively from the first slit 13a and the second slit 13a to the inside of the first shell body 31. In the first connection state, the first connecting portion 330a on the X-direction side and the first connecting portion 330a on the X′-direction side of the first shell 300a of the first connector part FC1 of the connector FC are received respectively in the first slit 13a and the second slit 13a and are in elastic contact respectively with the first side plate and the second side plate of the first shell body 31. Thus the first shell 30 is electrically connected to the first shell 300a of the first connector part FC1 of the connector FC in the first connection state. Where the tubular portion 13 is omitted, in the first connection state, the distal portion of the first shell body 310a of the first shell 300a of the connector FC is fitted in the first insertion space and in contact with the first shell body 31. Also in this manner, the first shell 30 is electrically connected to the first shell 300a of the first connector part FC1 of the connector FC in the first connection state.

Where the first body 10 is provided with the abutment 14, the top plate of the first shell body 31 is provided with a cutout 31a or an opening for exposing the abutment 14 to the Z-direction side.

The first shell 30 may further include a first cover 32. The first cover 32 is a plate contiguous with the end on the Y-direction side of the top plate of the first shell body 31, and covers the first body 10 from the Y-direction side. The first cover 32 can be omitted.

The first shell 30 may further include a plurality of first legs 33 on the X-direction side and a plurality of second legs 33 on the X′-direction side. Each of the first legs 33 extends in the Z′ direction from an end on the Z′-direction side of the first side plate of the first shell body 31 and is connected to a corresponding one of the first ground electrodes 2 being a through-hole electrode of the first circuit board B1, or alternatively extends in the X direction from the end on the Z′-direction side of the first side plate of the first shell body 31 and is connected to a corresponding one of the first ground electrodes 2 being a surface electrode of the first circuit board B1. Each of the second legs 33 extends in the Z′ direction from an end on the Z′-direction side of the second side plate of the first shell body 31 and is connected to a corresponding one of the first ground electrodes 2 being a through-hole electrode of the first circuit board B1, or alternatively extends in the X′ direction from the end on the Z′-direction side of the second side plate of the first shell body 31 and is connected to a corresponding one of the first ground electrodes 2 being a surface electrode of the first circuit board B1. Note that the plurality of first legs 33 and the plurality of second legs 33 can be omitted.

The first shell 30 may further include a plurality of locking pieces. The plurality of locking pieces are a plurality of first locking pieces 34, a plurality of second locking pieces 35, and/or a plurality of third locking pieces 36. Each of the first locking pieces 34 is a bent piece provided at the end on the Z′-direction side of the first side plate or the end on the Z′-direction side of the second side plate of the first shell body 31, and abuts the first body 10 from the Z′-direction side. Each of the second locking pieces 35 is a bent piece provided at an end on the Z′-direction side of the first cover 32, and abuts the first body 10 from the Z′-direction side. Each of the third locking pieces 36 is a bent piece of a generally L shape at an end on the X-direction side or an end on the X′-direction side of the first cover 32, and is received in a corresponding one of the locking grooves 11b of the first body 10 from the Z′-direction side.

The plurality of locking pieces of the first shell 30 can be omitted. Where the plurality of third locking pieces 36 are omitted, the locking grooves 11b of the first body 10 are also omitted.

The second circuit board B2 is disposed in spaced relation to, and on the Z-direction side relative to, the first circuit board B1. The second circuit board B2 has a similar configuration to the first circuit board B1. The plurality of first electrodes 1 of the second circuit board B2 are surface electrodes provided at intervals in the X-X′ direction on a surface on the Z-direction side of the second circuit board B2, or alternatively through-hole electrodes provided at intervals in the X-X′ direction in the second circuit board B2. The plurality of second ground electrodes 2 of the second circuit board B2 are surface electrodes provided on the surface on the Z-direction side of the second circuit board B2 and connectable to ground, or alternatively through-hole electrodes provided in the second circuit board B2 and connectable to ground. The plurality of second engaging holes 3 of the second circuit board B2 extend through the second circuit board B2 in the Z-Z′ direction. The plurality of second ground electrodes 2 and/or the plurality of second engaging holes 3 can be omitted.

The second mating connector MC2 may have a similar configuration to the first mating connector MC1 but may be different in that the second mating connector MC2 is mounted on the second circuit board B2 from the Z-direction side and connectable to the second connector part FC2 of the floating connector FC from the Y-direction side. When used herein, the term “second connection state” means a state where the second mating connector MC2 is connected to the second connector part FC2 of the connector FC described above in the Y-Y′ direction. The second mating connector MC2 differs from the first mating connector MC1 in the following respects.

The second body 10 of the second mating connector MC2 may be identical in shape to the first body 10 of the first mating connector MC1 (see FIGS. 5A to 6D and 8A to 10B). Alternatively, the second body 10 of the second mating connector MC2 may be similar in configuration to, but different in shape from, the first body 10 of the first mating connector MC1 described above (not illustrated). Accordingly, the second body 10 and its sub-elements will be referred to using the same reference numerals for the first body 10 and its sub-elements.

For example, the second body 10 may include the base 11 described above and the protrusion 12 described above. As described above, the base 11 is provided with the plurality of retaining grooves 11a. The protrusion 12 may be provided with the plurality of retaining holes 12a and the plurality of connection holes 12b, or alternatively provided with the plurality of retaining holes 12a but not with the plurality of connection holes 12b as described above. In the second connection state, the protrusion 12 of the second body 10 is fitted in the second connection space of the second shell body 310b of the second connector part FC2 of the connector FC and butted against the second body main portion 110b of the second body 100b of the second connector part FC2.

The second body 10 may further include the tubular portion 13 described above. The tubular portion 13 and the protrusion 12 define a second insertion space having a generally ring shape (e.g., a polygonal ring shape, such as a generally quadrangular ring shape (see FIG. 8A to FIG. 10B) or a generally circular ring shape (not illustrated)). Where the second connector part FC2 is provided with the second housing 400, in the second connection state, the distal portion of the second housing body 410 of the second housing 400 of the second connector part FC2 is fitted in the second insertion space in the Y-Y′ direction. Where the second connector part FC2 is not provided with the second housing 400, in the second connection state, the distal portion of the second shell body 310b of the second shell 300b of the second connector part FC2 is fitted in the second insertion space in the Y-Y′ direction.

The top plate of the tubular portion 13 may be provided with the abutment 14 protruding in the Z direction. The abutment 14 can be omitted.

The bottom plate of the tubular portion 13 may be provided with the plurality of engaging protrusions 15 protruding in the Z′ direction. The plurality of engaging protrusions 15 are fitted in the respective second engaging holes 3 of the second circuit board B2. The bottom plate of the tubular portion 13 may be further provided with the locking recess 13b. The engaging protrusion 15 and/or the locking recess 13b can be omitted.

Each of the plurality of second terminals 20 of the second mating connector MC2 may be identical in shape to each of the first terminals 20 of the first mating connector MC1 (see FIGS. 7A, 7B, 11A and 11B) Alternatively, each of the plurality of second terminals 20 may be similar in configuration to, but different in shape from, each of the first terminals 20 described above of the first mating connector MC1 (not illustrated). Accordingly, the second terminals 20 and their sub-elements will be referred to using the same reference numerals for the first terminals 20 and their sub-elements.

The second retainable portions 22 of the plurality of second terminals 20 are generally L-shaped plates, and securely received in the respective retaining grooves 11a of the base 11 of the second body 10 and the respective retaining holes 12a of the protrusion 12 from the Y-direction side. Thus the second retainable portions 22 of the plurality of second terminals 20 are retained in the second body 10 at intervals in the X-X′ direction.

The second contacting portions 21 of the plurality of second terminals 20 may extend in the Y′ direction from the corresponding second linking portions 24. The second contacting portions 21 of the plurality of second terminals 20 may each be constituted by a plate (not illustrated), a rod (not illustrated), or a tube (not illustrated), may have a bifurcated shape including the first and second contacting arms 21a (see FIGS. 6A, 6B, 7A, 7B, and 9A to 11B). The second contacting portions 21 of the plurality of second terminals 20 protrude, or are exposed, at least partly from the second body 10 such as to be visible from the Y′-direction side.

Where the second body 10 includes the plurality of connection holes 12b, the second contacting portions 21 of the plurality of second terminals 20 are disposed in the respective connection holes 12b from the Y-direction side and are exposed at least partly in the Y′ direction from the respective connection holes 12b. In the second connection state, the second contacting portions 210b of the plurality of terminals 200 of the second connector part FC2 of the connector FC, which protrude at least partly from the second body 100b, are received in the respective connection holes 12b of the second body 10 from the Y′-direction side and are in contact with the respective second contacting portions 21 of the plurality of second terminals 20.

Where the second body 10 does not include the plurality of connection holes 12b, the second contacting portions 21 of the plurality of second terminals 20 protrude at least partly in the Y′ direction from the respective retaining holes 12a. In the second connection state, the second contacting portions 210b of the plurality of terminals 200 of the second connector part FC2 of the connector FC, which protrude at least partly from the second body 100b, are in contact with the respective second contacting portions 21 of the plurality of second terminals 20. Alternatively, in the second connection state, the second contacting portions 21 of the plurality of second terminals 20 are received in the respective connection holes of the second body 100b of the second connector part FC2 of the connector FC and are in contact with the respective second contacting portions 210b of the plurality of terminals 200 of the second connector part FC2.

Where the second contacting portion 210b of each terminal 200 of the second connector part FC2 of the connector FC is constituted by a plate or rod inclined in the second oblique direction (see FIGS. 7A, 7B, 11A and 11B), the second linking portion 24 of each second terminal 20 may be bent or curved such that the first contacting arm 21a and the second contacting arm 21a of the second contacting portion 21 of each second terminal 20 are elastically contactable respectively with the first face 211b and the second face 212b of the corresponding second contacting portion 210b respectively from one side and the other side of a fourth oblique direction (at substantially right angle respectively to the first face 211b and the second face 212b), where the fourth oblique direction is substantially orthogonal to the second oblique direction. Alternatively, the second linking portion 24 of each second terminal 20 may be bent or curved such that the second contacting portion 21 of a plate or rod shape of each second terminal 20 is contactable with the first face 211b or the second face 212b of the corresponding second contacting portion 210b from the one side or the other side of the fourth oblique direction.

Where the second contacting portion 210b of each terminal 200 of the second connector part FC2 of the connector FC includes the first and second contacting arms inclined in the second oblique direction (not illustrated), the second linking portion 24 of each second terminal 20 may be bent or curved such that the first and second faces of the second contacting portion 21 of each second terminal 20 is inclined in the fourth oblique direction, and the first and the second contacting arms of the second contacting portion 210b are elastically contactable respectively with the first and second faces of the corresponding second contacting portion 21 respectively from one side and the other side of the second oblique direction (at substantially right angle respectively to the first and second faces of the second contacting portion 21).

The second linking portions 24 of the plurality of second terminals 20 may not be bent or curved but extend straight from the corresponding second retainable portions 22 to the corresponding second contacting portions 21 (not illustrated).

The second linking portions 24 of the plurality of second terminals 20 can be omitted. In this case, the second contacting portions 21 of the plurality of second terminals 20 may extend from the corresponding second retainable portions 22 in the Y′ direction.

The second lead portions 23 of the plurality of second terminals 20 may extend in the Y direction from the corresponding second retainable portions 22, be disposed on the Y-direction side relative to the second body 10, and be connected to the respective second electrodes 1 being surface electrodes of the second circuit board B2. Alternatively, the second lead portions 23 of the plurality of second terminals 20 may extend in the Z′ direction from the corresponding second retainable portions 22, be disposed on the Z′-direction side relative to the second body 10, and be connected to the respective second electrodes 1 being through-hole electrodes of the second circuit board B2.

The second shell 30 of the second mating connector MC2 may be identical in shape to the first shell 30 of the first mating connector MC1 (see FIGS. 5A to 6D and 8A to 10B) Alternatively, the second shell 30 of the second mating connector MC2 may be similar in configuration to, but different in shape from, the second shell 300b of the first mating connector MC1 described above (not illustrated). Accordingly, the second shell 30 and its sub-elements will be referred to using the same reference numerals for the first shell 30 and its sub-elements.

The second shell body 31 of the second shell 30 has a generally U shape (not illustrated) or a generally ring shape (a polygonal ring shape, such as a generally quadrangular ring shape, or a generally circular ring shape (not illustrated)) in sectional view along the Z-Z′ and X-X′ directions. The second shell body 31 of the second shell 30 extends in the Y-Y′ direction. The second shell body 31 has an inner shape and an inner size in cross section along the Z-Z′ and X-X′ directions that correspond to an outer shape and an outer size of the second body 10 in cross section along the Z-Z′ and X-X′ directions. The second body 10 is at least partly housed in the second shell body 31 from the Y-direction side. The second shell body 31 includes a top plate on the Z-direction side, a first side plate on the X-direction side, and a second side plate on the X′-direction side.

Where the tubular portion 13 of the second body 10 is provided with the first slit 13a and the second slit 13a, the first side plate and the second side plate of the second shell body 31 are exposed respectively from the first slit 13a and the second slit 13a to the inside of the second shell body 31. In the second connection state, the second connecting portion 330b on the X-direction side and the second connecting portion 330b on the X′-direction side of the second shell 300b of the second connector part FC2 of the connector FC are received respectively in the first slit 13a and the second slit 13a and are in elastic contact respectively with the first side plate and the second side plate of the second shell body 31. Thus the second shell 30 is electrically connected to the second shell 300b of the second connector part FC2 of the connector FC in the second connection state. Where the tubular portion 13 of the second body 10 is omitted, in the second connection state, the distal portion of the second shell body 310b of the second shell 300b of the connector FC is fitted in the second insertion space and in contact with the second shell body 31. Also in this manner, the second shell 30 is electrically connected to the second shell 300b of the second connector part FC2 of the connector FC in the second connection state.

Where the second body 10 is provided with the abutment 14, the top plate of the second shell body 31 is provided with the cutout 31a or an opening for exposing the abutment 14 to the Z-direction side.

The second cover 32 of the second shell 30 is a plate contiguous with the end on the Y-direction side of the top plate of the second shell body 31, and covers the second body 10 from the Y-direction side. The second cover 32 can be omitted.

The second shell 30 may further include the plurality of first legs 33 on the X-direction side and the plurality of second legs 33 on the X′-direction side. Each of the first legs 33 extends in the Z′ direction from the end on the Z′-direction side of the first side plate of the second shell body 31 and is connected to a corresponding one of the second ground electrodes 2 being a through-hole electrode of the second circuit board B2, or alternatively extends in the X direction from the end on the Z′-direction side of the first side plate of the second shell body 31 and is connected to a corresponding one of the second ground electrodes 2 being a surface electrode of the second circuit board B2. Each of the second legs 33 extends in the Z′ direction from the end on the Z′-direction side of the second side plate of the second shell body 31 and is connected to a corresponding one of the second ground electrodes 2 being through-hole electrode of the second circuit board B2, or alternatively extends in the X′ direction from the end on the Z′-direction side of the second side plate of the second shell body 31 and is connected to a corresponding one of the second ground electrodes 2 being a surface electrode of the second circuit board B2. Note that the plurality of first legs 33 and the plurality of second legs 33 can be omitted.

The second shell 30 may further include the plurality of locking pieces. The plurality of locking pieces are the plurality of first locking pieces 34, the plurality of second locking pieces 35, and/or the plurality of third locking pieces 36. Each of the first locking pieces 34 is a bent piece provided at the end on the Z′-direction side of the first side plate or the end on the Z′-direction side of the second side plate of the second shell body 31, and abuts the second body 10 from the Z′-direction side. Each of the second locking pieces 35 is a bent piece provided at the end on the Z′-direction side of the first cover 32, and abuts the second body 10 from the Z′-direction side. Each of the third locking pieces 36 is a bent piece of a generally L shape at the end on the X-direction side or the end on the X′-direction side of the first cover 32, and is received in a corresponding one of the locking grooves 11b of the second body 10 from the Z′-direction side.

The plurality of locking pieces of the second shell 30 can be omitted. Where the plurality of third locking pieces 36 are omitted, the locking grooves 11b of the second body 10 are also omitted.

The following describes non-limiting methods for connecting the first mating connector MC1 to the first connector part FC1 of the floating connector FC.

The first mating connector MC1 is connected to the first connector part FC1 from the Y-direction side. When the first mating connector MC1 is connected to the first connector part FC1, the distal portion of the retaining portion 720 of the first housing 700 (if provided) of the first connector part FC1 or the distal portion of the first shell body 310a of the first shell 300a (if the first housing 700 is not provided) is fitted from the Y′-direction side into the first insertion space defined by the tubular portion 13 and the protrusion 12 of the first body 10 of the first mating connector MC1, and the protrusion 12 of the first mating connector MC1 is fitted into the first connection space of the first shell body 310a of the first connector part FC1 and is brought into abutment with the first body main portion 110a of the first body 100a of the first connector part FC1.

Where the first body 10 of the first mating connector MC1 includes the plurality of connection holes 12b, when the first mating connector MC1 is connected to the first connector part FC1, the first contacting portions 210a of the plurality of terminals 200 of the first connector part FC1, which protrude at least partly from the first body 100a, are inserted into the respective connection holes 12b of the first body 10 of the first mating connector MC1 from the Y′-direction side and brought into contact with the respective first contacting portions 21 of the plurality of first terminals 20 of the first mating connector MC1.

Where the first body 10 does not include the plurality of connection holes 12b, when the first mating connector MC1 is connected to the first connector part FC1, the first contacting portions 210a of the plurality of terminals 200 of the first connector part FC1, which protrude at least partly from the first body 100a, are brought into contact with the respective first contacting portions 21 of the plurality of first terminals 20 of the first mating connector MC1, which protrude at least partly from the first body 10. Alternatively, the first contacting portions 21 of the plurality of first terminals 20, which protrude at least partly from the first body 10, are inserted into the respective connection holes of the second body 100b of the first connector part FC1 and brought into contact with the respective first contacting portions 210a of the plurality of terminals 200 of the first connector part FC1.

Where the first contacting portion 210a of each of the terminals 200 of the first connector part FC1 is constituted by a plate or rod inclined in the first oblique direction (see 7A, 7B, 11A and 11B), the first contacting arm 21a and the second contacting arm 21a of the first contacting portion 21 of each first terminal 20 of the first mating connector MC1 are brought into elastic contact respectively with the first face 211a and the second face 212a of the first contacting portion 210a of each of the terminals 200 of the first connector part FC1 at substantially right angles.

Where the tubular portion 13 of the first mating connector MC1 is provided with the first slit 13a and the second slit 13a, when the first mating connector MC1 is connected to the first connector part FC1, the first connecting portion 330a on the X-direction side and the first connecting portion 330a on the X′-direction side of the first shell 300a of the first connector part FC1 are inserted respectively into the first slit 13a and the second slit 13a of the first mating connector MC1 and are brought into elastic contact respectively with the first side plate and the second side plate of the first shell body 31 of the first shell 30 of the first mating connector MC1. Thus the first shell 30 of the first mating connector MC1 is electrically connected to the first shell 300a of the first connector part FC1.

Where the locking arm 750 of the first housing 700 of the connector FC is provided and the tubular portion 13 of the first mating connector MC1 is provided with the locking recess 13b, when the first mating connector MC1 is connected to the first connector part FC1, the locking arm 750 is locked into the locking recess 13b.

The following describes non-limiting methods for connecting the second mating connector MC2 to the second connector part FC2 of the floating connector FC.

The second mating connector MC2 is connected to the second connector part FC2 from the Y-direction side. When the second mating connector MC2 is connected to the second connector part FC2, the distal portion of the second housing body 410 of the second housing 400 (if provided) of the second connector part FC2 or the distal portion of the second shell body 310b of the second shell 300b of the second connector part FC2 (if the second housing 400 is not provided) is fitted from the Y′-direction side into the second insertion space defined by the tubular portion 13 and the protrusion 12 of the second body 10 of the second mating connector MC2, and the protrusion 12 of the second mating connector MC2 is fitted into the second connection space of the second shell body 310b of the second connector part FC2 and is brought into abutment with the second body main portion 110b of the second body 100b of the second connector part FC2.

Where the second body 10 of the second mating connector MC2 includes the plurality of connection holes 12b, when the second mating connector MC2 is connected to the second connector part FC2, the second contacting portions 210b of the plurality of terminals 200 of the second connector part FC2, which protrude at least partly from the second body 100b, are inserted into the respective connection holes 12b of the second body 10 of the second mating connector MC2 from the Y′-direction side and brought into contact with the respective second contacting portions 21 of the plurality of second terminals 20 of the second mating connector MC2.

Where the second body 10 does not include the plurality of connection holes 12b, when the second mating connector MC2 is connected to the second connector part FC2, the second contacting portions 210b of the plurality of terminals 200 of the second connector part FC2, which protrude at least partly from the second body 100b, are brought into contact with the respective second contacting portions 21 protruding at least partly from the second body 10 of the plurality of second terminals 20 of the second mating connector MC2. Alternatively, the second contacting portions 21 protruding at least partly from the second body 10 of the plurality of second terminals 20 are inserted into the respective connection holes of the second body 100b of the second connector part FC2 and brought into contact with the respective second contacting portions 210b of the plurality of terminals 200 of the second connector part FC2.

Where the second contacting portion 210b of each of the plurality of terminals 200 of the second connector part FC2 is constituted by a plate or rod inclined in the third oblique direction (see 7A, 7B, 11A and 11B), the first contacting arm 21a and the second contacting arm 21a of the second contacting portion 21 of each of the second terminals 20 of the second mating connector MC2 are brought into elastic contact respectively with the first face 211a and the second face 212a of the second contacting portion 210b of each of the plurality of terminals 200 of the second connector part FC2 at substantially right angles.

Where the tubular portion 13 of the second mating connector MC2 is provided with the first slit 13a and the second slit 13a, when the second mating connector MC2 is connected to the second connector part FC2, the second connecting portion 330b on the X-direction side and the second connecting portion 330b on the X′-direction side of the second shell 300b of the second connector part FC2 are inserted respectively into the first slit 13a and the second slit 13a of the second mating connector MC2 and are brought into elastic contact respectively with the first side plate and the second side plate of the second shell body 31 of the second shell 30 of the second mating connector MC2. Thus the second shell 30 of the second mating connector MC2 is electrically connected to the second shell 300b of the second connector part FC2.

Even in a case where the first circuit board B1 and the second circuit board B2 are fixed in an electronic device (not illustrated) to install the first circuit board B1 and the second circuit board B2 and where the second mating connector MC2 is at a position offset, in the direction including the component of the at least one direction, from the normal position with respect to the first mating connector MC1, when the second mating connector MC2 is connected to the second connector part FC2, the elastically deformable portions 230 of the plurality of terminals 200 elastically deform in the direction including the component of the at least one direction, so that the second connector part FC2 is displaced in the same direction. In other words, when the second mating connector MC2 is connected to the second connector part FC2, in accordance with the offset position of the second mating connector MC2, the second connector part FC2 is displaced in the direction including the component of one direction, in the direction including the two components, or in the direction including the three components described above. This allows easy connection of the second mating connector MC2 to the second connector part FC2.

Where the connector FC is provided with the rotating lever 600 and the second mating connector MC2 is provided with the abutment 14, the rotating lever 600 in the unlocked state is rotated by approximately 180 degrees. This causes the locking protrusion 450 on the X′-direction side of the second housing 400 to be disengaged from the locking recess 614 of the rotating lever 600. When the rotating lever 600 has been rotated by approximately 180 degrees, the locking protrusion 450 on the X-direction side of the second housing 400 is fitted into the locking recess 614, and the rotating lever 600 enters the locked state. During the rotation of the rotating lever 600, the abutment 14 is inserted into, and then locked in, the lock groove 613 of the rotating lever 600. When the rotating lever 600 is rotated in the opposite direction by approximately 180 degrees, the rotating lever 600 enters the unlocked state.

The connection structure as described above, which includes the above-described connector FC, provides similar technical features and effects as those of the connector FC described above.

The connection structure further provides the following technical features and effects.

Technical features and effects (1): Even if the second mating connector MC2 is at a position offset, in the direction including the component of the at least one direction, from the predetermined position with respect to the first mating connector MC1, the first mating connector MC1 can be connected to the first connector part FC1 of the connector FC, and the second mating connector MC2 can be connected to the second connector part FC2 of the connector FC displacing the second mating connector MC2 in the direction including the component of the at least one direction in accordance with the offset position of the second mating connector MC2.

As such, the first mating connector MC1 and the second mating connector MC2 can be used as external interfaces of the electronic device.

Technical features and effects (2): Where the plurality of first terminals 20 of the first mating connector MC1 are manufactured by the rolling method, and the first faces on the X-direction side and the second faces on the X′-direction side of the plurality of first terminals 20 are flat rolled faces, it is possible to reduce the pitch distance in the X-X′ direction between the plurality of first terminals 20 and to reduce the dimension in the X-X′ direction of the first mating connector MC1. Where the plurality of second terminals 20 of the second mating connector MC2 are manufactured by the rolling method, and the first faces on the X-direction side and the second faces on the X′-direction side of the plurality of second terminals 20 are flat rolled faces, it is possible to reduce the pitch distance in the X-X′ direction between the plurality of second terminals 20 and to reduce the dimension in the X-X′ direction of the second mating connector MC2.

Technical features and effects (3): Where the first body 10, the first terminals 20, and the first shell 30 (if provided) of the first mating connector MC1 are identical in shape respectively to the second body 10, the second terminals 20, and the second shell 30 (if provided) of the second mating connector MC2, commonality of connectors is achieved for the first mating connector MC1 and the second mating connector MC2.

Technical features and effects (4): Where only the first mating connector MC1 mounted on the first circuit board P1 is disposed between the first circuit board B1 and the second circuit board B2, it is possible to shorten the linear distance in the Z-Z′ direction between the first circuit board B1 and the second circuit board B2.

Note that the connector FC, the first mating connector MC1, the second mating connector MC2, and the connection structure (combination) described above are not limited to the above-described embodiments, but can be modified in any manner within the scope of the claims. Some examples of modifications will now be described.

The first retainable portions 220a of the plurality of terminals 200 described above are only required to be retained in the first body 100a at intervals in the X-X′ direction. The first retainable portions 220a of the plurality of terminals 200 may be insert-molded in, and retained by, the first body 100a, for example. The first retainable portions 22 of the plurality of first terminals 20 of the first mating connector MC1 are also only required to be retained in the first body 10 at intervals in the X-X′ direction, and may be insert-molded in, and retained by, the first body 10.

The second retainable portions 220b of the plurality of terminals 200 described above are only required to be retained in the second body 100b at intervals in the X-X′ direction. The second retainable portions 220b of the plurality of terminals 200 may be insert-molded in, and retained by, the second body 100b, for example. The second retainable portions 22 of the plurality of second terminals 20 of the second mating connector MC2 are also only required to be retained in the second body 10 at intervals in the X-X′ direction, and may be insert-molded in, and retained by, the second body 10.

The first contacting portions 210a of the plurality of terminals 200 described above may be housed in respective first housing grooves (not illustrated) of the first body 100a described above and may be exposed or protrude from the respective first housing grooves in the Z′ direction such as to be visible from the Y-direction side. The plurality of first housing grooves are provided in the first body 100a and open out in the Z′ direction. The first contacting portions 21 of the plurality of first terminals 20 of the first mating connector MC1 may be housed in respective first housing grooves (not illustrated) of the first body 10 and may be exposed or protrude from the respective first housing grooves in the Z direction such as to be visible from the Y′-direction side. The plurality of first housing grooves are provided in the first body 10 and open out in the Z direction.

The second contacting portions 210b of the plurality of terminals 200 described above may be housed in respective second housing grooves (not illustrated) of the second body 100b described above and may be exposed or protrude from the respective second housing grooves in the Z′ direction such as to be visible from the Y-direction side. The plurality of second housing grooves are provided in the second body 100b and open out in the Z′ direction. The second contacting portions 21 of the plurality of second terminals 20 of the second mating connector MC2 may be housed in respective second housing grooves (not illustrated) of the second body 10 and may be exposed or protrude from the respective second housing grooves in the Z direction such as to be visible from the Y′-direction side. The plurality of second housing grooves are provided in the second body 10 and open out in the Z direction.

The first mating connector MC1 may be mounted on the first circuit board B1 from the Z′-direction side. In this case, the first mating connector MC1 is oriented such as to be rotated by approximately 180 degrees in the Z-Z′ direction. The first lead portions 23 of the plurality of first terminals 20 of the first mating connector MC1 in this orientation may extend in the Y direction from the corresponding first retainable portions 22, be disposed on the Y-direction side relative to the first body 10, and be connected to the respective first electrodes 1 being surface electrodes of the first circuit board B1; or alternatively may extend in the Z direction from the corresponding first retainable portions 22, be disposed on the Z-direction side relative to the first body 10, and be connected to the respective first electrodes 1 being through-hole electrodes of the first circuit board B1. The first mating connector MC1 is connectable to connectors other than the first connector part FC1 of the connector FC.

The second mating connector MC2 may be mounted on the second circuit board B2 from the Z′-direction side. In this case, the second mating connector MC2 is oriented such as to be rotated by approximately 180 degrees in the Z-Z′ direction. The second lead portions 23 of the plurality of second terminals 20 of the second mating connector MC2 in this orientation may extend in the Y direction from the corresponding second retainable portions 22, be disposed on the Y-direction side relative to the second body 10, and be connected to the respective second electrodes 1 being surface electrodes of the second circuit board B2; or alternatively may extend in the Z direction from the corresponding second retainable portions 22, be disposed on the Z-direction side relative to the first body 10, and be connected to the respective second electrodes 1 being through-hole electrodes of the second circuit board B2. The first mating connector MC1 is connectable to connectors other than the second connector part FC2 of the connector FC.

The number of the plurality of first terminals 20 of the first mating connector MC1 and/or the number of the plurality of second terminals 20 of the second mating connector MC2 may be different from the number of the plurality of terminals 200 of the connector FC.

The plurality of relay terminals 200 of the connector FC described above can be omitted. In this case, the connector FC may include a plurality of variant relay terminals (not illustrated) in place of the plurality of relay terminals 200, and the first connector part FC1 and the second connector part FC2 may have the following configurations.

The first connector part FC1 is mounted on the first circuit board. The first connector part FC1 further includes at least one first terminal (not illustrated) constituted by an electrically conductive material. The at least one first terminal includes a first retainable portion, a first contacting portion, and a first lead portion. The first retainable portion of the at least one first terminal is retained in the first body 100a of the first connector part FC1. The first contacting portion of the at least one first terminal extends in the Y direction from the first retainable portion of the at least one first terminal, and protrudes or is exposed from the first body 100a. The first lead portion is connected to the first circuit board.

The second connector part FC2 is mounted on the second circuit board. The second connector part FC2 further includes at least one second terminal (not illustrated) constituted by an electrically conductive material. The at least one second terminal includes a second retainable portion, a second contacting portion, and a second lead portion. The second retainable portion of the at least one second terminal is retained in the second body 100b of the second connector part FC2. The second contacting portion of the at least one second terminal extends in the Y direction from the second retainable portion of the at least one second terminal, and protrudes or is exposed from the second body 100b. The second lead portion is connected to the second circuit board.

The plurality of variant relay terminals are interposed between the first circuit board with the first connector part FC1 mounted thereon and the second circuit board with the second connector part FC2 mounted thereon. The variant relay terminals are manufactured by the above-described rolling method or other known method for manufacturing terminals. Each of the variant relay terminals includes a first connecting part, a second connecting part, and the elastically deformable portion 230. The first connecting part extends in the Z direction from the first end portion 231 of the elastically deformable portion 230, and is received in, and connected to, a through-hole electrode of the first circuit board. The second connecting part extends in the Z′ direction from the second end portion 232 of the elastically deformable portion 230, and is received in, and connected to, a through-hole electrode of the second circuit board. The elastically deformable portions 230 are elastically deformable in the direction including the component of the at least one direction, and the elastic deformation of the elastically deformable portions causes the second connector part FC2 to be displaced relative to the first connector part FC1 in the direction including the component of the at least one direction, from the predetermined normal position of the second connector part FC2 with respect to the first connector part FC1.

### REFERENCE SIGNS LIST

FC: Floating connector
   FC1: First connector part
      100a: First body
         110a: First body main portion; 120a: First partition; 130a: Plate; 140a: Side wall
      210a: First contacting portion; 220a: First retainable portion; 240a: First linking portion
      300a: First shell
         310a: First shell body
   FC2: Second connector part
      100b: Second body
         110b: Second body main portion; 120b: Second partition; 130b: Plate; 140b: Side wall
      210b: Second contacting portion; 220b: Second retainable portion; 240b: Second linking portion
      300b: Second shell
         310b: Second shell body
      400: Second housing
         410: Second housing body; 420: First guidable portion, second guidable portion
   200: Relay terminal
      230: Elastically deformable portion
   500a: First retainer
   500b: Second retainer
   600: Rotating lever
      610: Lever body; 620: Screw or pin
   700: First housing
      710: First housing body
         711: First portion; 712: Second portion; 713: Third portion
      720: Retaining portion
      730: Guide
      740: Partition
   800: First shield
      810: First shield body
         811: First shield portion; 812: Second shield portion; 813: Third shield portion
   900: Second shield
      910: Second shield body
         920a: First connecting portion; 920b: Second connecting portion; 930: Third connecting portion
   MC1: First mating connector; MC2: Second mating connector
      10: First body, Second body
         11: Base; 12: Protrusion; 13: Tubular portion; 14: Abutment; 15: Engaging protrusion
      20: First terminal, Second terminal
         21: First contacting portion, Second contacting portion
      22: First retainable portion, second retainable portion
      23: First lead portion, second lead portion
      24: First linking portion, second linking portion
   30: First shell, Second shell
      31: First shell body, second shell body
      32: First cover, second cover
      33: First leg, second leg
   B1: First circuit board
   B2: Second circuit board

What is claimed is:

1. A floating connector comprising:
a first connector part;
a second connector part disposed in spaced relation to, and on one side in a first direction relative to, the first connector part; and
a plurality of relay terminals constituted by an electrically conductive material, wherein
the first connector part includes
a first body constituted by an insulating material,
first retainable portions of the plurality of relay terminals, the first retainable portions being retained in the first body at intervals in a second direction, the second direction being substantially orthogonal to the first direction, and
first contacting portions of the plurality of relay terminals, the first contacting portions extending to one side in a third direction from the respective first retainable portions of the plurality of relay terminals, and protruding or being exposed at least partly from the first body such as to be visible from the one side in the third direction, the third direction being substantially orthogonal to the first and second directions,
the second connector part includes
a second body constituted by an insulating material and disposed in spaced relation to, and on the one side in the first direction relative to, the first body,
second retainable portions of the plurality of relay terminals, the second retainable portions being retained in the second body at intervals in the second direction, and
second contacting portions of the plurality of relay terminals, the second contacting portions extending to the one side in the third direction from the respective second retainable portions of the plurality of relay terminals, and protruding or being exposed at least partly from the second body such as to be visible from the one side in the third direction,
the plurality of relay terminals further include respective elastically deformable portions, the elastically deformable portions are provided between the respective first retainable portions and the respective second retainable portions and are arranged at intervals in the second direction, wherein the second direction is a thickness direction of each of the elastically deformable portions of the plurality of relay terminals, and
the elastically deformable portions of the plurality of relay terminals are elastically deformable in a direction including a component of at least one direction of the first, second, or the third direction, and the elastic deformation of the elastically deformable portions causes the second connector part to be displaced relative to the first connector part, in the direction including the component of the at least one direction.

2. The floating connector according to claim 1, wherein the elastically deformable portions are generally laterally oriented U shaped, generally laterally oriented arc shaped, or generally laterally oriented V shaped, in sectional view along the first and third directions.

3. The floating connector according to claim 2, wherein each of the elastically deformable portions includes
a first end portion on the one side in the first direction, and
a second end portion of the other side in the first direction, and
a top portion having a dimension in the third direction that is smaller than a dimension in the first direction of the first end portion and than a dimension in the first direction of the second end portion.

4. The floating connector according to claim 3, further comprising a first housing constituted by an insulating material, wherein
the first housing includes a plurality of partitions being arranged at intervals in the second direction and including a plurality of sets of two adjacent partitions adjacent in the second direction, and
each of the top portions of the elastically deformable portions of the plurality of relay terminals is disposed between the two adjacent partitions of each set.

5. The floating connector according to claim 2, wherein
the first connector part further includes first linking portions of the plurality of relay terminals,
the second connector part further includes second linking portions of the plurality of relay terminals,
each of the first linking portions links each of the first retainable portions and each of the elastically deformable portions, and
each of the second linking portions links each of the second retainable portions and each of the elastically deformable portions.

6. The floating connector according to claim 5, wherein
each of the first contacting portions includes a first face on one side in the second direction and a second face on the other side in the second direction,
each of the first linking portions is at least partly bent or curved such that the first and second faces of the corresponding first contacting portions are inclined in a first oblique direction, the first oblique direction including components of the first and second directions,
each of the second contacting portions includes a first face on the one side in the second direction and a second face on the other side in the second direction, and
each of the second linking portions is at least partly bent or curved such that the first and second faces of the corresponding second contacting portion are inclined in a second oblique direction, the second oblique direction including components of the first and second directions.

7. The floating connector according to claim 5, wherein
the first body includes a plurality of first partitions being arranged at intervals in the second direction and including a plurality of sets of two adjacent first partitions adjacent in the second direction,
each of the first linking portions of the plurality of relay terminals is disposed between the two adjacent first partitions of each set,
the second body includes a plurality of second partitions being arranged at intervals in the second direction and including a plurality of sets of two adjacent second partitions adjacent in the second direction, and
each of the second linking portions of the plurality of relay terminals is disposed between the two adjacent second partitions of each set.

8. The floating connector according to claim 1, further comprising a first housing constituted by an insulating material,
wherein the first housing includes
a retaining portion to retain the first connector part, and
at least one guide to guide the second connector part movably in the direction including the component of the at least one direction.

9. The floating connector according to claim 8, wherein
the first connector part further includes a first shell having electrical conductivity,
the first shell includes a first shell body being of a generally ring shape or a generally U shape in sectional view along the first and second directions, the first shell body extending in the third direction and housing the first body at least partly from the other side in the third direction,
the second connector part further includes
a second shell having electrical conductivity and including a second shell body generally of a generally ring shape or a generally U shape in sectional view along the first and second directions, the second shell body extending in the third direction and housing the second body at least partly from the other side in the third direction, and
a second housing being constituted by an insulating material and retaining the second shell, and
the at least one guide of the first housing is configured to guide the second housing movably in the direction including the component of the at least one direction.

10. The floating connector according to claim 9, wherein
the first body and the second body are identical in shape,
the second body is oriented such as to be rotated by 180 degrees in the first direction relative to the first body,
the first shell and the second shell are identical in shape, and
the second shell is oriented such as to be rotated by 180 degrees in the first direction relative to the first shell.

11. The floating connector according to claim 1, wherein
the direction including the component of the at least one direction comprises a direction including components of a plurality of directions among the first, second, and the third direction,
the elastically deformable portions of the plurality of relay terminals are elastically deformable in the direction including the components of the plurality of directions, and the elastic deformation of the elastically deformable portions causes the second connector part to be displaced relative to the first connector part, in the direction including the components of the plurality of directions.

12. The floating connector according to claim 2, wherein
the direction including the component of the at least one direction comprises a direction including components of a plurality of directions among the first, second, and the third direction,
the elastically deformable portions of the plurality of relay terminals are elastically deformable in the direction including the components of the plurality of directions, and the elastic deformation of the elastically deformable portions causes the second connector part to be displaced relative to the first connector part, in the direction including the components of the plurality of directions.

13. The floating connector according to claim 3, wherein
the direction including the component of the at least one direction comprises a direction including components of a plurality of directions among the first, second, and the third direction,
the elastically deformable portions of the plurality of relay terminals are elastically deformable in the direction including the components of the plurality of directions, and the elastic deformation of the elastically deformable portions causes the second connector part to be displaced relative to the first connector part, in the direction including the components of the plurality of directions.

14. A connection structure of connectors, the connection structure comprising:
the floating connector according to claim 1;
a first circuit board;
a second circuit board disposed in spaced relation to, and on the one side in the first direction relative to, the first circuit board;
a first mating connector mounted on the first circuit board and connectable to the first connector part of the floating connector from the one side in the third direction; and
a second mating connector mounted on the second circuit board and connectable to the second connector part of the floating connector from the one side in the third direction, wherein
the first mating connector includes
a first body constituted by an insulating material, and
a plurality of first terminals being constituted by an electrically conductive material and including respective first retainable portions, respective first contacting portions, and respective first lead portions,
the first retainable portions of the first mating connector are retained in the first body of the first mating connector at intervals in the second direction,
the first contacting portions of the first mating connector extend to the other side in the third direction, and protrude or are exposed at least partly from the first body of the first mating connector such as to be visible from the other side in the third direction,
the first lead portions of the first mating connector are disposed on the one side in the third direction, the one side in the first direction, or the other side in the first direction, relative to the first body of the first mating connector, and are connected to the first circuit board,
in a state where the first connector part of the floating connector is connected to the first mating connector, the first contacting portions of the plurality of relay terminals of the floating connector are in contact with the respective first contacting portions of the plurality of first terminals of the first mating connector,
the second mating connector includes
a second body constituted by an insulating material, and
a plurality of second terminals being constituted by an electrically conductive material and including respective second retainable portions, respective second contacting portions, and respective second lead portions,
the second retainable portions of the second mating connector are retained in the second body of the second mating connector at intervals in the second direction,
the second contacting portions of the second mating connector extend to the other side in the third direction, and protrude or are exposed at least partly from the second body of the second mating connector such as to be visible from the other side in the third direction,
the second lead portions of the second mating connector are disposed on the one side in the third direction, the one side in the first direction, or the other side in the first direction, relative to the second body of the second mating connector, and are connected to the second circuit board, and
in a state where the second connector part of the floating connector is connected to the second mating connector, the second contacting portions of the plurality of relay terminals of the floating connector are in contact with the respective second contacting portions of the plurality of second terminals of the second mating connector.

15. A connection structure of connectors, the connection structure comprising:
the floating connector according to claim 11;
a first circuit board;
a second circuit board disposed in spaced relation to, and on the one side in the first direction relative to, the first circuit board;
a first mating connector mounted on the first circuit board and connectable to the first connector part of the floating connector from the one side in the third direction; and
a second mating connector mounted on the second circuit board and connectable to the second connector part of the floating connector from the one side in the third direction, wherein the first mating connector includes
a first body constituted by an insulating material, and
a plurality of first terminals being constituted by an electrically conductive material and including respective first retainable portions, respective first contacting portions, and respective first lead portions,
the first retainable portions of the first mating connector are retained in the first body of the first mating connector at intervals in the second direction,
the first contacting portions of the first mating connector extend to the other side in the third direction, and protrude or are exposed at least partly from the first body of the first mating connector such as to be visible from the other side in the third direction,
the first lead portions of the first mating connector are disposed on the one side in the third direction, the one side in the first direction, or the other side in the first direction, relative to the first body of the first mating connector, and are connected to the first circuit board,
in a state where the first connector part of the floating connector is connected to the first mating connector, the first contacting portions of the plurality of relay terminals of the floating connector are in contact with the respective first contacting portions of the plurality of first terminals of the first mating connector,
the second mating connector includes
a second body constituted by an insulating material, and
a plurality of second terminals being constituted by an electrically conductive material and including respective second retainable portions, respective second contacting portions, and respective second lead portions,
the second retainable portions of the second mating connector are retained in the second body of the second mating connector at intervals in the second direction,
the second contacting portions of the second mating connector extend to the other side in the third direction, and protrude or are exposed at least partly from the second body of the second mating connector such as to be visible from the other side in the third direction,
the second lead portions of the second mating connector are disposed on the one side in the third direction, the one side in the first direction, or the other side in the first direction, relative to the second body of the second mating connector, and are connected to the second circuit board, and
in a state where the second connector part of the floating connector is connected to the second mating connector, the second contacting portions of the plurality of relay terminals of the floating connector are in contact with the respective second contacting portions of the plurality of second terminals of the second mating connector.

16. The connection structure according to claim 14, wherein
the first contacting portions of the plurality of relay terminals of the floating connector are primary first contacting portions, and the first contacting portions of the plurality of first terminals of the first mating connector are secondary first contacting portions,
the primary first contacting portions include respective first faces on one side in the second direction and respective second faces on the other side in the second direction, the first faces and the second faces of the primary first contacting portions being inclined in a first oblique direction including components of the first and second directions, and the secondary first contacting portions include respective first contacting arms and respective second contacting arms, with the corresponding second faces of the primary first contacting portions from a direction substantially orthogonal to the corresponding second faces of the primary first contacting portions;
the second contacting portions of the plurality of relay terminals of the floating connector are primary second contacting portions, and the second contacting portions of the plurality of second terminals of the second mating connector are secondary second contacting portions, and
the primary second contacting portions include respective first faces on one side in the second direction and respective second faces on the other side in the second direction, the first faces and the second faces of the primary second contacting portions being inclined in a second oblique direction including components of the first and second directions, and the secondary second contacting portions include respective first contacting arms and respective second contacting arms, the first contacting arms of the secondary second contacting portions being elastically contactable with the corresponding first faces of the primary second contacting portions from a direction substantially orthogonal to the corresponding first faces of the primary second contacting portions, the second contacting arms of the secondary second contacting portions being elastically contactable with the corresponding second faces of the primary second contacting portions from a direction substantially orthogonal to the corresponding second faces of the primary second contacting portions.

17. The connection structure according to claim 14, wherein
the first contacting portions of the plurality of first terminals of the first mating connector are primary first contacting portions, and the first contacting portions of the plurality of relay terminals of the floating connector are secondary first contacting portions,
the primary first contacting portions include respective first faces on one side in the second direction and respective second faces on the other side in the second direction, the first faces and the second faces of the primary first contacting portions being inclined in a first oblique direction including components of the first and second directions, and the secondary first contacting portions include respective first contacting arms and respective second contacting arms, with the corresponding second faces of the primary first contacting portions from a direction substantially orthogonal to the corresponding second faces of the primary first contacting portions;
the second contacting portions of the plurality of second terminals of the second mating connector are primary second contacting portions, and the second contacting portions of the plurality of relay terminals of the floating connector are secondary second contacting portions, and
the primary second contacting portions include respective first faces on one side in the second direction and respective second faces on the other side in the second direction, the first faces and the second faces of the primary second contacting portions being inclined in a second oblique direction including components of the first and second directions, and the secondary second contacting portions include respective first contacting arms and respective second contacting arms, the first contacting arms of the secondary second contacting portions being elastically contactable with the corresponding first faces of the primary second contacting portions from a direction substantially orthogonal to the corresponding first faces of the primary second contacting portions, the second contacting arms of the secondary second contacting portions being elastically contactable with the corresponding second faces of the primary second contacting portions from a direction substantially orthogonal to the corresponding second faces of the primary second contacting portions.

18. The connection structure according to claim 15, wherein
the first contacting portions of the plurality of relay terminals of the floating connector are primary first contacting portions, and the first contacting portions of the plurality of first terminals of the first mating connector are secondary first contacting portions,
the primary first contacting portions include respective first faces on one side in the second direction and respective second faces on the other side in the second direction, the first faces and the second faces of the primary first contacting portions being inclined in a first oblique direction including components of the first and second directions, and the secondary first contacting portions include respective first contacting arms and respective second contacting arms, with the corresponding second faces of the primary first contacting portions from a direction substantially orthogonal to the corresponding second faces of the primary first contacting portions;
the second contacting portions of the plurality of relay terminals of the floating connector are primary second contacting portions, and the second contacting portions of the plurality of second terminals of the second mating connector are secondary second contacting portions, and
the primary second contacting portions include respective first faces on one side in the second direction and respective second faces on the other side in the second direction, the first faces and the second faces of the primary second contacting portions being inclined in a second oblique direction including components of the first and second directions, and the secondary second contacting portions include respective first contacting arms and respective second contacting arms, the first contacting arms of the secondary second contacting portions being elastically contactable with the corresponding first faces of the primary second contacting portions from a direction substantially orthogonal to the corresponding first faces of the primary second contacting portions, the second contacting arms of the secondary second contacting portions being elastically contactable with the corresponding second faces of the primary second contacting portions from a direction substantially orthogonal to the corresponding second faces of the primary second contacting portions.

19. The connection structure according to claim 15, wherein
the first contacting portions of the plurality of first terminals of the first mating connector are primary first contacting portions, and the first contacting portions of the plurality of relay terminals of the floating connector are secondary first contacting portions,
the primary first contacting portions include respective first faces on one side in the second direction and respective second faces on the other side in the second direction, the first faces and the second faces of the primary first contacting portions being inclined in a first oblique direction including components of the first and second directions, and the secondary first contacting portions include respective first contacting arms and respective second contacting arms, with the corresponding second faces of the primary first contacting portions from a direction substantially orthogonal to the corresponding second faces of the primary first contacting portions;
the second contacting portions of the plurality of second terminals of the second mating connector are primary second contacting portions, and the second contacting portions of the plurality of relay terminals of the floating connector are secondary second contacting portions, and
the primary second contacting portions include respective first faces on one side in the second direction and respective second faces on the other side in the second direction, the first faces and the second faces of the primary second contacting portions being inclined in a second oblique direction including components of the first and second directions, and the secondary second contacting portions include respective first contacting arms and respective second contacting arms, the first contacting arms of the secondary second contacting portions being elastically contactable with the corresponding first faces of the primary second contacting portions from a direction substantially orthogonal to the corresponding first faces of the primary second contacting portions, the second contacting arms of the secondary second contacting portions being elastically contactable with the corresponding second faces of the primary second contacting portions from a direction substantially orthogonal to the corresponding second faces of the primary second contacting portions.
